(19) United States
(12) Patent Application Publication
(10) Pub. No.: US 2024/0049029 A1
(43) Pub. Date: Feb. 8, 2024

(54) TECHNIQUES TO FACILITATE GROUP-BASED REPORTS WITH REPETITION ON CONFIGURED FOR AT LEAST ONE CHANNEL MEASUREMENT RESOURCE SET

(71) Applicant: QUALCOMM Incorporated, San Diego, CA (US)

(72) Inventors: Tianyang BAI, Somerville, NJ (US); Yan ZHOU, San Diego, CA (US); Junyi LI, Fairless Hills, PA (US); Tao LUO, San Diego, CA (US)

(21) Appl. No.: 18/313,300

(22) Filed: May 5, 2023

Related U.S. Application Data
(60) Provisional application No. 63/369,883, filed on Jul. 29, 2022.

(51) Int. Cl. H04W 24/10; H04L 5/00

(52) U.S. Cl. CPC H04W 24/10; H04L 5/0035

(57) ABSTRACT

Apparatus, methods, and computer-readable media for facilitating group-based reports when at least one CMR set associated with the group-based report is configured with repetition ON are disclosed herein. An example method for wireless communication at a UE includes receiving a configuration for a group-based report associated with multiple TRPs, each TRP of the multiple TRPs associated with a respective CMR set including one or more beams. The example method also includes receiving reference signals via the one or more beams associated with each CMR set. The example method also includes transmitting the group-based report based on measurements associated with the reference signals and the configuration, the group-based report including a first quantity of report groups, a second quantity of beams per report group.

### CROSS REFERENCE TO RELATED APPLICATION(S)

This application claims the benefit of and priority to U.S. Provisional Application Ser. No. 63/369,883, entitled “TECHNIQUES TO FACILITATE GROUP-BASED REPORTS WITH REPETITION ON CONFIGURED FOR AT LEAST ONE CHANNEL MEASUREMENT RESOURCE SET” and filed on Jul. 29, 2022, which is expressly incorporated by reference herein in its entirety.

### TECHNICAL FIELD

The present disclosure relates generally to communication systems, and more particularly, to wireless communication employing group-based reports to support multiple transmission reception points (TRPs).

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided for wireless communication. An apparatus may include a user equipment (UE). The example apparatus may receive a configuration for a group-based report associated with multiple transmission-reception points (TRPs), each TRP of the multiple TRPs associated with a respective channel measurement resource (CMR) set including one or more beams, and at least a first CMR set being configured with a first repetition value and a second CMR set being configured with a second repetition value different than the first repetition value. The example apparatus may also receive reference signals via the one or more beams associated with each CMR set associated with the group-based report. Additionally, the example apparatus may transmit the group-based report based on measurements associated with the reference signals and the configuration, the group-based report including a first quantity of report groups, and a second quantity of beams-per-report group, and the group-based report including, for the first CMR set, a single measurement value and excluding respective beam identifiers.

In another aspect of the disclosure, a method, a computer-readable medium, and an apparatus are provided for wireless communication. An apparatus may include a network entity, such as a base station. The example apparatus may provide a configuration for a group-based report associated with multiple TRPs, each TRP of the multiple TRPs associated with a respective CMR set including one or more beams, and at least a first CMR set being configured with a first repetition value

The example apparatus may also provide reference signals via the one or more beams associated with the first CMR set associated with the first network entity.

Additionally, the example apparatus may obtain the group-based report based on measurements associated with the reference signals and the configuration, the group-based report including a first quantity of report groups, and a second quantity of beams-per-report group, and the group-based report including, for the first CMR set, a single measurement value and excluding respective beam identifiers.

In an aspect of the disclosure, a method, a computer-readable medium, and an apparatus are provided for wireless communication. An apparatus may include a UE. The example apparatus may receive a configuration for a group-based report associated with multiple TRPs, each TRP of the multiple TRPs associated with a respective CMR set including one or more beams. The example apparatus may also receive reference signals via the one or more beams associated with each CMR set. Additionally, the apparatus may transmit the group-based report based on measurements associated with the reference signals and the configuration, the group-based report including a first quantity of report groups, a second quantity of beams-per-report group.

In another aspect of the disclosure, a method, a computer-readable medium, and an apparatus are provided for wireless communication. An apparatus may include a first network entity, such as a base station or a component of a base station. The example apparatus may output a configuration for a group-based report associated with multiple TRPs, each TRP of the multiple TRPs associated with a respective CMR set including one or more beams. The example apparatus may also output reference signals via the one or more beams associated with a first CMR set associated with the first network entity. Additionally, the example apparatus may obtain the group-based report based on measurements associated with the reference signals and the configuration, the group-based report including a first quantity of report groups, and a second quantity of beams-per-report group.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and a UE in an access network.

FIG. 4A illustrates an example of beam pair link (BPL) discovery and refinement, in accordance with various aspects of the present disclosure.

FIG. 4B illustrates another example of BPL discovery and refinement, in accordance with various aspects of the present disclosure.

FIG. 4C illustrates another example of BPL discovery and refinement, in accordance with various aspects of the present disclosure.

FIG. 5A is a diagram illustrating an example of a wireless communication system employing a UE and multiple TRPs, in accordance with various aspects of the present disclosure.

FIG. 5B is a diagram illustrating an example group-based report to support multiple TRP transmission, in accordance with various aspects of the present disclosure.

FIG. 6A is a diagram illustrating an example of a wireless communication system employing a UE, a first TRP configured with repetition ON, and a second TRP configured with repetition OFF, in accordance with various aspects of the present disclosure.

FIG. 6B is a diagram illustrating an example of a wireless communication system employing a UE, a first TRP configured with repetition ON, and a second TRP configured with repetition ON, in accordance with various aspects of the present disclosure.

FIG. 7 is an example communication flow between a first network entity, a second network entity, and a UE, in accordance with the teachings disclosed herein.

FIG. 8A is a diagram illustrating an example of a wireless communication system employing a UE, a first TRP configured with repetition ON, and a second TRP configured with repetition OFF, in accordance with various aspects of the present disclosure.

FIG. 8B is a diagram illustrating an example group-based report to support multiple TRP transmission based on the wireless communication system of FIG. 8A, in accordance with various aspects of the present disclosure.

FIG. 9A is a diagram illustrating an example of a wireless communication system employing a UE, a first TRP configured with repetition ON, and a second TRP configured with repetition OFF, in accordance with various aspects of the present disclosure.

FIG. 9B is a diagram illustrating an example group-based report to support multiple TRP transmission based on the wireless communication system of FIG. 9A, in accordance with various aspects of the present disclosure.

FIG. 10A is a diagram illustrating an example of a wireless communication system employing a UE, a first TRP configured with repetition ON, and a second TRP configured with repetition OFF, in accordance with various aspects of the present disclosure.

FIG. 10B is a diagram illustrating an example group-based report to support multiple TRP transmission based on the wireless communication system of FIG. 10A, in accordance with various aspects of the present disclosure.

FIG. 11A is a diagram illustrating an example of a wireless communication system employing a UE, a first TRP configured with repetition ON, and a second TRP configured with repetition OFF, in accordance with various aspects of the present disclosure.

FIG. 11B is a diagram illustrating an example group-based report to support multiple TRP transmission based on the wireless communication system of FIG. 11A, in accordance with various aspects of the present disclosure.

FIG. 12A is a diagram illustrating an example of a wireless communication system employing a UE, a first TRP configured with repetition ON, and a second TRP configured with repetition ON, in accordance with various aspects of the present disclosure.

FIG. 12B is a diagram illustrating an example group-based report to support multiple TRP transmission based on the wireless communication system of FIG. 12A, in accordance with various aspects of the present disclosure.

FIG. 13A is a diagram illustrating an example of a wireless communication system employing a UE, a first TRP configured with repetition ON, and a second TRP configured with repetition ON, in accordance with various aspects of the present disclosure.

FIG. 13B is a diagram illustrating an example group-based report to support multiple TRP transmission based on the wireless communication system of FIG. 13A, in accordance with various aspects of the present disclosure.

FIG. 14A is a diagram illustrating an example of a wireless communication system employing a UE, a first TRP configured with repetition ON, and a second TRP configured with repetition OFF, in accordance with various aspects of the present disclosure.

FIG. 14B is a diagram illustrating an example group-based report to support multiple TRP transmission based on the wireless communication system of FIG. 14A, in accordance with various aspects of the present disclosure.

FIG. 15 is a diagram illustrating an example of a group-based report facilitating support of a wireless communication system, in accordance with various aspects of the present disclosure.

FIG. 16 is a diagram illustrating another example of a group-based report facilitating support of a wireless communication system, in accordance with various aspects of the present disclosure.

FIG. 17 is a diagram illustrating another example of a group-based report facilitating support of a wireless communication system, in accordance with various aspects of the present disclosure.

FIG. 18 is a diagram illustrating another example of a group-based report facilitating support of a wireless communication system, in accordance with various aspects of the present disclosure.

FIG. 19 is a flowchart of a method of wireless communication at a UE, in accordance with the teachings disclosed herein.

FIG. 20 is a flowchart of a method of wireless communication at a UE, in accordance with the teachings disclosed herein.

FIG. 21 is a flowchart of a method of wireless communication at a UE, in accordance with the teachings disclosed herein.

FIG. 22 is a diagram illustrating an example of a hardware implementation for an example apparatus and/or network entity.

FIG. 23 is a flowchart of a method of wireless communication at a network entity, in accordance with the teachings disclosed herein.

FIG. 24 is a flowchart of a method of wireless communication at a network entity, in accordance with the teachings disclosed herein.

FIG. 25 is a diagram illustrating an example of a hardware implementation for an example network entity.

### DETAILED DESCRIPTION

Group-based reports may be implemented when a UE is in communication with two or more TRPs. In some such examples, each of the TRPs may be configured with a respective CMR set including one or more candidate beams for the UE to measure. In some examples, the channel measurement resources may correspond to CSI reference signals (CSI-RS) and, thus, the CMR set may include one or more CSI-RS. A CSI-RS may be identified by a CSI-RS resource indicator (CRI). To improve communication at the UE, the UE may be configured to simultaneously (or nearly simultaneously) receive multiple beams. For example, when the UE is in communication with two TRPs, the group-based report may enable supporting the simultaneous reception of two beams including one beam from each of the two TRPs.

The group-based report may indicate a beam pair (e.g., one beam from each TRP) that the UE is able to receive simultaneously. The group-based report may also indicate the signal strength (e.g., the RSRP and/or the SINR) associated with the beam pair. In some examples, the group-based report may include multiple beam pairs (e.g., multiple groups). For example, the group-based report may include information related to a first group and a second group. The first group may include a first beam associated with a first TRP and a first beam associated with a second TRP, and the second group may include a second beam associated with the first TRP and a second beam associated with the second TRP.

In some examples, the UE may be configured to provide a group-based report. In some such examples, the UE may be configured with different CMR sets associated with respective TRPs. Additionally, each CMR set may include one or more CRIs corresponding to beams. For example, a first TRP may be associated with a first CMR set including a first CRI set and a second TRP may be associated with a second CMR set including a second CRI set.

The UE may perform measurements based on the different beams associated with the different CMR sets and TRPs. The measurements may include measured RSRP and/or SINR. In some examples, the measurements may include layer-1 (L1) RSRP (L1-RSRP) and/or L1-SINR. The group-based report may include information regarding the different beams and the corresponding measurements. For example, the UE may report N groups with M beams per group in a single report (e.g., a group-based report). It may be appreciated that in examples in which the quantity of beams M is set to two, a group may be referred to as a “pair” and the group-based report may be referred to as a “pair-based report.” For example, a pair-based report may include N pairs of beams.

Each group of a group-based report includes one beam from each TRP that the UE has the ability to receive simultaneously (or nearly simultaneously). In some examples, the quantity of beams M supported for the group-based report is two beams per group. For example, simultaneous reception at the UE may be supported by two TRPs and, thus, with one beam from each TRP, the quantity of beams M is two beams (e.g., M=2).

Although the following description describes examples in which two beams are reported per group (e.g., M=2), in other examples, the quantity of beams M may include more than two beams. For example, the quantity of beams M may be based on a capability of the UE.

The UE may be configured with the quantity of groups N to include in the group-based report. The quantity of groups N may be configured via RRC signaling with a network entity, such as the first TRP, the second TRP, or another network entity. The quantity of groups N may be based on a capability of the UE. In some examples, the quantity of groups N may be selected from an inclusive set ranging between 1 and 4 (e.g., Nₘₐₓ={1, 2, 3, 4}). For example, the UE may report that it has the ability to report three groups (e.g., Nₘₐₓ=3). In such examples, the UE may be configured to report one group (e.g., N=1), two groups (e.g., N=2), or three groups (e.g., N=3).

In some examples, a CMR set may be configured with repetition ON. For example, a TRP performing a P3 sweep may be configured with repetition ON. The P3 sweep may enable a UE to perform beam refinement. For example, a network entity may output a signal using a same transmit beam at the network entity, and repeat the transmission multiple times. The UE may try different receive beams and identify the best UE receive beam (e.g., based on measured signals strengths).

In some examples, an indication of whether a CMR set is configured with repetition ON or repetition OFF may be obtained via RRC signaling. For example, RRC signaling configuring a first CMR set may also indicate whether repetition is ON or OFF for the first CMR set. When a CMR set is configured with repetition ON, the TRP outputs CSI-RS using a same transmit beam. However, the UE may try different receive beams to refine the beam at the UE.

In some examples, all of the CMR sets may be configured with repetition OFF. In some examples, one or more of the CMR sets may be configured with repetition ON.

In some examples, when a CMR set is configured with repetition ON, the UE may be configured to exclude a beam identifier in a report based on channel measurement resources. For example, when repetition for a CSI-RS resource set for channel measurement (e.g., a CMR set) is set to ON, then CRI for the CSI-RS resource set for channel measurement (e.g., the CMR set) may not be reported. However, when a CRI report corresponds to a group-based report, the group-based report may be configured to include CRI (e.g., beam identifiers). Thus, there may be a conflict in scenarios in which a group-based report is enabled and at least one of the CMR sets is configured with repetition ON.

Aspects disclosed herein provide techniques for addressing scenarios in which group-based reporting is enabled and at least one of the CMR sets is configured with repetition ON. In some examples, beam identifiers for beams of the CMR set configured with repetition ON may be excluded from the group-based report, while beams identifiers for beams of the CMR set configured with repetition OFF may be included in the group-based report. In some examples, the group-based report may include a single signal strength measurement for the CMR set configured with repetition ON. In other examples, the group-based report may exclude signal strength measurements for the CMR set configured with repetition ON. In still other examples, the group-based report may include multiple signal strength measurements for the CMR set configured with repetition ON.

The aspects presented herein may enable a UE to provide group-based reports when at least one CMR set associated with the group-based report is configured with repetition ON.

Although the following description provides examples directed to 5G NR, the concepts described herein may be applicable to other similar areas, such as 6G, 5G-advanced, LTE, LTE-A, CDMA, GSM, and/or other wireless technologies.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

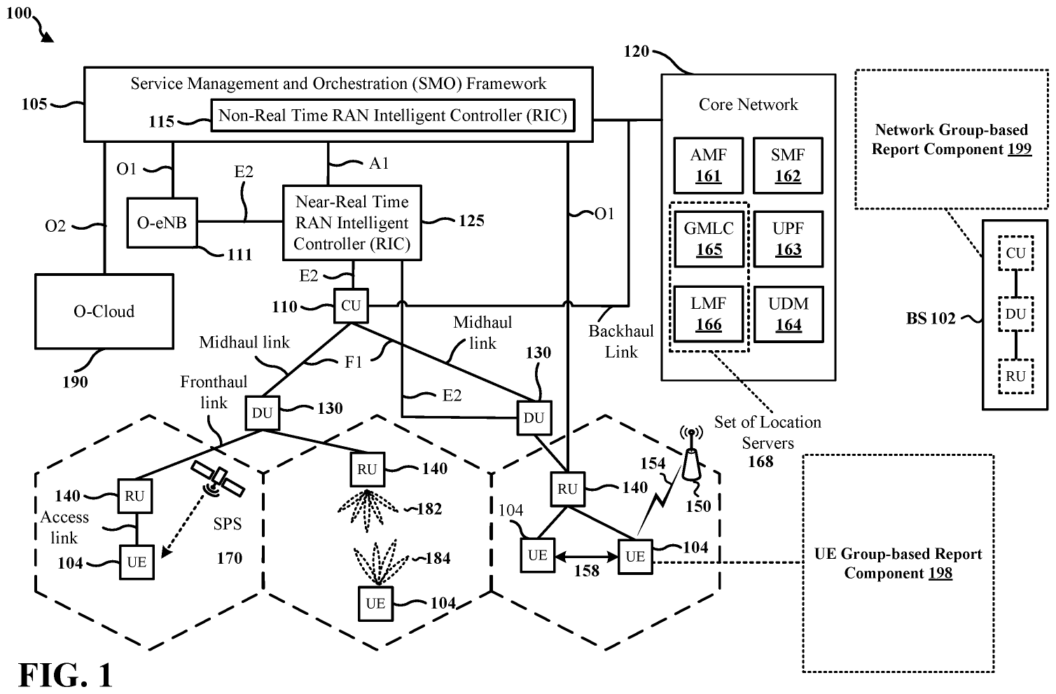

FIG. 1 is a diagram 100 illustrating an example of a wireless communications system and an access network. The illustrated wireless communications system includes a disaggregated base station architecture. The disaggregated base station architecture may include one or more CUs (e.g., a CU 110) that can communicate directly with a core network 120 via a backhaul link, or indirectly with the core network 120 through one or more disaggregated base station units (such as a Near-Real Time (Near-RT) RAN Intelligent Controller (RIC) (e.g., a Near-RT RIC 125) via an E2 link, or a Non-Real Time (Non-RT) RIC (e.g., a Non-RT RIC 115) associated with a Service Management and Orchestration (SMO) Framework (e.g., an SMO Framework 105), or both). A CU 110 may communicate with one or more DUs (e.g., a DU 130) via respective midhaul links, such as an F1 interface. The DU 130 may communicate with one or more RUs (e.g., an RU 140) via respective fronthaul links. The RU 140 may communicate with respective UEs (e.g., a UE 104) via one or more radio frequency (RF) access links. In some implementations, the UE 104 may be simultaneously served by multiple RUs.

Each of the units, i.e., the CUs (e.g., a CU 110), the DUs (e.g., a DU 130), the RUs (e.g., an RU 140), as well as the Near-RT RICs (e.g., the Near-RT RIC 125), the Non-RT RICs (e.g., the Non-RT RIC 115), and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU 140 can be implemented to handle over the air (OTA) communication with one or more UEs (e.g., the UE 104). In some implementations, real-time and non-real-time aspects of control and user plane communication with the RU 140 can be controlled by a corresponding DU. In some scenarios, this configuration can enable the DU(s) and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (e.g., an O-Cloud 190) to perform network element life cycle management (such as to instantiate virtualized network elements) via a cloud computing platform interface (such as an O2 interface). Such virtualized network elements can include, but are not limited to, CUs, DUs, RUs and Near-RT RICs. In some implementations, the SMO Framework 105 can communicate with a hardware aspect of a 4G RAN, such as an open eNB (e.g., an O-eNB 111), via an O1 interface. Additionally, in some implementations, the SMO Framework 105 can communicate directly with one or more RUs via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs, one or more DUs, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs (e.g., the RU 140) and the UEs (e.g., the UE 104) may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UE 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Some UEs may communicate with each other using device-to-device (D2D) communication (e.g., a D2D communication link 158). The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with a UE 104 (also referred to as Wi-Fi stations (STAs)) via communication link 154, e.g., in a 5 GHz unlicensed frequency spectrum or the like. When communicating in an unlicensed frequency spectrum, the UE 104/Wi-Fi AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) (e.g., an AMF 161), a Session Management Function (SMF) (e.g., an SMF 162), a User Plane Function (UPF) (e.g., a UPF 163), a Unified Data Management (UDM) (e.g., a UDM 164), one or more location servers 168, and other functional entities. The AMF 161 is the control node that processes the signaling between the UE 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) (e.g., a GMLC 165) and a Location Management Function (LMF) (e.g., an LMF 166). However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (e.g., SPS 170) (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in some aspects, a device in communication with a base station, such as a UE 104 in communication with a network entity, such as a base station 102 or a component of a base station (e.g., a CU 110, a DU 130, and/or an RU 140), may be configured to manage one or more aspects of wireless communication. For example, the UE 104 may include a UE group-based report component 198 configured to facilitate providing group-based reports when at least one CMR set associated with the group-based report is configured with repetition ON.

In some aspects, the UE group-based report component 198 may be configured to receive a configuration for a group-based report associated with multiple TRPs, each TRP of the multiple TRPs associated with a respective CMR set including one or more beams, and at least a first CMR set being configured with a first repetition value and a second CMR set being configured with a second repetition value different than the first repetition value. The example UE group-based report component 198 may also be configured to receive reference signals via the one or more beams associated with each CMR set associated with the group-based report. Additionally, the example UE group-based report component 198 may be configured to transmit the group-based report based on measurements associated with the reference signals and the configuration, the group-based report including a first quantity of report groups, and a second quantity of beams-per-report group, and the group-based report including, for the first CMR set, a single measurement value and excluding respective beam identifiers.

In some aspects, the UE group-based report component 198 may be configured to receive a configuration for a group-based report associated with multiple TRPs, each TRP of the multiple TRPs associated with a respective CMR set including one or more beams. The example UE group-based report component 198 may also be configured to receive reference signals via the one or more beams associated with each CMR set. Additionally, the example UE group-based report component 198 may be configured to transmit the group-based report based on measurements associated with the reference signals and the configuration, the group-based report including a first quantity of report groups, a second quantity of beams-per-report group.

In another configuration, a network entity, such as a base station 102 or a component of a base station (e.g., a CU 110, a DU 130, and/or an RU 140), may be configured to manage or more aspects of wireless communication. For example, the base station 102 may include a network group-based report component 199 configured to facilitate group-based reports at a UE when at least one CMR set associated with the group-based report is configured with repetition ON.

In some aspects, the network group-based report component 199 may be configured to provide a configuration for a group-based report associated with multiple TRPs, each TRP of the multiple TRPs associated with a respective CMR set including one or more beams, and at least a first CMR set being configured with a first repetition value. The example network group-based report component 199 may also be configured to provide reference signals via the one or more beams associated with the first CMR set associated with the first network entity. Additionally, the example network group-based report component 199 may be configured to obtain the group-based report based on measurements associated with the reference signals and the configuration, the group-based report including a first quantity of report groups, and a second quantity of beams-per-report group, and the group-based report including, for the first CMR set, a single measurement value and excluding respective beam identifiers.

In some aspects, the network group-based report component 199 may be configured to output a configuration for a group-based report associated with multiple TRPs, each TRP of the multiple TRPs associated with a respective CMR set including one or more beams. The example network group-based report component 199 may also be configured to output reference signals via the one or more beams associated with a first CMR set associated with the first network entity. Additionally, the example network group-based report component 199 may be configured to obtain the group-based report based on measurements associated with the reference signals and the configuration, the group-based report including a first quantity of report groups, and a second quantity of beams-per-report group.

The aspects presented herein may enable a UE to provide group-based reports when at least one CMR set associated with the group-based report is configured with repetition ON, which may improve communication performance, for example, by improving beam management procedures.

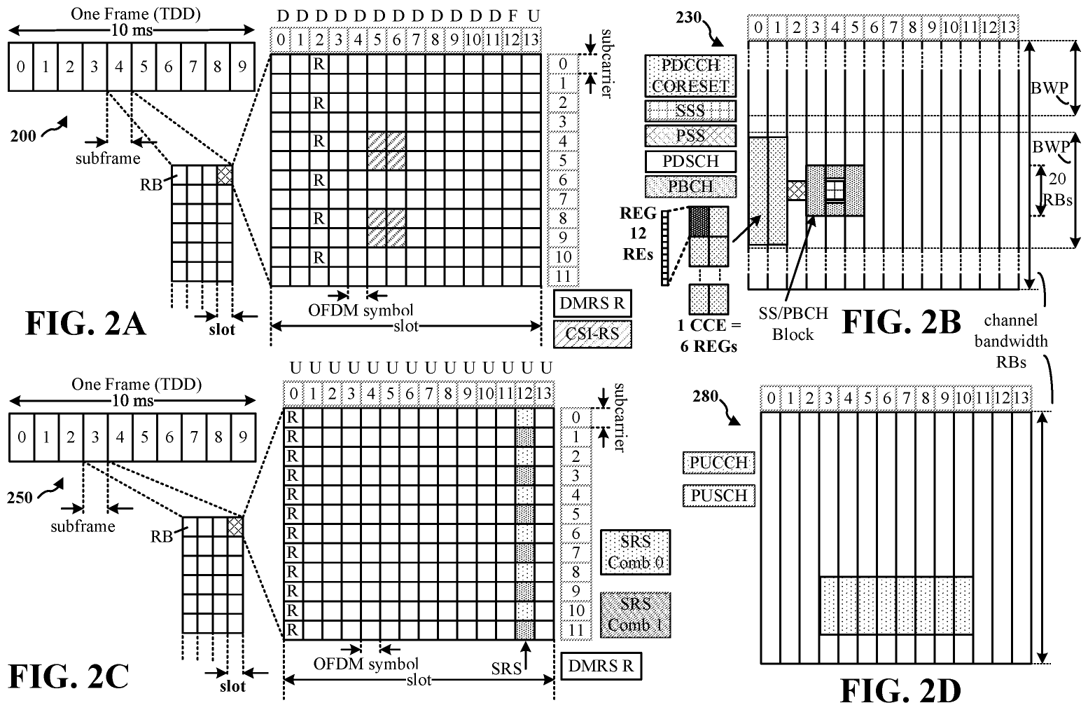

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. As shown in Table 1, the subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

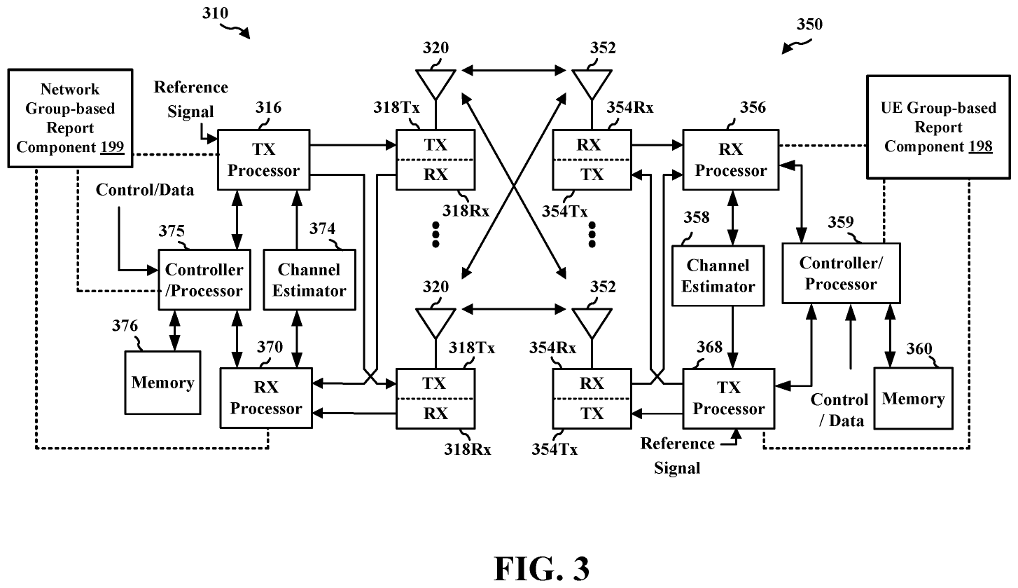

FIG. 3 is a block diagram that illustrates an example of a first wireless device that is configured to exchange wireless communication with a second wireless device. In the illustrated example of FIG. 3, the first wireless device may include a base station 310, the second wireless device may include a UE 350, and the base station 310 may be in communication with the UE 350 in an access network. As shown in FIG. 3, the base station 310 includes a transmit processor (TX processor 316), a transmitter 318Tx, a receiver 318Rx, antennas 320, a receive processor (RX processor 370), a channel estimator 374, a controller/processor 375, and at least one memory 376. The example UE 350 includes antennas 352, a transmitter 354Tx, a receiver 354Rx, an RX processor 356, a channel estimator 358, a controller/processor 359, at least one memory 360, and a TX processor 368. In other examples, the base station 310 and/or the UE 350 may include additional or alternative components.

In the DL, Internet protocol (IP) packets may be provided to the controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The TX processor 316 and the RX processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from the channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna of the antennas 320 via a separate transmitter (e.g., the transmitter 318Tx). Each transmitter 318Tx may modulate a radio frequency (RF) carrier with a respective spatial stream for transmission.

At the UE 350, each receiver 354Rx receives a signal through its respective antenna of the antennas 352. Each receiver 354Rx recovers information modulated onto an RF carrier and provides the information to the RX processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, two or more of the multiple spatial streams may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with the at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by the channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna of the antennas 352 via separate transmitters (e.g., the transmitter 354Tx). Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna of the antennas 320. Each receiver 318Rx recovers information modulated onto an RF carrier and provides the information to the RX processor 370.

The controller/processor 375 can be associated with the at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the UE group-based report component 198 of FIG. 1.

At least one of the TX processor 316, the RX processor 370, and the controller/processor 375 may be configured to perform aspects in connection with the network group-based report component 199 of FIG. 1.

A beamforming technology (e.g., 5G NR mmW technology) may use beam management procedures, such as beam measurements and beam switches, to maintain a quality of a link between a first network entity and a second network entity (e.g., an access link between a base station and a UE or a sidelink communication link between a first UE and a second UE) at a sufficient level. Beam management procedures aim to support mobility and the selection of the best beam pairing (or beam pair link (BPL)) between the first network entity and the second network entity. Beam selection may be based on a number of considerations including logical state, power saving, robustness, mobility, throughput, etc. For example, wide beams may be used for initial connection and for coverage/mobility and narrow beams may be used for high throughput scenarios with low mobility.

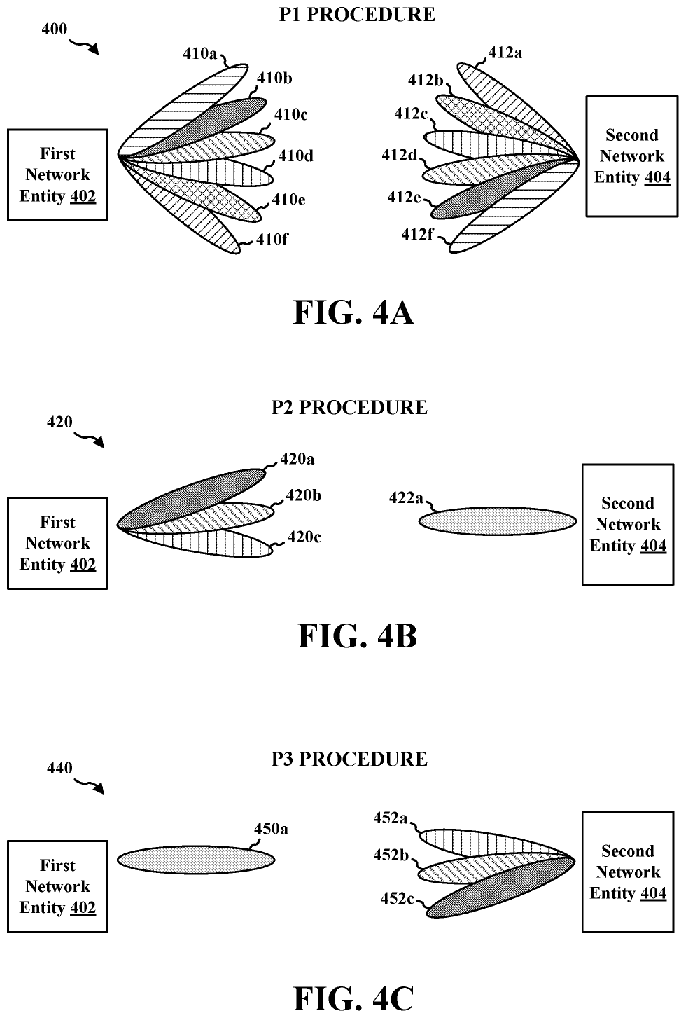

FIG. 4A, FIG. 4B, and FIG. 4C illustrate an example of BPL discovery and refinement between a first network entity 402 and a second network entity 404, as presented herein. In 5G NR, P1, P2, and P3 procedures are used for BPL discovery and refinement.

A P1 procedure enables the discovery of new BPLs. Referring to FIG. 4A, in a P1 procedure 400, the first network entity 402 transmits different symbols of a reference signal (e.g., a P1 signal), each beamformed in a different spatial direction. For example, the first network entity 402 may transmit beams using different transmit beams (e.g., transmit beams 410a, 410b, 410c, 410d, 410e, and 4100 over time in different directions. The P1 signal may be a periodic signal. For successful reception of at least a symbol of the P1 signal, the second network entity 404 searches for an appropriate receive beam. The second network entity 404 may search using available receive beams (e.g., receive beams 412a, 412b, 412c, 412d, 412e, and 4120 and applying a different receive beam during each occurrence of the periodic P1 signal.

Once the second network entity 404 has succeeded in receiving a symbol of the P1 signal, the second network entity 404 has discovered a BPL. In some aspects, the second network entity 404 may not want to wait until it has found the best receive beam, since this may delay further actions. The second network entity 404 may measure a signal strength (e.g., reference signal receive power (RSRP) and/or a signal to interference and noise ratio (SINR)) and report the symbol index together with the signal strength to the first network entity 402. Such a report may contain the findings of one or more BPLs. In an example, the second network entity 404 may determine a received signal having a high signal strength. The second network entity 404 may not know which transmit beam the first network entity 402 used to transmit. However, the second network entity 404 may report to the first network entity 402 the time at which the signal having a high signal strength was observed. The first network entity 402 may receive this report and may determine which transmit beam the first network entity 402 used at the given time.

The first network entity 402 may then offer P2 and P3 procedures to refine an individual BPL. Referring to FIG. 4B, a P2 procedure 420 refines the beam (transmit beam) of a BPL at the first network entity 402. The first network entity 402 may transmit a set of symbols of a reference signal with different beams that are spatially close to the beam of the BPL (e.g., the first network entity 402 may perform a sweep using neighboring beams around the selected beam). For example, the first network entity 402 may transmit a plurality of transmit beams (e.g., beams 420a, 420b, and 420c) over a consecutive sequence of symbols, with a different beam per symbol. In the P2 procedure 420, the second network entity 404 keeps its receive beam (e.g., a receive beam 422a) constant. Thus, the second network entity 404 uses the same beam as in the BPL reported via the P1 procedure 400. The beams used by the first network entity 402 for the P2 procedure 420 may be different from those used for the P1 procedure in that they may be spaced closer together or they may be more focused. The second network entity 404 may measure the signal strength (e.g., the RSRP and/or the SINR) for the various beams (e.g., the beams 420a, 420b, and 420c) and indicate the strongest beam and/or the highest signal strength to the first network entity 402. Additionally, or alternatively, the second network entity 404 may indicate all signal strengths measured for the beams. The second network entity 404 may indicate such information via a CSI-RS resource indicator feedback message, which may contain the signal strengths of the received beams (e.g., the beams 420a, 420b, 420c) in a sorted manner. The first network entity 402 may switch an active beam to the strongest beam reported, thus keeping the signal strength of the BPL at a highest level and supporting low mobility. If the transmit beams used for the P2 procedure 420 are spatially close (or even partially overlapped), no beam switch notification may be sent to the second network entity 404.

Referring to FIG. 4C, a P3 procedure 440 refines the beam (receive beam) of a BPL at the second network entity 404. In this example, the first network entity 402 transmits a same transmit beam 450a over a consecutive sequence of symbols. The second network entity 404 may use this opportunity to refine the receive beam by checking a strength of multiple receive beams (from the same or different panels). That is, while the transmit beam stays constant, the second network entity 404 may scan using different receive beams (e.g., the second network entity 404 performs a sweep using neighboring beams (e.g., receive beams 452a, 452b, and 452c)). The second network entity 404 may measure the signal strength (e.g., the RSRP and/or the SINR) of each receive beam and identify the best beam. Afterwards, the second network entity 404 may use the best beam for the BPL. The second network entity 404 may or may not send a report of signal strength(s) of the receive beam to the first network entity 402. By the end of the P2 and P3 procedures, the refined transmit beam at the first network entity 402 and the refined receive beam at the second network entity 404 maximize the signal strength of the BPL.

Group-based reports may be implemented when a UE is in communication with two or more TRPs. In some such examples, each of the TRPs may be configured with a respective CMR set indicating one or more candidate beams for the UE to measure. In some examples, the channel measurement resources may correspond to CSI-RS and, thus, the CMR set may indicate one or more CSI-RS. A CSI-RS may be identified by a CRI. To improve communication at the UE, the UE may be configured to simultaneously (or nearly simultaneously) receive multiple beams. For example, when the UE is in communication with two TRPs, the group-based report may enable supporting the simultaneous reception of two beams including one beam from each of the two TRPs.

The group-based report may indicate a beam pair (e.g., one beam from each TRP) that the UE is able to receive simultaneously. The group-based report may also indicate a signal strength (e.g., an RSRP and/or an SINR) associated with the beam pair. In some examples, the group-based report may include multiple beam pairs (e.g., multiple groups). For example, the group-based report may include information related to a first group and a second group. The first group may include a first beam associated with a first TRP and a first beam associated with a second TRP, and the second group may include a second beam associated with the first TRP and a second beam associated with the second TRP.

In some examples, the UE may be configured to provide a group-based report. In some such examples, the UE may be configured with different CMR sets associated with respective TRPs. Additionally, or alternatively, each CMR set may include one or more CRIs corresponding to beams. For example, a first TRP may be associated with a first CMR set including a first CRI set and a second TRP may be associated with a second CMR set including a second CRI set.

The UE may perform measurements based on the different beams associated with the different CMR sets and TRPs. The measurements may include measured RSRP and/or SINR. In some examples, the measurements may include layer-1 (L1) RSRP (L1-RSRP) and/or L1-SINR. The group-based report may include information regarding the different beams and the corresponding measurements. For example, the UE may report N groups with M beams per group in a single report (e.g., a group-based report). In some examples in which the quantity of beams M is set to two, a group may also be referred to as a “pair” and the group-based report may also be referred to as a “pair-based report.” For example, a pair-based report may include N pairs of beams.

Each group of a group-based report includes one beam from each TRP that the UE may receive simultaneously (or nearly simultaneously). In some examples, the quantity of beams M supported for the group-based report is two beams per group. For example, simultaneous reception at the UE may be supported by two TRPs and, thus, with one beam from each TRP, the quantity of beams M is two beams (e.g., M=2).

Although the following description describes examples in which two beams are reported per group (e.g., M=2), in other examples, the quantity of beams M may include more than two beams. For example, the quantity of beams M may be based on a capability of the UE.

The UE may be configured with the quantity of groups N to include in the group-based report. The quantity of groups N may be configured via RRC signaling with a network entity, such as the first TRP, the second TRP, or another network entity. The quantity of groups N may be based on a capability of the UE. In some examples, the quantity of groups N may be selected from an inclusive set ranging between 1 and 4 (e.g., Nₘₐₓ={1, 2, 3, 4}). For example, the UE may report that it has the ability to report three groups (e.g., Nₘₐₓ=3). In such examples, the UE may be configured to report one group (e.g., N=1), two groups (e.g., N=2), or three groups (e.g., N=3).

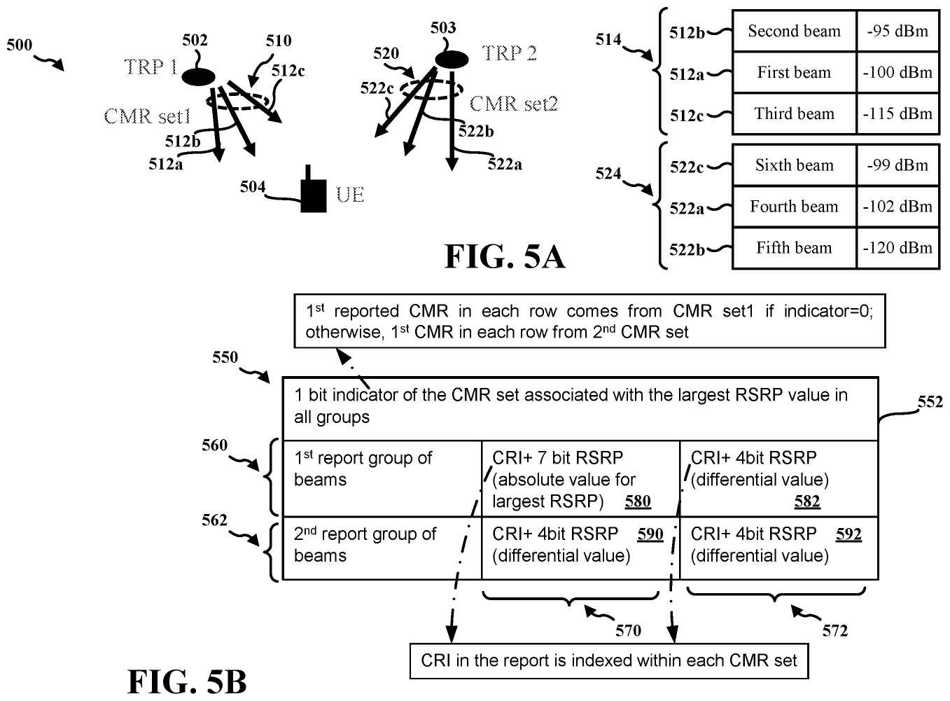

FIG. 5A is a diagram illustrating an example of a wireless communication system 500 employing a UE 504 and multiple TRPs, as presented herein. In the example of FIG. 5A, the UE 504 is in communication with a first TRP 502 (“TRP 1”) and a second TRP 503 (“TRP 2”). In the example of FIG. 5A, the UE 504 may be configured with two CMR sets (e.g., M=2) via a report configuration. The UE 504 may receive the report configuration via the first TRP 502, the second TRP 503, or another network entity. In the example of FIG. 5A, the UE 504 is configured with a first CMR set 510 (“CMR set1”) associated with the first TRP 502, and a second CMR set 520 (“CMR set2”) associated with the second TRP 503.

Each CMR set may correspond to one or more beams from a TRP. For example, the first CMR set 510 of FIG. 5A includes 3 beams including a first beam 512a, a second beam 512b, and a third beam 512c. The second CMR set 520 of FIG. 5A includes 3 beams including a fourth beam 522a, a fifth beam 522b, and a sixth beam 522c. It may be appreciated that other examples may include the same or alternate quantities of beams in a respective CMR set. The beams reported in a same group (e.g., a report group) are selected from different CMR sets and indicate beams that may be received simultaneously (e.g., received by a same receiver beam at the UE 504). For example, a first report group may include the first beam 512a from the first CMR set 510 and the fifth beam 522b from the second CMR set 520.

The UE 504 may perform measurements on the beams of the first CMR set 510 and the second CMR set 520. The measurements may include RSRP (e.g., L1-RSRP), SINR (e.g., L1-SINR), and/or other measurable characteristics. In the example of FIG. the UE 504 may determine a first ordering 514 of the signal strengths of the beams of the first CMR set 510. As shown in FIG. 5A, the strongest signal strength of the beams of the first CMR set 510 includes the second beam 512b, followed by the first beam 512a, and then the third beam 512c. The UE 504 may determine a second ordering 524 of the signal strengths of the beams of the second CMR set 520. As shown in FIG. 5A, the strongest signal strength of the beams of the second CMR set 520 includes the sixth beam 522c, followed by the fourth beam 522a, and then the fifth beam 522b.

FIG. 5B is a diagram illustrating an example group-based report 550 to support multiple TRP transmissions, as presented herein. For example, the UE 504 of FIG. 5A may generate and report the group-based report 550 based on measurements performed on the beams of the first CMR set 510 and the second CMR set 520 and indicated via the first ordering 514 and the second ordering 524 of FIG. 5A. The UE 504 may report the group-based report 550 to the first TRP 502, the second TRP 503, and/or another network entity.

In the example of FIG. 5B, the group-based report 550 includes an indicator 552. The indicator 552 may be a 1-bit indicator to indicate the CMR set with the strongest signal strength. For example, the indicator 552 may be set to a first value (e.g., a “0”) to indicate that the first CMR set 510 is associated with the largest signal strength value. The indicator 552 may be set to a second value (e.g., a “1”) to indicate that the second CMR set 520 is associated with the largest signal strength value. For example, after measuring the x beams of the first CMR set 510 and the y beams of the second CMR set 520, the UE 504 may determine that the second beam 512b of the first CMR set 510 is the beam with the strongest signal strength (e.g., the largest RSRP value). In such examples, the value of the indicator 552 may be configured to indicate that the first CMR set 510 is associated with the strongest signal strength value in all of the groups included in the group-based report 550 (e.g., the value of the indicator 552 may be set to the first value).

It may be appreciated that in examples in which the quantity of CMR sets is greater than two CMR sets, the size of the indicator 552 may be greater than 1-bit so that each candidate CMR set may be indicated by the value of the indicator 552.

In the example of FIG. 5B, the group-based report 550 includes a first report group 560 and a second report group 562. The first report group 560 corresponds to a first group (e.g., beams of a first report group). The second report group 562 corresponds to a second group (e.g., beams of a second report group). Thus, it may be appreciated that the group-based report 550 includes two groups or two pairs (e.g., N=2). The group-based report 550, which may also be referred to as a “pair-based report,” also includes a first column 570 and a second column 572. Values in the first column 570 correspond to a first beam of a report group and are selected from the CMR set associated with the strongest signal strength. Values in the second column 572 correspond to a second beam of the report group and are selected from the other CMR set. For example, if the indicator 552 indicates that the first CMR set 510 is associated with the strongest signal strength, then the beams indicated in the first column 570 are selected from the first CMR set 510 and the beams indicated in the second column 572 are selected from the second CMR set 520.

In the example of FIG. 5B, the group-based report 550 includes a first entry 580 and a second entry 582 corresponding to the first report group (e.g., indicated by the first report group 560). The group-based report 550 also includes a third entry 590 and a fourth entry 592 corresponding to the second report group (e.g., indicated by the second report group 562). In the example of FIG. 5B, each entry in the group-based report 550 includes a beam identifier (e.g., a CRI) and a corresponding measurement.

In some examples, each beam of the first CMR set 510 and the second CMR set 520 may include a CSI-RS identifier (ID) that corresponds to an absolute ID or a “raw” ID of the beam. However, such identifiers may be long and, thus, using these identifiers may introduce overhead. To reduce overhead associated with identifying a beam in the group-based report 550, the beam identifier of an entry may be indicated by an index within each CMR set in the group-based report 550. For example, and based on the first ordering 514, a beam identifier included in the first entry 580 may index to the second beam 512b of the first CMR set 510 and a beam identifier included in the second entry 582 may index to the fourth beam 522a of the second CMR set 520. In a similar manner, and based on the second ordering 524, a beam identifier included in the third entry 590 may index to the first beam 512a of the first CMR set 510 and a beam identifier included in the fourth entry 592 may index to the fourth beam 522a of the second CMR set 520.

In the example of FIG. 5B, the group-based report 550 includes an absolute value associated with the strongest signal strength (e.g., an absolute measurement value for a largest RSRP). Additionally, the group-based report 550 includes differential values for the remaining entries of the group-based report 550. The differential values may help reduce overhead. For example, in the example of FIG. 5B, the group-based report 550 includes 7-bits to indicate the absolute value of the beam with the strongest signal strength and includes 4-bits to indicate the differential value. In some examples, the differential values may indicate differential measurement values that are based relative to the absolute value indicated in the first entry 580. For example, the differential value in the third entry 590 may indicate a difference in signal strength between the measured signal strengths of the second beam 512b and the first beam 512a (e.g., differential value=−5 dBm). In a similar manner, the differential value in the fourth entry 592 may indicate a difference in signal strength between the measured signal strengths of the second beam 512b and the fourth beam 522a (e.g., differential value=−7 dBm).

In some examples, the differential values may indicate differential measurement values that are based relative to a previous measurement in the group-based report 550. For example, the differential value in the second entry 582 may indicate a difference in signal strength between the measured signal strengths of the second beam 512b and the sixth beam 522c (e.g., differential value=−4 dBm), the differential value in the third entry 590 may indicate a difference in the signal strength between the measured signal strengths of the sixth beam 522c and the first beam 512a (e.g., differential value=−1 dBm), and the differential value in the fourth entry 592 may indicate a difference in the signal strength between the measured signal strengths of the first beam 512a and the fourth beam 522a (e.g., differential value=−2 dBm).

In some examples, a CMR set may be configured with repetition ON. When a CMR set is configured with repetition ON, the TRP outputs CSI-RS using a same transmit beam. However, the UE may try different receive beams to refine the beam at the UE. For example, a TRP performing a P3 sweep (e.g., the P3 procedure 440 of FIG. 4C) may be configured with repetition ON. As described above, and referring to the example of FIG. 4C, the P3 procedure enables the UE (e.g., the second network entity 404) to perform beam refinement. For example, a base station (e.g., the first network entity 402) may output a signal using a same transmit beam at the base station (e.g., the same transmit beam 450a), and repeat the transmission multiple times. The UE (e.g., the second network entity 404) may try different receive beams (e.g., the receive beams 452a, 452b, and 452c) and identify the best UE receive beam (e.g., based on measured signals strengths).

In some examples, an indication of whether a CMR set is configured with repetition ON or repetition OFF may be obtained via RRC signaling. For example, RRC signaling configuring a first CMR set may also indicate whether repetition is ON or OFF for the first CMR set.

In some examples, all of the CMR sets may be configured with repetition OFF. For example, in the example of FIG. 5A, the first CMR set 510 and the second CMR set 520 may be configured with repetition OFF. In some examples, one or more of the CMR sets may be configured with repetition ON.

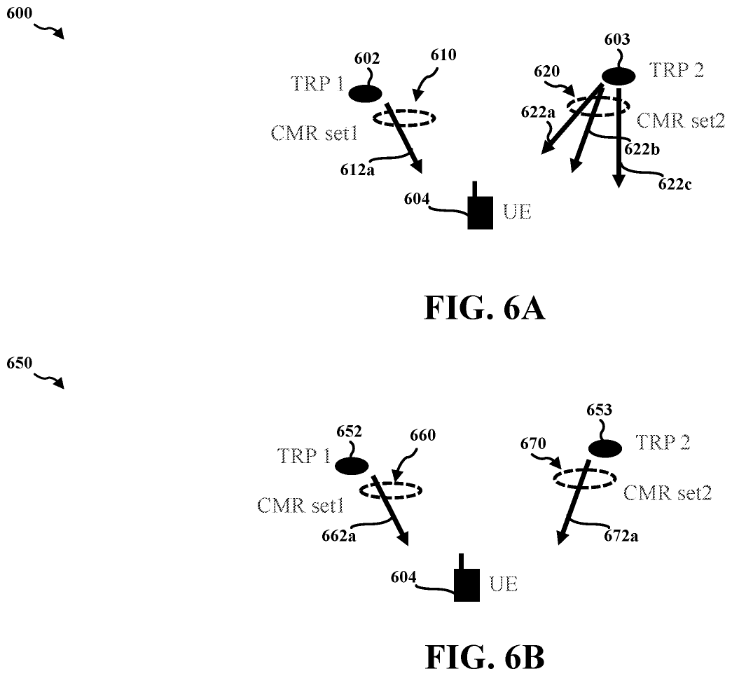

FIG. 6A is a diagram illustrating an example of a wireless communication system 600 employing a UE 604, a first TRP 602 (“TRP 1”) configured with repetition ON, and a second TRP 603 (“TRP 2”) configured with repetition OFF, as presented herein. As shown in FIG. 6A, the first TRP 602 is associated with a first CMR set 610 (“CMR set 1”) including a first transmit beam 612a. The second TRP 603 is associated with a second CMR set 620 including three transmit beams (e.g., a second transmit beam 622a, a third transmit beam 622b, and a fourth transmit beam 622c). In the example of FIG. 6A, the first TRP 602 may output CSI-RS using the same transmit beam (e.g., the first transmit beam 612a), while the second TRP 603 may output CSI-RS using different transmit beams (e.g., the second transmit beam 622a, the third transmit beam 622b, and the fourth transmit beam 622c).

FIG. 6B is a diagram illustrating an example of a wireless communication system 650 employing the UE 604, a first TRP 652 (“TRP 1”) configured with repetition ON, and a second TRP 653 (“TRP 2”) configured with repetition ON, as presented herein. As shown in FIG. 6B, the first TRP 652 is associated with a first CMR set 660 (“CMR set 1”) including a first transmit beam 662a. The second TRP 653 is associated with a second CMR set 670 including a second transmit beam 672a. In the example of FIG. 6B, the first TRP 652 may output CSI-RS using the same transmit beam (e.g., the first transmit beam 662a) and the second TRP 653 may output CSI-RS using the same transmit beam (e.g., the second transmit beam 672a).

In some examples, when a CMR set is configured with repetition ON, the UE may be configured to exclude a beam identifier in a report based on channel measurement resources. For example, when repetition for a CSI-RS resource set for channel measurement (e.g., a CMR set) is set to ON, then CRI for the CSI-RS resource set for channel measurement (e.g., the CMR set) may not be reported as they are associated with a same beam. However, when a CRI report corresponds to a group-based report, the group-based report may be configured to include CRI (e.g., beam identifiers). Thus, there may be a conflict in scenarios in which a group-based report is enabled and at least one of the CMR sets is configured with repetition ON.

Aspects disclosed herein provide techniques for addressing scenarios in which group-based reporting is enabled and at least one of the CMR sets is configured with repetition ON. In some examples, beam identifiers for beams of the CMR set configured with repetition ON may be excluded from the group-based report, while beam identifiers for beams of the CMR set configured with repetition OFF may be included in the group-based report. In some examples, the group-based report may include a single signal strength measurement for the CMR set configured with repetition ON. In other examples, the group-based report may exclude signal strength measurements for the CMR set configured with repetition ON. In still other examples, the group-based report may include multiple signal strength measurements for the CMR set configured with repetition ON.

In examples in which beam identifiers for beams of the CMR configured with repetition ON are included, the receive beam at the UE associated with the reported measurement may be compatible with simultaneous reception of the other reported CSI-RSs from the other CMR set. For example, and referring to the example of FIG. 6A, a first report group of a group-based report may include a first entry corresponding to a first beam of the first CMR set 610 and include a measurement of the signal strength associated with the first beam. The first report group may also include a second entry corresponding to a second beam of the second CMR set 620 and include a beam identifier associated with the second beam and a measured signal strength of the second beam. Although the group-based report, in the above-example, may not include a beam identifier associated with the first beam, the first beam may be determined by the first TRP 602 as a beam that is capable of being received at the UE 604 simultaneously with the second beam from the second TRP 603.

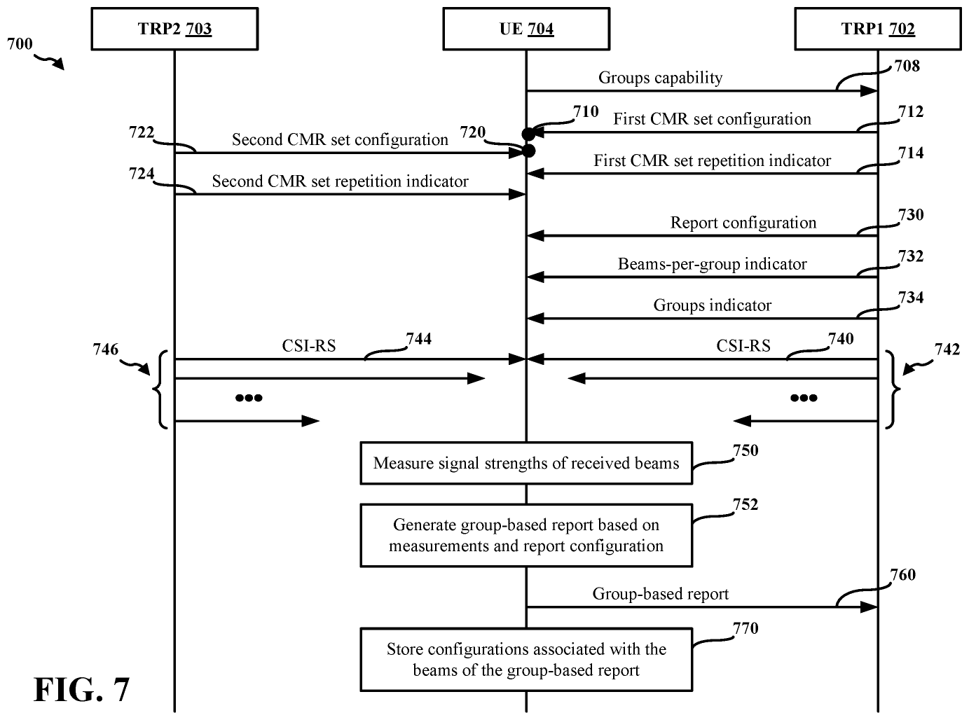

FIG. 7 is an example communication flow between a first network entity 702 (“TRP 1”), a second network entity 703 (“TRP 2”), and a UE 704, as presented herein. One or more aspects described for the first network entity 702 and/or the second network entity 703 may be performed by a component of a base station or a network entity, such as a CU, a DU, and/or an RU. In the illustrated example, the communication flow 700 facilitates the UE 704 providing group-based reports when at least one CMR set associated with the group-based report is configured with repetition ON. Aspects of the first network entity 702 and/or the second network entity 703 may be implemented by the base station 102 of FIG. 1 and/or the base station 310 of FIG. 3. Aspects of the UE 704 may be implemented by the UE 104 of FIG. 1 and/or the UE 350 of FIG. 3. Although not shown in the illustrated example of FIG. 7, in additional or alternate examples, the first network entity 702, the second network entity 703, and/or the UE 704 may be in communication with one or more other base stations or UEs.

In the illustrated example of FIG. 7, the UE 704 is configured with a first CMR set 710. For example, the first network entity 702 may provide (e.g., output or transmit) a first CMR set configuration 712 that is received (e.g., obtained) by the UE 704. The first CMR set configuration 712 may indicate one or more beams associated with CSI-RS for channel measurement. The first network entity 702 may provide the first CMR set configuration 712, including an indication of the first CMR set 710, to the UE 704 via signaling, such as RRC signaling, a MAC-control element (MAC-CE), and/or DCI.

The first network entity 702 may also provide a first CMR set repetition indicator 714 that is received by the UE 704. The first CMR set repetition indicator 714 may indicate whether the corresponding CMR set (e.g., the first CMR set 710) is configured with repetition ON or with repetition OFF. The first network entity 702 may provide the first CMR set repetition indicator 714 to the UE 704 via signaling, such as RRC signaling, a MAC-CE, and/or DCI. In examples in which the first CMR set 710 is configured with repetition ON, the first CMR set configuration 712 may indicate a single transit beam at the first network entity 702, such as the same transmit beam 450a of FIG. 4C and/or the first transmit beam 612a of FIG. 6A. In examples in which the first CMR set 710 is configured with repetition OFF, the first CMR set configuration 712 may indicate multiple beams at the first network entity 702, such as the transmit beams associated with the second CMR set 620 of FIG. 6A.

The UE 704 may also be configured with a second CMR set 720. For example, the second network entity 703 may provide a second CMR set configuration 722 that is received by the UE 704. The second CMR set configuration 722 may indicate one or more beams associated with CSI-RS for channel measurement. The second network entity 703 may provide the second CMR set configuration 722 to the UE 704 via signaling, such as RRC signaling, a MAC-CE, and/or DCI. The second network entity 703 may also provide a second set repetition indicator 724 that is received by the UE 704. The second set repetition indicator 724 may indicate whether the second CMR set 720 is configured with repetition ON or with repetition OFF. The second network entity 703 may provide the second set repetition indicator 724 to the UE 704 via signaling, such as RRC signaling, a MAC-CE, and/or DCI.

Although the first CMR set configuration 712 and the first CMR set repetition indicator 714 are illustrated as separate communications in the example of FIG. 7, in other examples, the first CMR set configuration 712 and the first CMR set repetition indicator 714 may be provided via a single communication. In a similar manner, in some examples, the second CMR set configuration 722 and the second set repetition indicator 724 may be provided via a single communication.

Although the UE 704 of FIG. 7 is configured with the first CMR set 710 by the first network entity 702 and the second CMR set 720 by the second network entity 703, in other examples, the UE 704 may be configured with the first CMR set 710 and the second CMR set 720 by the same network entity (e.g., by the first network entity 702 or by the second network entity 703). In some examples, the UE 704 may be configured with the first CMR set 710 and/or the second CMR set 720 by a third network entity different from the first network entity 702 and the second network entity 703.

As shown in FIG. 7, the UE 704 may be configured with a report configuration. For example, the first network entity 702 may provide a report configuration 730 that is received by the UE 704. The report configuration 730 may configure a group-based report at the UE 704. For example, the report configuration 730 may indicate which CMR sets the UE 704 is to include in a group-based report, such as a group-based report 760. In the example of FIG. 7, the report configuration 730 may configure the UE 704 to generate group-based reports based on the first CMR set 710 and the second CMR set 720.

The first network entity 702 may provide a beams-per-group indicator 732 and a groups indicator 734 that is received by the UE 704. The beams-per-group indicator 732 may indicate a quantity of beams per group (M) for the UE 704 to include in the group-based report. The groups indicator 734 may indicate a quantity of groups (N) for the UE 704 to include in the group-based report. The quantity of groups N indicated by the groups indicator 734 may be based on a maximum quantity of groups (e.g., Nₘₐₓ) that the UE 704 has the capability to support. For example, the UE 704 may transmit a groups capability 708 that is obtained by the first network entity 702. In some examples, the maximum quantity of groups supported by the UE 704 may range from 1 to 4 (e.g., Nₘₐₓ={1, 2, 3, 4}). The groups indicator 734 may indicate a quantity of groups N based on the maximum quantity of groups indicated by the UE 704 via the groups capability 708.

The first network entity 702 may output the report configuration 730, the beams-per-group indicator 732, and/or the groups indicator 734 to the UE 704 via signaling, such as RRC signaling, a MAC-CE, and/or DCI.

Although the report configuration 730, the beams-per-group indicator 732, and the groups indicator 734 are illustrated as separate communications in the example of FIG. 7, in other examples, the report configuration 730, the beams-per-group indicator 732, and/or the groups indicator 734 may be provided in a same communication.

Although the example of FIG. 7 shows the first network entity 702 providing the report configuration 730, the beams-per-group indicator 732 and the groups indicator 734 to the UE 704, in other examples, the UE 704 may receive a report configuration, a beams-per-group indicator, and a groups indicator from the second network entity 703 and/or from a third network entity different from the first network entity 702 and the second network entity 703. Additionally, although the example of FIG. 7 shows the UE 704 providing the groups capability 708 to the first network entity 702, in other examples, the UE 704 may additionally, or alternatively, provide a groups capability to the second network entity 703 and/or another network entity.

As shown in FIG. 7, the first network entity 702 and the second network entity 703 may output a plurality of CSI-RS that are received by the UE 704. For example, the first network entity 702 may output CSI-RS 740 via one or more beams 742 associated with the first CMR set 710. In a similar manner, the second network entity 703 may output CSI-RS 744 via one or more beams 746 associated with the second CMR set 720.

The UE 704 may perform a measurement procedure 750 to measure the signal strengths of the beams. In some examples, the UE 704 may measure RSRP (e.g., L1-RSRP) of a beam. Additionally, or alternatively, the UE 704 may measure SINR (e.g., L1-SINR) of a beam.

In the example of FIG. 7, the UE 704 may perform a generation procedure 752 to generate the group-based report 760. The UE 704 may perform the generation procedure 752 to generate the group-based report 760 based on measurements (e.g., obtained via the measurement procedure 750) and a report configuration (e.g., the report configuration 730). The group-based report 760 may indicate a report groups quantity (e.g., a first quantity of groups N). The group-based report 760 may also include a beams-per-report group quantity (e.g., a second quantity M of beams-per-group). The UE 704 may transmit the group-based report 760 to the first network entity 702, the second network entity 703, and/or to a third network entity different from the first network entity 702 and the second network entity 703. In the illustrated example of FIG. 7, the UE 704 transmits the group-based report 760 that is obtained by first network entity 702. The UE 704 may transmit the group-based report 760 periodically, aperiodically, and/or semi-periodically.

In some examples, the UE 704 may perform a storing procedure 770 to store configurations associated with the beams of the group-based report 760. For example, the UE 704 may store a first receiver beam configuration associated with a first beam identifier corresponding to a first measurement value of the group-based report 760. The UE 704 may also store a second receiver beam configuration associated with a second beam identifier corresponding to a second measurement of the group-based report 760.

In the example of FIG. 7, the UE 704 may generate the group-based report 760 to include one or more report groups associated with a respective group of beams that the UE 704 may receive simultaneously from the first network entity 702 and the second network entity 703 via a same receive beam. The beams of the report group may include one beam from each CMR set. For example, a first report group of the group-based report 760 may include two beams including a first beam from the first CMR set 710 associated with the first network entity 702 and a second beam from the second CMR set 720 associated with the second network entity 703.

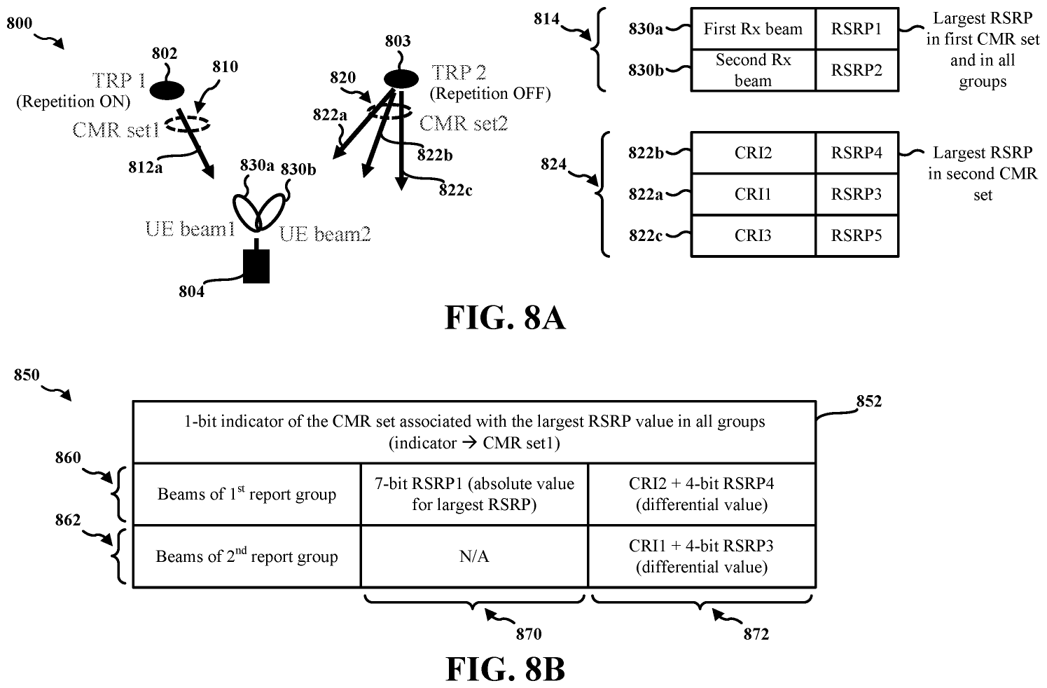

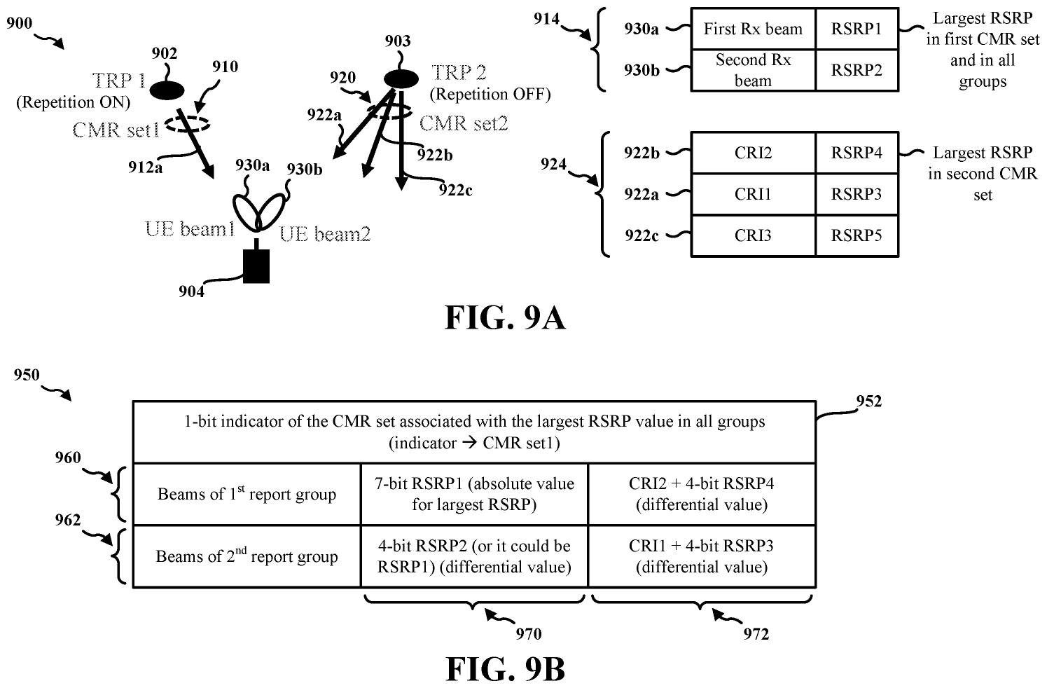

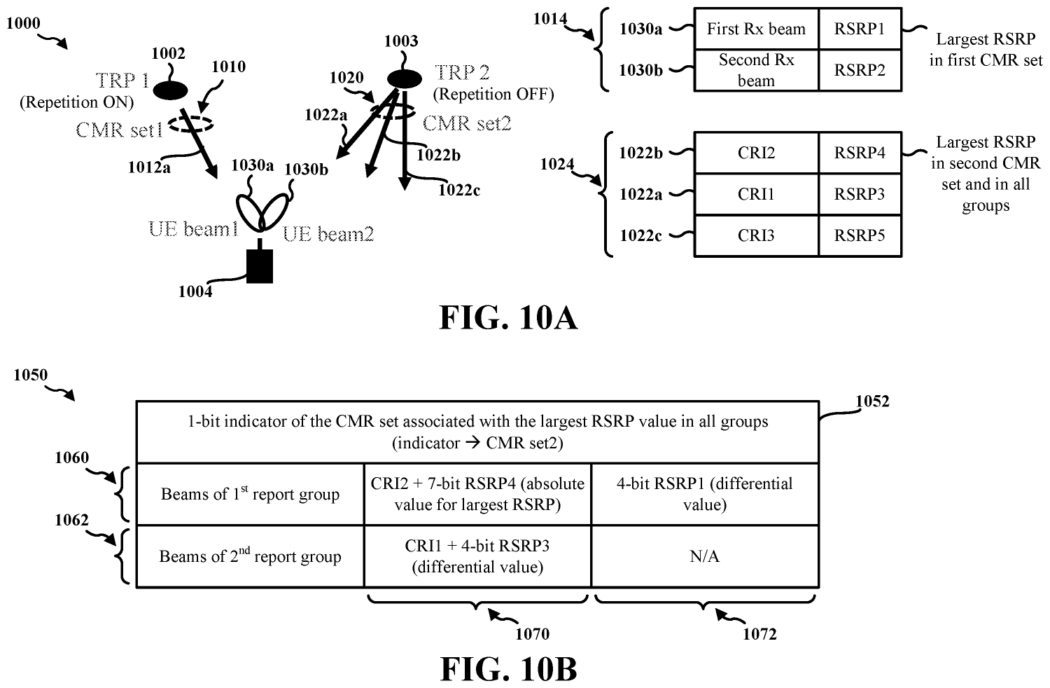

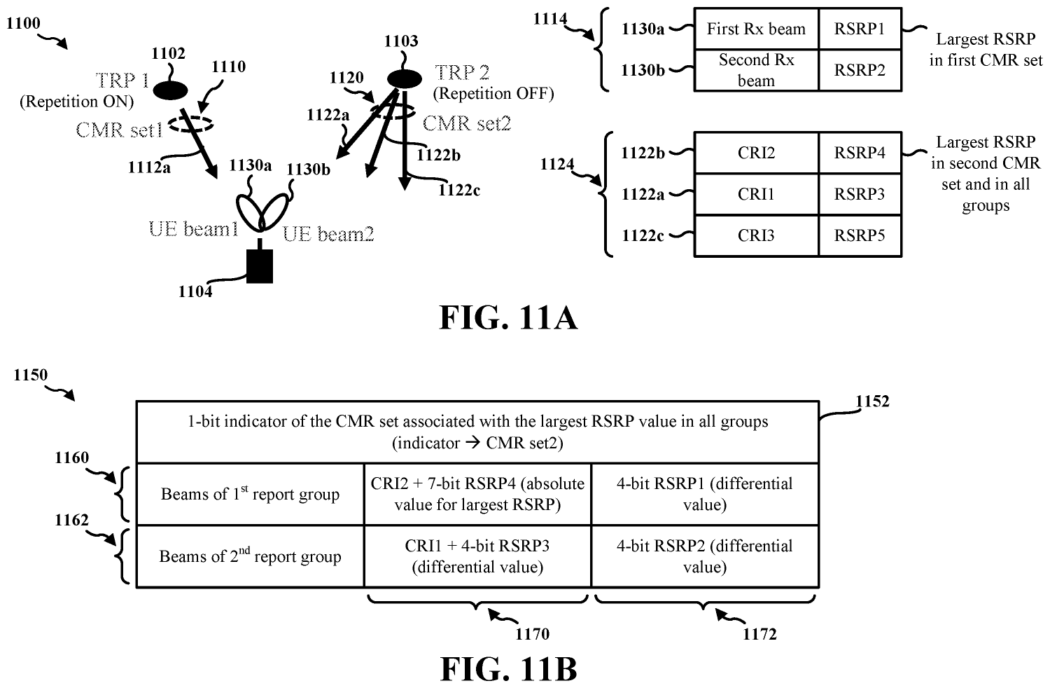

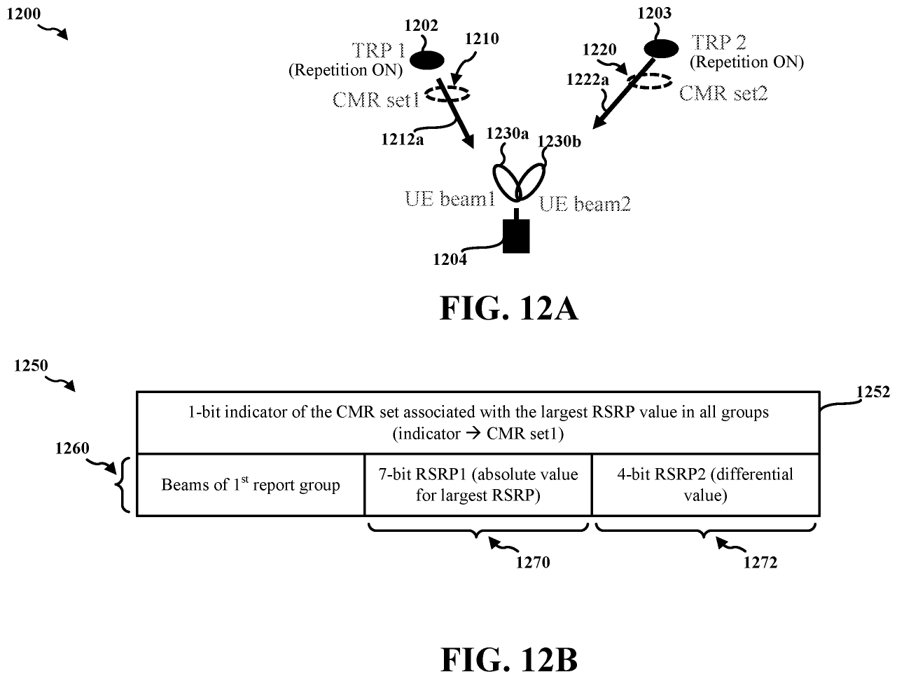

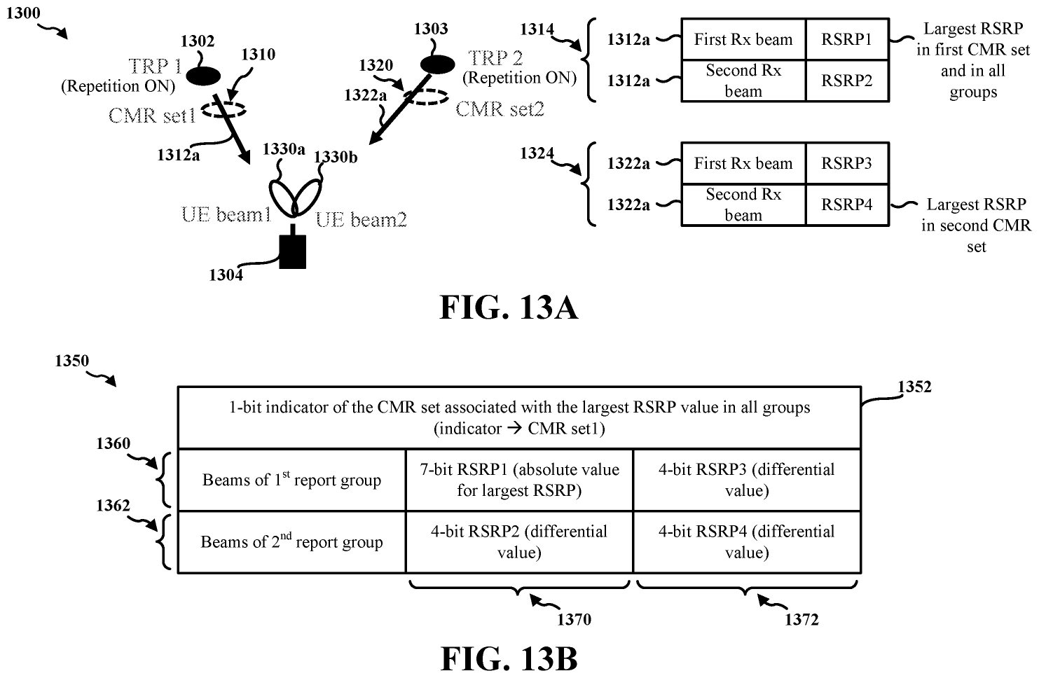

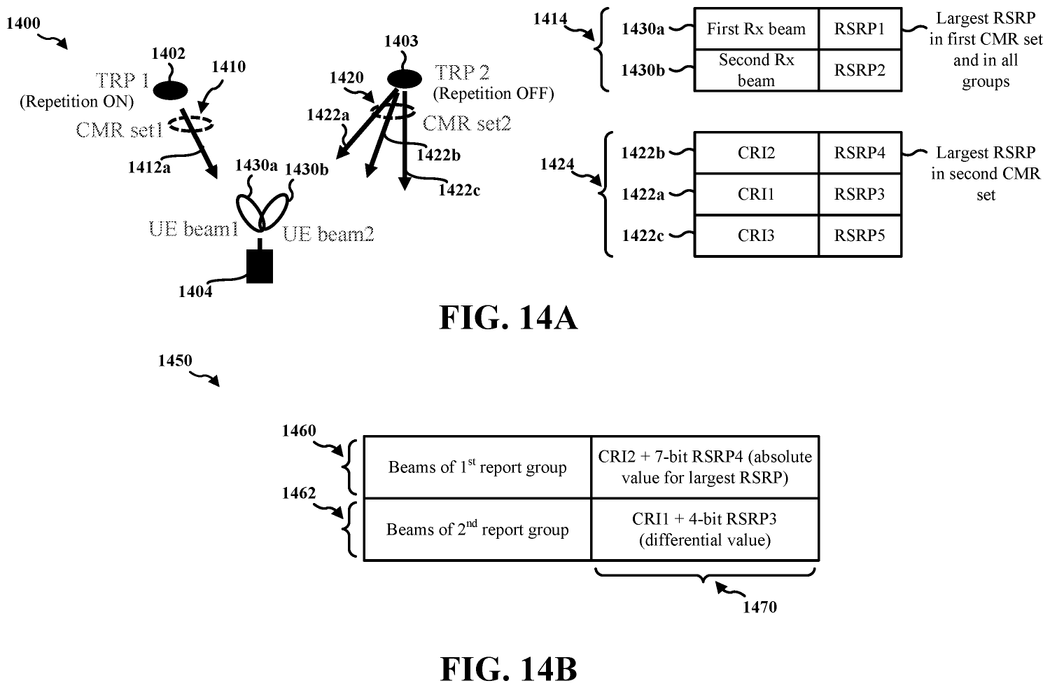

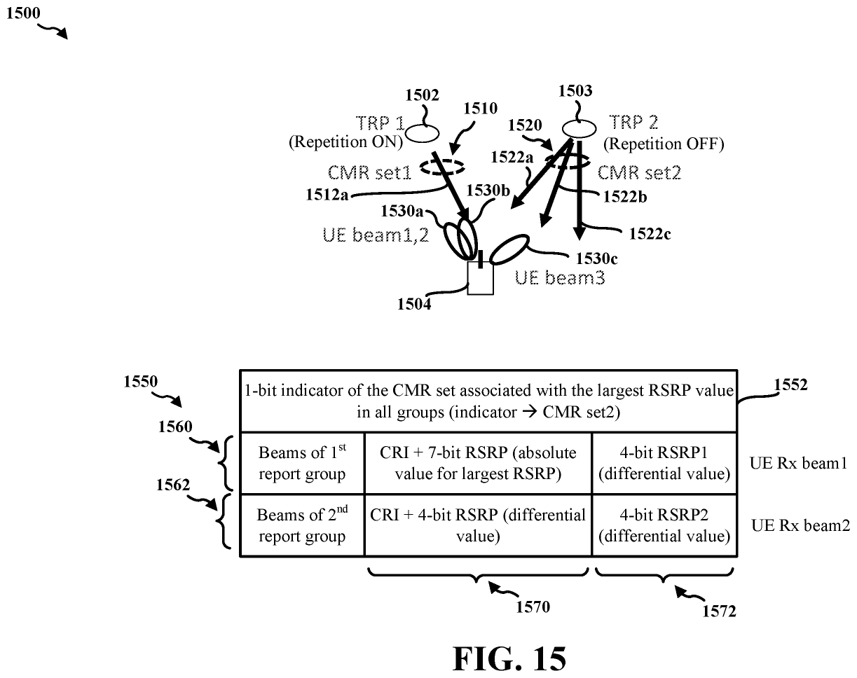

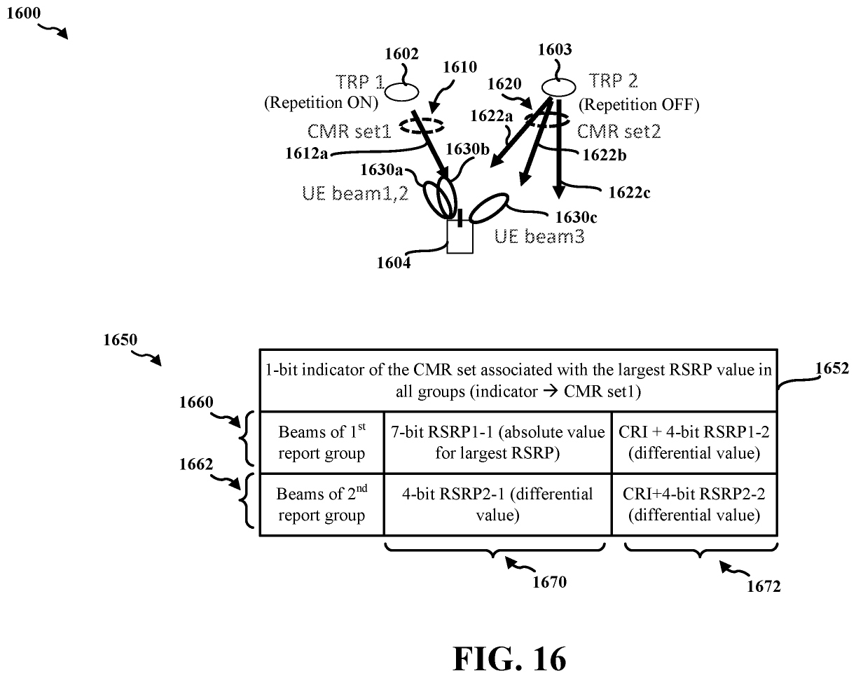

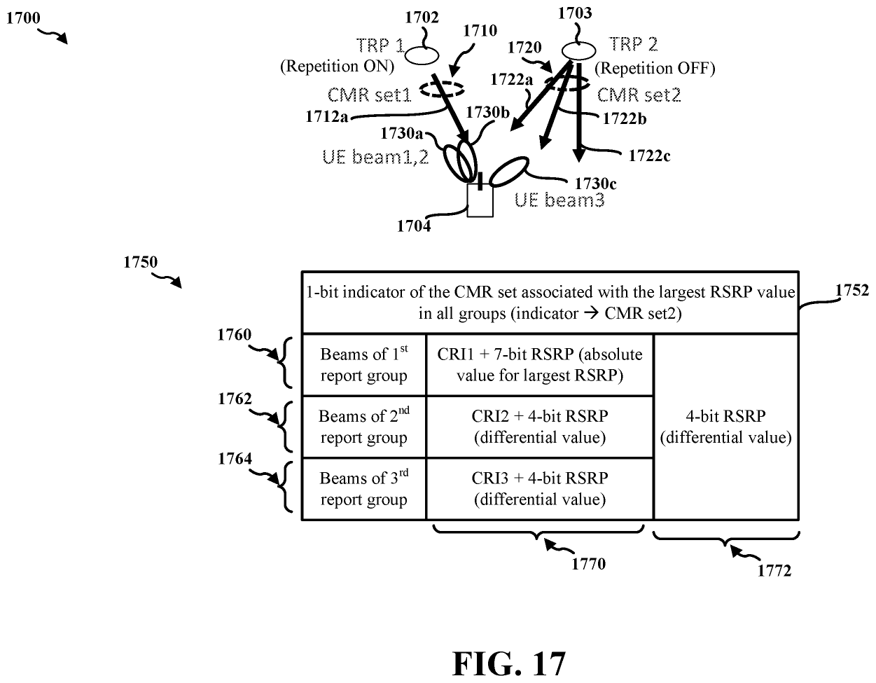

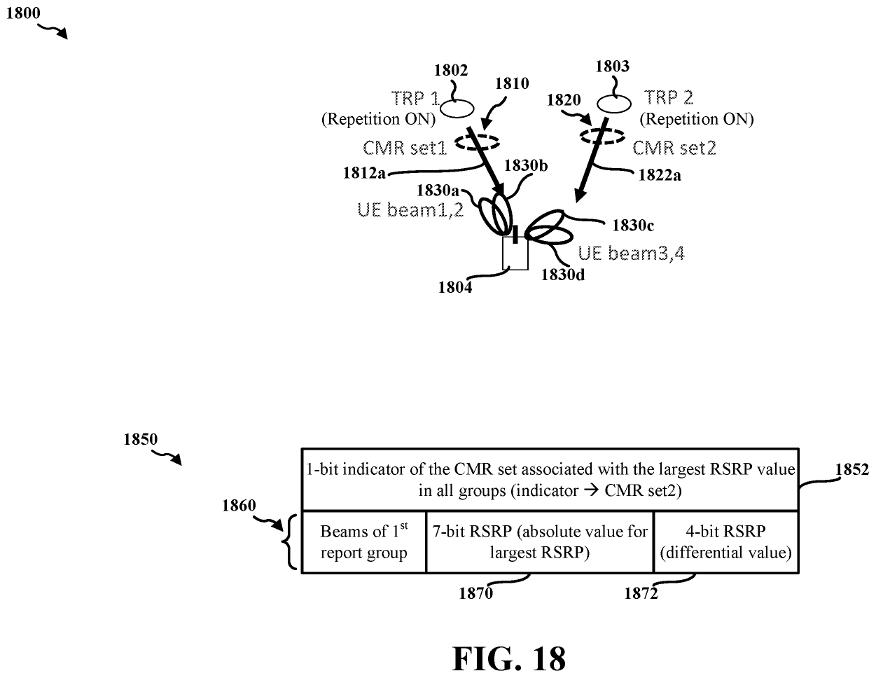

As described in connection with the examples of FIG. 8B, FIG. 9B, FIG. 10B, FIG. 11B, FIG. 12B, FIG. 13B, FIG. 14B, FIG. 15, FIG. 16, FIG. 17, and FIG. 18, the group-based report may exclude a beam identifier for beams of a CMR set configured with repetition ON. Additionally, the group-based report 760 may include zero signal strength measurements, one signal strength measurement, or more than one signal strength measurements for beams of a CMR set configured with repetition ON.

In some examples, the report configuration 730 may configure or indicate a rule associated with the group-based report 760. For example, in a first aspect, no CMR sets associated with the group-based report 760 may be configured with repetition ON. For example, the first CMR set repetition indicator 714 and the second set repetition indicator 724 may be set to values to indicate that repetition for the respective CMR set is OFF. In such examples, the group-based report 760 may be configured with a format corresponding to the example group-based report 550 of FIG. 5B.

In a second aspect, the group-based report 760 may be configured so that the UE 704 does not expect all CMR sets to be configured with repetition ON when the quantity of groups N is greater than one. For example, when the groups indicator 734 indicates that the quantity of groups is one (e.g., N=1), then the first CMR set 710 and the second CMR set 720 may each be configured with repetition ON (e.g., via the first CMR set repetition indicator 714 and the second set repetition indicator 724, respectively). However, when the groups indicator 734 indicates that the quantity of groups N is greater than one, then at least one of the first CMR set 710 and the second CMR set 720 is configured with repetition OFF. Thus, such an example may disallow the scenario in which all CMR sets are configured as repetition ON. Additionally, the quantity of groups N for the UE 704 to include in the group-based report 760 is greater than one.

In another aspect, the report configuration 730 may configure the UE 704 so that at least one CMR set associated with the group-based report 760 is configured with repetition ON. In some such examples, entries for the beam of the CMR set configured with repetition ON may exclude beam identifiers. In some examples, the column of the group-based report 760 corresponding to the beam of the CMR set configured with repetition ON may include a single signal strength measurement (e.g., a single RSRP value or a single SINR value). In such examples, the reported signal strength measurement may correspond to the best refined receive beam. It may be appreciated that the receive beam associated with the reported signal strength may be compatible with the simultaneous reception of the other reported CSI-RS s from the other CMR set.

In some examples, one of the CMR sets may be configured with repetition ON and the beam with the strongest signal strength may be associated with the same CMR set, as described in connection with the examples of FIG. 8A and FIG. 8B, and FIG. 9A and FIG. 9B. In some examples, one of the CMR sets may be configured with repetition ON and the beam with the strongest signal strength may be associated with a different CMR set configured with repetition OFF, as described in connection with the examples of FIG. 10A and FIG. 10B, and FIG. 11A and FIG. 11B. In some examples, all of the CMR sets may be configured with repetition ON, as described in connection with the examples of FIG. 12A and FIG. 12B, and FIG. 13A and FIG. 13B.

In another aspect, the report configuration 730 may configure the UE 704 so that at least one CMR set associated with the group-based report 760 is configured with repetition ON. In some such examples, entries for the beam of the CMR set configured with repetition ON may exclude beam identifiers. In some examples, the column of the group-based report 760 corresponding to the beam of the CMR set configured with repetition ON may include zero signal strength measurements. In some such examples, the report may be similar to a non-group based report, for example, in which the report includes beam identifiers and corresponding measurements for beams associated with the CRM set configured with repetition OFF. Aspects of a group-based report in which the group-based report excludes beam identifiers and corresponding measurements for beams associated with the CMR set configured with repetition ON are described in connection with examples of FIG. 14A and FIG. 14B.

In another aspect, the report configuration 730 may configure the UE 704 so that at least one CMR set associated with the group-based report 760 is configured with repetition ON. Similar to the other examples in which at least one CMR set is configured with repetition ON, entries for the beam of the CMR set configured with repetition ON may exclude beam identifiers. In some examples, the column of the group-based report 760 corresponding to the beam of the CMR set configured with repetition ON may include multiple signal strength measurements. For example, each reported signal strength measurement for the beam of the CMR set configured with repetition ON may correspond to a different receive beam at the UE. It may be appreciated that the receive beam associated with the reported signal strength of each report group may be compatible with the simultaneous reception of the other reported CSI-RSs from the other CMR set for the same report group.

In scenarios in which one CMR set of two CMR sets is configured with repetition ON, the UE may be configured to report, for the CMR set configured with repetition ON, one or more signal strength measurements (e.g., one or more RSRP values). In some such scenarios, each reported RSRP of the CMR set configured with repetition ON may correspond to different Rx beams (e.g., at the UE). Aspects of such scenarios are described in connection with FIG. 15 and FIG. 16.

In another aspect in which one CMR set of two CMR sets is configured with repetition ON, the UE may be configured to report, for the CMR set configured with repetition ON, a single signal strength measurement (e.g., a single RSRP value). Aspects of such scenarios are described in connection with FIG. 17.

In scenarios in which both CMR sets associated with a group-based report are configured with repetition ON, the UE may be configured to report two signal strength measurements (e.g., two RSRP values), each signal strength measurement corresponding to one CMR set. For example, the group-based report may include a first RSRP value corresponding to a first CMR set and a second RSRP value corresponding to a second CMR set. In some such examples, the UE may skip reporting multiple signal strength measurements (e.g., skip reporting multiple RSRP values) from different Rx configurations (e.g., at the UE) as a network entity may be unable to indicate which Rx configuration (e.g., at the UE) is preferred. Aspects of such scenarios are described in connection with FIG. 18.

FIG. 8A is a diagram illustrating an example of a wireless communication system 800 employing a UE 804, a first TRP 802 configured with repetition ON, and a second TRP 803 configured with repetition OFF, as presented herein. As shown in FIG. 8A, the first TRP 802 may be associated with a first CMR set 810 (“CMR set1”) including a first transmit beam 812a. The second TRP 803 is associated with a second CMR set 820 including three transmit beams (e.g., a second transmit beam 822a, a third transmit beam 822b, and a fourth transmit beam 822c). In the example of FIG. 8A, the second transmit beam 822a may be indexed as the first beam (“CRI1”), the third transmit beam 822b may be indexed as the second beam (“CRI2”), and the fourth transmit beam 822c may be indexed as the third beam (“CRI3”). Aspects of the first TRP 802 and the first CMR set 810 may be similar to the first TRP 602 and the first CMR set 610 of FIG. 6A. Aspects of the second TRP 803 and the second CMR set 820 may be similar to the second TRP 603 and the second CMR set 620 of FIG. 6A.

In the example of FIG. 8A, the UE 804 may be configured with a first receive beam 830a (“UE beam1”) and a second receive beam 830b (“UE beam2”). The UE 804 may try the first receive beam 830a and the second receive beam 830b to receive the first transmit beam 812a of the first CMR set 810. As shown in FIG. 8A, the UE 804 may determine a first ordering 814 for the first CMR set 810 based on the measured signal strengths of the first transmit beam 812a via the first receive beam 830a (e.g., RSRP1) and the second receive beam 830b (e.g., RSRP2). In the example of FIG. 8A, the measured signal strength associated with the first receive beam 830a (RSRP1) is stronger than the measured signal strength associated with the second receive beam 830b (RSRP2).

The UE 804 may also determine a second ordering 824 for the second CMR set 820 based on the measured signal strengths of the transmit beams of the second CMR set 820. In the example of FIG. 8A, the measured signal strength associated with the third transmit beam 822b (RSRP4) is stronger than the measured signal strength associated with the second transmit beam 822a (RSRP3), which is stronger than the measured signal strength associated with the fourth transmit beam 822c (RSRP5). In the example of FIG. 8A, the strongest measured signal strength for all beams is associated with the first CMR set 810 (e.g., the CMR set configured with repetition ON).

FIG. 8B is a diagram illustrating an example group-based report 850 to support multiple TRP transmission based on the wireless communication system of FIG. 8A, as presented herein. The group-based report 850 is configured with two groups (e.g., N=2). The example group-based report 850 includes an indicator 852 that indicates the CMR set associated with the strongest measured signal strength. In the example of FIG. 8B, the indicator 852 may be set to a value to indicate that the first CMR set 810 is associated with the largest RSRP value in all of the groups (e.g., RSRP1 associated with the first receive beam 830a).

The example group-based report 850 includes a first row corresponding to a first report group 860 (e.g., a first pair) and a second row corresponding to a second report group 862 (e.g., a second pair). The example group-based report 850 also includes a first column 870 corresponding to beams of the CMR set associated with the strongest measured signal strength (e.g., the first CMR set 810) and a second column 872 corresponding to beams of the other CMR set (e.g., the second CMR set 820).

As shown in the example group-based report 850 of FIG. 8B, the entries for the first CMR set 810 exclude beam identifiers and include a single measured signal strength (e.g., RSRP1). For example, and with respect to the first column 870, the first report group 860 includes a measured signal strength for the first CMR set 810 and the second report group 862 does not include a measured signal strength for the first CMR set 810.

In contrast, entries for the second CMR set 820 in the group-based report 850 include a beam identifier and a measured signal strength for each report group. For example, and with respect to the second column 872, the first report group 860 includes a measured signal strength (RSRP4) corresponding to the third transmit beam 822b. In a similar manner, the second report group 862 includes a measured signal strength (RSRP3) corresponding to the second transmit beam 822a.

In the example of FIG. 8B, the measurement value of the strongest measured signal strength is indicated via an absolute measurement value (e.g., an absolute value for the largest RSRP or RSRP1). The measurement values of the other measured signal strengths are indicated via differential measurement values (e.g., a differential value). Aspects of absolute values and differential values are described in connection with the example of FIG. 5A and FIG. 5B.

FIG. 9A is a diagram illustrating an example of a wireless communication system 900 employing a UE 904, a first TRP 902 configured with repetition ON, and a second TRP 903 configured with repetition OFF, as presented herein. As shown in FIG. 9A, the first TRP 902 may be associated with a first CMR set 910 (“CMR set1”) including a first transmit beam 912a. The second TRP 903 is associated with a second CMR set 920 including three transmit beams (e.g., a second transmit beam 922a, a third transmit beam 922b, and a fourth transmit beam 922c). In the example of FIG. 9A, the second transmit beam 922a may be indexed as the first beam (“CRI1”), the third transmit beam 922b may be indexed as the second beam (“CRI2”), and the fourth transmit beam 922c may be indexed as the third beam (“CRI3”). Aspects of the first TRP 902 and the first CMR set 910 may be similar to the first TRP 802 and the first CMR set 810 of FIG. 8A. Aspects of the second TRP 903 and the second CMR set 920 may be similar to the second TRP 803 and the second CMR set 820 of FIG. 8A.

Similar to the example of FIG. 8A, the UE 904 of FIG. 9A may be configured with a first receive beam 930a (“UE beam1”) and a second receive beam 930b (“UE beam2”). The UE 904 may try to receive the first transmit beam 912a of the first CMR set 910 using the first receive beam 930a and the second receive beam 930b. As shown in FIG. 9A, the UE 904 may determine a first ordering 914 for the first CMR set 910 based on the measured signal strengths of the first transmit beam 99a via the first receive beam 930a (e.g., RSRP1) and the second receive beam 930b (e.g., RSRP2). In the example of FIG. 9A, the measured signal strength associated with the first receive beam 930a (RSRP1) is stronger than the measured signal strength associated with the second receive beam 930b (RSRP2).

The UE 904 may also determine a second ordering 924 for the second CMR set 920 based on the measured signal strengths of the transmit beams of the second CMR set 920. In the example of FIG. 9A, the measured signal strength associated with the third transmit beam 922b (RSRP4) is stronger than the measured signal strength associated with the second transmit beam 922a (RSRP1), which is stronger than the measured signal strength associated with the fourth transmit beam 922c (RSRP3). In the example of FIG. 9A, the strongest measured signal strength for all beams is associated with the first CMR set 910 (e.g., the CMR set configured with repetition ON).

FIG. 9B is a diagram illustrating an example group-based report 950 to support multiple TRP transmission based on the wireless communication system 900 of FIG. 9A, as presented herein. The group-based report 950 is configured with two groups (e.g., N=2). The example group-based report 950 includes an indicator 952 that indicates the CMR set associated with the strongest measured signal strength. In the example of FIG. 9B, the indicator 952 may be set to a value to indicate that the first CMR set 910 is associated with the largest RSRP value in all of the groups (e.g., RSRP1 associated with the first receive beam 930a).

The example group-based report 950 includes a first row corresponding to a first report group 960 (e.g., a first pair) and a second row corresponding to a second report group 962 (e.g., a second pair). The example group-based report 950 also includes a first column 970 corresponding to beams of the CMR set associated with the strongest measured signal strength (e.g., the first CMR set 910) and a second column 972 corresponding to beams of the other CMR set (e.g., the second CMR set 920).

As shown in the example of FIG. 9B, the entries for the first CMR set 910 exclude beam identifiers. In contrast to the example of FIG. 8B in which the group-based report 850 includes a single measured signal strength in the first column, the group-based report 950 of FIG. 9B includes multiple measured signal strengths. For example, and with respect to the first column 970, the first report group 960 includes a first measured signal strength for the first CMR set 910 (RSRP1) and the second report group 962 includes a second measured signal strength for the first CMR set 910. In some examples, the value of the second measured signal strength may correspond to the same beam as the first measured signal strength. For example, the second measured signal strength may be based on the first receive beam 930a of FIG. 9A (e.g., RSRP1). In other examples, the value of the second measured signal strength may correspond to a different beam than the beam associated with the first measured signal strength. For example, the second measured signal strength may be based on the second receive beam 930b of FIG. 9A (e.g., RSRP2).

In the example of FIG. 9B, the entries for the second CMR set 920 in the group-based report 950 may be similar to the entries for the second CMR set 820 in the group-based report 850 of FIG. 8B. For example, and with respect to the second column 972, the first report group 960 includes a measured signal strength (RSRP4) corresponding to the third transmit beam 922b. In a similar manner, the second report group 962 includes a measured signal strength (RSRP3) corresponding to the second transmit beam 922a.

In some examples, the UE 904 may store the receive beam used to measure the reported signal strength associated with the CRIs of the second CMR set 920. For example, the UE 904 may store a configuration indicating that the first report group 960 corresponds to the first receive beam 930a of the UE 904. Similarly, the UE 904 may store a configuration indicating that the second report group 962 corresponds to the second receive beam 930b of the UE 904. Aspects of storing the receive beam are described in connection with the storing procedure 770 of FIG. 7.

In the example of FIG. 9B, the measurement value of the strongest measured signal strength is indicated via an absolute measurement value (e.g., an absolute value for the largest RSRP or RSRP1). The measurement values of the other measured signal strengths are indicated via differential measurement values (e.g., a differential value). Aspects of absolute values and differential values are described in connection with the example of FIG. 5A and FIG. 5B.

FIG. 10A is a diagram illustrating an example of a wireless communication system 1000 employing a UE 1004, a first TRP 1002 configured with repetition ON, and a second TRP 1003 configured with repetition OFF, as presented herein. As shown in FIG. 10A, the first TRP 1002 may be associated with a first CMR set 1010 (“CMR set1”) including a first transmit beam 1012a. The second TRP 1003 is associated with a second CMR set 1020 including three transmit beams (e.g., a second transmit beam 1022a, a third transmit beam 1022b, and a fourth transmit beam 1022c). In the example of FIG. 10A, the second transmit beam 1022a may be indexed as the first beam (“CRI1”), the third transmit beam 1022b may be indexed as the second beam (“CRI2”), and the fourth transmit beam 1022c may be indexed as the third beam (“CRI3”). Aspects of the first TRP 1002 and the first CMR set 1010 may be similar to the first TRP 602 and the first CMR set 610 of FIG. 6A. Aspects of the second TRP 1003 and the second CMR set 1020 may be similar to the second TRP 603 and the second CMR set 620 of FIG. 6A.

Similar to the example of FIG. 8A, the UE 1004 may be configured with a first receive beam 1030a (“UE beam1”) and a second receive beam 1030b (“UE beam2”). The UE 1004 may try to receive the first transmit beam 1012a of the first CMR set 1010 using the first receive beam 1030a and the second receive beam 1030b. As shown in FIG. the UE 1004 may determine a first ordering 1014 for the first CMR set 1010 based on the measured signal strengths of the first transmit beam 1012a via the first receive beam 1030a (e.g., RSRP1) and the second receive beam 1030b (e.g., RSRP2). In the example of FIG. 10A, the measured signal strength associated with the first receive beam 1030a (RSRP1) is stronger than the measured signal strength associated with the second receive beam 1030b (RSRP2).

The UE 1004 may also determine a second ordering 1024 based on the measured signal strengths of the transmit beams of the second CMR set 1020. In the example of FIG. 10A, the measured signal strength associated with the third transmit beam 1022b (RSRP4) is stronger than the measured signal strength associated with the second transmit beam 1022a (RSRP3), which is stronger than the measured signal strength associated with the fourth transmit beam 1022c (RSRP5). In the example of FIG. 10A, the strongest measured signal strength is associated with the second CMR set 1020 (e.g., the CMR set configured with repetition OFF).

FIG. 10B is a diagram illustrating an example group-based report 1050 to support multiple TRP transmission based on the wireless communication system 1000 of FIG. as presented herein. The group-based report 1050 is configured with two report groups (e.g., N=2). The example group-based report 1050 includes an indicator 1052 that indicates the CMR set associated with the strongest measured signal strength. In the example of FIG. 10B, the indicator 1052 may be set to a value to indicate that the second CMR set 1020 is associated with the largest RSRP value in all of the groups (e.g., RSRP4 associated with third transmit beam 1022b).

The example group-based report 1050 includes a first row corresponding to a first report group 1060 (e.g., a first pair) and a second row corresponding to a second report group 1062 (e.g., a second pair). The example group-based report 1050 also includes a first column 1070 corresponding to beams of the CMR set associated with the strongest measured signal strength (e.g., the second CMR set 1020) and a second column 1072 corresponding to beams of the other CMR set (e.g., the first CMR set 1010).

As shown in the example of FIG. 10B, the entries for the first CMR set 1010 exclude beam identifiers and include a single measured signal strength (e.g., RSRP1). For example, and with respect to the second column 1072, the first report group 1060 includes a measured signal strength for the first CMR set 1010 and the second report group 1062 does not include a measured signal strength for the first CMR set 1010.

In contrast, entries for the second CMR set 1020 in the group-based report 1050 (e.g., the first column 1070) include a beam identifier and a measured signal strength for each report group. For example, and with respect to the first column 1070, the first report group 1060 includes a measured signal strength (RSRP4) corresponding to the third transmit beam 1022b. In a similar manner, the second report group 1062 includes a measured signal strength (RSRP3) corresponding to the second transmit beam 1022a.

In the example of FIG. 10B, the measurement value of the strongest measured signal strength is indicated via an absolute measurement value (e.g., an absolute value for the largest RSRP or RSRP4). The measurement values of the other measured signal strengths are indicated via differential measurement values (e.g., a differential value). Aspects of absolute values and differential values are described in connection with the example of FIG. 5A and FIG. 5B.

FIG. 11A is a diagram illustrating an example of a wireless communication system 1100 employing a UE 1104, a first TRP 1102 configured with repetition ON, and a second TRP 1103 configured with repetition OFF, as presented herein. As shown in FIG. 11A, the first TRP 1102 may be associated with a first CMR set 1110 (“CMR set1”) including a first transmit beam 1112a. The second TRP 1103 is associated with a second CMR set 1120 including three transmit beams (e.g., a second transmit beam 1122a, a third transmit beam 1122b, and a fourth transmit beam 1122c). In the example of FIG. 11A, the second transmit beam 1122a may be indexed as the first beam (“CRI1”), the third transmit beam 1122b may be indexed as the second beam (“CRI2”), and the fourth transmit beam 1122c may be indexed as the third beam (“CRI3”). Aspects of the first TRP 1102 and the first CMR set 1110 may be similar to the first TRP 1002 and the first CMR set 1010 of FIG. 10A. Aspects of the second TRP 1103 and the second CMR set 1120 may be similar to the second TRP 1003 and the second CMR set 1020 of FIG. 10A.

Similar to the example of FIG. 10A, the UE 1104 may be configured with a first receive beam 1130a (“UE beam1”) and a second receive beam 1130b (“UE beam2”). The UE 1104 may try to receive the first transmit beam 1112a of the first CMR set 1110 using the first receive beam 1130a and the second receive beam 1130b. As shown in FIG. 11A, the UE 1104 may determine a first ordering 1114 for the first CMR set 1110 based on the measured signal strengths of the first transmit beam 1112a via the first receive beam 1130a (e.g., RSRP1) and the second receive beam 1130b (e.g., RSRP2). In the example of FIG. 11A, the measured signal strength associated with the first receive beam 1130a (RSRP1) is stronger than the measured signal strength associated with the second receive beam 1130b (RSRP2).

The UE 1104 may also determine a second ordering 1124 based on the measured signal strengths of the transmit beams of the second CMR set 1120. In the example of FIG. 11A, the measured signal strength associated with the third transmit beam 1122b (RSRP4) is stronger than the measured signal strength associated with the second transmit beam 1122a (RSRP3), which is stronger than the measured signal strength associated with the fourth transmit beam 1122c (RSRP5). In the example of FIG. 11A, the strongest measured signal strength is associated with the second CMR set 1120 (e.g., the CMR set configured with repetition OFF).

FIG. 11B is a diagram illustrating an example group-based report 1150 to support multiple TRP transmission based on the wireless communication system 1100 of FIG. 11A, as presented herein. The group-based report 1150 is configured with two groups (e.g., N=2). The example group-based report 1150 includes an indicator 1152 that indicates the CMR set associated with the strongest measured signal strength. In the example of FIG. 11B, the indicator 1152 may be set to a value to indicate that the second CMR set 1120 is associated with the largest RSRP value in all of the groups (e.g., RSRP4 associated with third transmit beam 1122b).

The example group-based report 1150 includes a first row corresponding to a first report group 1160 (e.g., a first pair) and a second row corresponding to a second report group 1162 (e.g., a second pair). The example group-based report 1150 also includes a first column 1170 corresponding to beams of the CMR set associated with the strongest measured signal strength (e.g., the second CMR set 1120) and a second column 1172 corresponding to beams of the other CMR set (e.g., the first CMR set 1110).

As shown in the example of FIG. 11B, the entries for the first CMR set 1110 (e.g., the second column 1172) exclude beam identifiers. In contrast to the example of FIG. 10B in which the group-based report 1050 includes a single measured signal strength for the first CMR set 1010, the group-based report 1150 of FIG. 11B includes multiple measured signal strengths for the CMR set configured with repetition ON (e.g., the first CMR set 1110). For example, and with respect to the second column 1172, the first report group 1160 includes a first measured signal strength for the first CMR set 1110 (RSRP1) and the second report group 1162 includes a second measured signal strength for the first CMR set 1110. Similar to the example of FIG. 9B, the value of the second measured signal strength may correspond to the same beam as the first measured signal strength (e.g., the second measured signal strength may correspond to RSRP1) or may correspond to a different beam than the beam associated with the first measured signal strength (e.g., the second measured signal strength may be based on the second receive beam 1130b of FIG. 11A (RSRP2)).

In the example of FIG. 11B, the entries for the second CMR set 1120 in the group-based report 1150 may be similar to the entries for the second CMR set 1020 in the group-based report 1050 of FIG. 10B. For example, and with respect to the first column 1170, the first report group 1160 includes a measured signal strength (RSRP4) corresponding to the third transmit beam 1122b. In a similar manner, the second report group 1162 includes a measured signal strength (RSRP3) corresponding to the second transmit beam 1122a.

In some examples, the UE 1104 may store the receive beam used to measure the reported signal strength associated with the CRIs of the second CMR set 1120. For example, the UE 1104 may store a configuration indicating that the first report group 1160 corresponds to the first receive beam 1130a of the UE 1104. Similarly, the UE 1104 may store a configuration indicating that the second report group 1162 corresponds to the second receive beam 1130b of the UE 1104. Aspects of storing the receive beam are described in connection with the storing procedure 770 of FIG. 7.

In the example of FIG. 11B, the measurement value of the strongest measured signal strength is indicated via an absolute measurement value (e.g., an absolute value for the largest RSRP or RSRP4). The measurement values of the other measured signal strengths are indicated via differential measurement values (e.g., a differential value). Aspects of absolute values and differential values are described in connection with the example of FIG. 5A and FIG. 5B.

FIG. 12A is a diagram illustrating an example of a wireless communication system 1200 employing a UE 1204, a first TRP 1202 configured with repetition ON, and a second TRP 1203 configured with repetition ON, as presented herein. As shown in FIG. 12A, the first TRP 1202 may be associated with a first CMR set 1210 (“CMR set1”) including a first transmit beam 1212a. The second TRP 1203 is associated with a second CMR set 1220 including a second transmit beam 1222a. Aspects of the first TRP 1202 and the first CMR set 1210 may be similar to the first TRP 652 and the first CMR set 660 of FIG. 6B. Aspects of the second TRP 1203 and the second CMR set 1220 may be similar to the second TRP 653 and the second CMR set 670 of FIG. 6B.

Similar to the example of FIG. 8A, the UE 1204 may be configured with a first receive beam 1230a (“UE beam1”) and a second receive beam 1230b (“UE beam2”). The UE 1204 may try to receive the first transmit beam 1212a of the first CMR set 1210 using the first receive beam 1230a and the second receive beam 1230b. The UE 1204 may also try to receive the second transmit beam 1222a of the second CMR set 1220 using the first receive beam 1230a and the second receive beam 1230b. In the example of FIG. 12A, the UE 1204 may determine that the strongest measured signal strength is associated with the first CMR set 1210.

FIG. 12B is a diagram illustrating an example group-based report 1250 to support multiple TRP transmission based on the wireless communication system 1200 of FIG. 12A, as presented herein. The example group-based report 1250 includes an indicator 1252 that indicates the CMR set associated with the strongest measured signal strength. In the example of FIG. 12B, the indicator 1252 may be set to a value to indicate that the first CMR set 1210 is associated with the largest RSRP value in all of the groups (e.g., RSRP1 associated with the first receive beam 1230a).

The example group-based report 1250 includes a first row corresponding to a first report group 1260 (e.g., a first pair). The example group-based report 1250 also includes a first column 1270 corresponding to beams of the CMR set associated with the strongest measured signal strength (e.g., the first CMR set 1210) and a second column 1272 corresponding to beams of the other CMR set (e.g., the second CMR set 1220).

As shown in the example of FIG. 12B, the group-based report 1250 excludes beam identifiers for the first CMR set 1210 and the second CMR set 1220. The group-based report 1250 also includes a single measured signal strength that is reported for each CMR set. Thus, in the illustrated example of FIG. 12B, the group-based report 1250 includes a single report group. In some examples, when all of the CMR sets (e.g., the first CMR set 1210 and the second CMR set 1220 of FIG. 12A) are configured with repetition ON, the UE 1204 may disregard the quantity of groups N indicated by a groups indicator, such as the groups indicator 734 of FIG. 7. For example, if the groups indicator 734 configures a group-based report to include three groups, but all of the CMR sets are configured with repetition ON, the UE 1204 may generate the group-based report 1250 and report measured signal strengths for one report group (e.g., one pair).

In some examples, when all of the CMR sets are configured with repetition ON, the groups indicator 734 may be set to a quantity of one group. For example, the UE 1204 may not expect all of the CMR sets to be configured with repetition ON at least when multiple groups are configured in the group-based report (e.g., when the groups indicator 734 configures the quantity of groups to be greater than one (N>1)). Said differently, when the groups indicator 734 configures the quantity of groups to be greater than one (N>1), the UE 1204 may expect at least one of the CMR sets to be configured with repetition OFF.

In the example of FIG. 12B, the measurement value of the strongest measured signal strength is indicated via an absolute measurement value (e.g., an absolute value for the largest RSRP). The measurement value of the other measured signal strength is indicated via a differential measurement value (e.g., a differential value). Aspects of absolute values and differential values are described in connection with the example of FIG. 5A and FIG. 5B.

FIG. 13A is a diagram illustrating an example of a wireless communication system 1300 employing a UE 1304, a first TRP 1302 configured with repetition ON, and a second TRP 1303 configured with repetition ON, as presented herein. As shown in FIG. 13A, the first TRP 1302 may be associated with a first CMR set 1310 (“CMR set1”) including a first transmit beam 1312a. The second TRP 1303 is associated with a second CMR set 1320 including a second transmit beam 1322a. Aspects of the first TRP 1302 and the first CMR set 1310 may be similar to the first TRP 1202 and the first CMR set 1210 of FIG. 12A. Aspects of the second TRP 1303 and the second CMR set 1320 may be similar to the second TRP 1203 and the second CMR set 1220 of FIG. 12A.

Similar to the example of FIG. 12A, the UE 1304 of FIG. 13A may be configured with a first receive beam 1330a (“UE beam1”) and a second receive beam 1330b (“UE beam2”). The UE 1304 may try to receive the first transmit beam 1312a of the first CMR set 1310 using the first receive beam 1330a and the second receive beam 1330b. The UE 1304 may also try to receive the second transmit beam 1322a of the second CMR set 1320 using the first receive beam 1330a and the second receive beam 1330b.

As shown in FIG. 13A, the UE 1304 may determine a first ordering 1314 for the first CMR set 1310 based on the measured signal strengths of the first transmit beam 1312a via the first receive beam 1330a (e.g., RSRP1) and the second receive beam 1330b (e.g., RSRP2). In the example of FIG. 13A, the measured signal strength associated with the first receive beam 1330a (RSRP1) is stronger than the measured signal strength associated with the second receive beam 1330b (RSRP2).

The UE 1304 may also determine a second ordering 1324 for the second CMR set 1320 based on the measured signal strengths of the second transmit beam 1322a via the first receive beam 1330a (e.g., RSRP3) and the second receive beam 1330b (e.g., RSRP4). In the example of FIG. 13A, the measured signal strength associated with the second receive beam 1330b (RSRP4) is stronger than the measured signal strength associated with the first receive beam 1330a (RSRP3). In the example of FIG. 13A, the strongest measured signal strength is associated with the first CMR set 1310.

FIG. 13B is a diagram illustrating an example group-based report 1350 to support multiple TRP transmission based on the wireless communication system 1300 of FIG. 13A, as presented herein. The example group-based report 1350 includes an indicator 1352 that indicates the CMR set associated with the strongest measured signal strength. In the example of FIG. 13B, the indicator 1352 may be set to a value to indicate that the first CMR set 1310 is associated with the largest RSRP value in all of the groups (e.g., RSRP1 associated with the first receive beam 1330a).

The example group-based report 1350 includes a first row corresponding to a first report group 1360 (e.g., a first pair) and a second row corresponding to a second report group 1362 (e.g., a second pair). The example group-based report 1350 also includes a first column 1370 corresponding to beams of the CMR set associated with the strongest measured signal strength (e.g., the first CMR set 1310) and a second column 1372 corresponding to beams of the other CMR set (e.g., the second CMR set 1320).

As shown in the example of FIG. 13B, the group-based report 1350 excludes beam identifiers for the first CMR set 1310 and the second CMR set 1320. The group-based report 1350 also reports multiple measured signal strengths for each CMR set. For example, the first report group 1360 includes a first measured value (RSRP1) associated with the first receive beam 1330a and the first transmit beam 1312a of the first CMR set 1310. The first report group 1360 also includes a second measured value (RSRP3) associated with the first receive beam 1330a and the second transmit beam 1322a of the second CMR set 1320. The group-based report 1350 also includes a second report group 1362 including a third measured value (RSRP2) and a fourth measured value (RSRP4) based on the second receive beam 1330b and the first transmit beam 1312a of the first CMR set 1310 and the second transmit beam 1322a of the second CMR set 1320, respectively.

In the example of FIG. 13B, the measurement value of the strongest measured signal strength is indicated via an absolute measurement value (e.g., an absolute value for the largest RSRP or RSRP1). The measurement value of the other measured signal strength is indicated via a differential measurement value (e.g., a differential value). Aspects of absolute values and differential values are described in connection with the example of FIG. 5A and FIG. 5B.

At least in some scenarios, a CMR set associated with a group-based report may not be configured as repetition ON. For example, a UE may not expect that both CMR sets are configured as repetition ON, at least when multiple groups are configured in the group-based report (e.g., N>1). For example, and referring to the example of FIG. 7, when the groups indicator 734 indicates that the quantity of groups N is greater than one, then the UE 704 does not that any of the CMR sets associated with the group-based report 760 (e.g., the first CMR set 710 and the second CMR set 720) to be configured as repetition ON.

In another aspect, the network may prevent (both or any) CMR set(s) associated a with group-based report to be configured with repetition ON.

As shown above, in some scenarios, at least one CMR set may be configured with repetition ON. In such scenarios, the UE may be configured to skip reporting CRI for a CMR set configured with repetition ON in the group-based report.

FIG. 14A is a diagram illustrating an example of a wireless communication system 1400 employing a UE 1404, a first TRP 1402 configured with repetition ON, and a second TRP 1403 configured with repetition OFF, as presented herein. As shown in FIG. 14A, the first TRP 1402 may be associated with a first CMR set 1410 (“CMR set1”) including a first transmit beam 1412a. The second TRP 1403 is associated with a second CMR set 1420 including three transmit beams (e.g., a second transmit beam 1422a, a third transmit beam 1422b, and a fourth transmit beam 1422c). In the example of FIG. 14A, the second transmit beam 1422a may be indexed as the first beam (“CRI1”), the third transmit beam 1422b may be indexed as the second beam (“CRI2”), and the fourth transmit beam 1422c may be indexed as the third beam (“CRI3”). Aspects of the first TRP 1402 and the first CMR set 1410 may be similar to the first TRP 802 and the first CMR set 810 of FIG. 8A. Aspects of the second TRP 1403 and the second CMR set 1420 may be similar to the second TRP 803 and the second CMR set 820 of FIG. 8A.

In the example of FIG. 14A, the UE 1404 may be configured with a first receive beam 1430a (“UE beam1”) and a second receive beam 1430b (“UE beam2”). The UE 1404 may try the first receive beam 1430a and the second receive beam 1430b to receive the first transmit beam 1412a of the first CMR set 1410. As shown in FIG. 14A, the UE 1404 may determine a first ordering 1414 for the first CMR set 1410 based on the measured signal strengths of the first transmit beam 1412a via the first receive beam 1430a (e.g., RSRP1) and the second receive beam 1430b (e.g., RSRP2). In the example of FIG. 14A, the measured signal strength associated with the first receive beam 1430a (RSRP1) is stronger than the measured signal strength associated with the second receive beam 1430b (RSRP2).

The UE 1404 may also determine a second ordering 1424 for the second CMR set 1420 based on the measured signal strengths of the transmit beams of the second CMR set 1420. In the example of FIG. 14A, the measured signal strength associated with the third transmit beam 1422b (RSRP4) is stronger than the measured signal strength associated with the second transmit beam 1422a (RSRP3), which is stronger than the measured signal strength associated with the fourth transmit beam 1422c (RSRP5). In the example of FIG. 14A, the strongest measured signal strength is associated with the first CMR set 1410 (e.g., the CMR set configured with repetition ON).

FIG. 14B is a diagram illustrating an example group-based report 1450 to support multiple TRP transmission based on the wireless communication system 1400 of FIG. 14A, as presented herein. The group-based report 1450 is configured with a quantity of two groups (e.g., N=2). In the example of FIG. 14B, the group-based report 1450 excludes beam identifiers and measurement values for beams associated with the CMR set configured with repetition ON. For example, from the perspective of a transmitting node (e.g., the first TRP 1402), the transmitting node uses the same beam and, thus, a measurement value for the beam may introduce overhead. Thus, since information for the beams of the first CMR set 1410 may be excluded from the group-based report 1450, the group-based report 1450 may include a column 1470 providing information related to the CMR set configured with repetition OFF (e.g., the second CMR set 1420).

The example group-based report 1450 includes a first row corresponding to a first report group 1460 and a second row corresponding to a second report group 1462. The example group-based report 1450 also includes the column 1470 corresponding to beams of the second CMR set 1420.

Additionally, the group-based report 1450 of FIG. 14B excludes an indicator indicating the CMR set associated with the strongest measured signal strength as the information provided by the group-based report 1450 corresponds to a single CMR set (e.g., the second CMR set 1420).

In the example of FIG. 14B, the measurement value of the strongest measured signal strength is indicated via an absolute measurement value (e.g., an absolute value for the largest RSRP). The measurement value of the other measured signal strength is indicated via a differential measurement value (e.g., a differential value). Aspects of absolute values and differential values are described in connection with the example of FIG. 5A and FIG. 5B.

FIG. 15 is a diagram illustrating an example of a group-based report 1550 facilitating support of a wireless communication system 1500, as presented herein. Aspects of FIG. 15 may be similar to the examples of FIG. 11A and FIG. 11B. In the example of FIG. 15, one of two CMR sets is configured with repetition ON and a UE 1504 is configured to report multiple signal strength measurements for the CMR set configured with repetition ON. For example, in the example of FIG. 15, a first CMR set 1510 associated with a first TRP 1502 is configured with repetition ON and a second CMR set 1520 associated with a second TRP 1503 is configured with repetition OFF. As shown in FIG. 15, the UE 1504 may be configured with three receive beams (UE beams) (e.g., a first UE beam 1530a, a second UE beam 1530b, and a third UE beam 1530c) to receive communications from the first TRP 1502 and the second TRP 1503.

In the illustrated example of FIG. 15, the strongest measured RSRP value is from the second CMR set 1520 associated with the second TRP 1503. For example, an indicator 1552 of the group-based report 1550 may be set to a value to indicate that the second CMR set 1520 is associated with the largest RSRP value. In the example of FIG. 15, the UE 1504 sweep across the first UE beam 1530a, the second UE beam 1530b, and the third UE beam 1530c to receive communications associated with the first CMR set 1510 from the first TRP 1502. The UE 1504 may perform measurements on the received communications and associate the first UE beam 1530a with a first signal strength measurement (RSRP1) and associate the second UE beam 1530b with a second signal strength measurement (RSRP2).

In some examples, it may be up to the UE 1504 to determine to report RSRP values corresponding to different UE beams, either the first UE beam 1530a or the second UE beam 1530b, to receive the first CMR set 1510.

In some examples, it may be possible that the first UE beam 1530a has a larger RSRP measurement value than the second UE beam 1530b from the first TRP 1502, but also receives more interference from one or more beams of the second TRP 1503.

In some examples, while the UE 1504 may not report SINR (e.g., L1-SINR) in the group-based report 1550, the UE 1504 may still calculate inter-beam SINR based on receiving two CMR sets.

In some examples, the UE 1504 may store the Rx configuration (e.g., an indicator of the first UE beam 1530a or the second UE beam 1530b) associated with the reported rows/reported CRIs of the second TRP 1503. The different reported rows of the group-based report 1550 may correspond to different report groups of beams. In some examples, the UE 1504 may expect to receive a subsequent downlink communication (e.g., a PDSCH) from transmission configuration indications (TCIs) associated with a reported CRI. For example, a TCI codepoint may be configured as TCI codepoint={TCI1 defined by the first CMR set, TCI2 defined by first reported CRI1 from the second CMR set}. In some such examples, the UE 1504 may use the same Rx configuration as the configuration to measure the corresponding reported RSRP.

As shown in the illustrated example of FIG. 15, a first report group 1560 corresponds to the first UE beam 1530a (“UE Rx beam1”) and includes information for resources from the first CMR set 1510 and the second CMR set 1520. For example, and with respect to a second column 1572 of the group-based report 1550, the first report group 1560 includes information for resources from the first CMR set 1510. As shown in FIG. 15, the information includes a 4-bit signal strength measurement (RSRP1) associated with receiving a reference signal (e.g., a CSI-RS) from the first TRP 1502 via the first UE beam 1530a. The UE 1504 may receive the reference signal via a transmit beam 1512a associated with the first CMR set 1510. A first column 1570 of the group-based report 1550 includes, for the first report group 1560, information for resources from the second CMR set 1520. As shown in FIG. 15, the information includes a CRI corresponding to a resource of the second CMR set 1520 and a 7-bit signal strength measurement associated with receiving a reference signal (e.g., a CSI-RS) from the second TRP 1503 via the first UE beam 1530a. The CRI corresponding to the resource of the second CMR set 1520 may be associated with one of the transmit beams of the second CMR set 1520 (e.g., the first transmit beam 1522a, a second transmit beam 1522b, or a third transmit beam 1522c).

In a similar manner, a second row of the group-based report 1550 corresponds to a second report group 1562 and includes information corresponding to the second UE beam 1530b (“UE Rx beam2”). For example, and with respect to the first column 1570, the second report group 1562 includes information for resources from the second CMR set 1520. As shown in FIG. 15, the information includes a beam identifier (e.g., a CRI) and a 4-bit signal strength measurement (RSRP) associated with receiving the reference signal from the second TRP 1503 via the second UE beam 1530b. The UE 1504 may receive the reference signal via a transmit beam associated with the second CMR set 1520. With respect to the second column 1572, the group-based report 1550 includes information for resources from the second CMR set 1520. As shown in FIG. 15, the information includes a 4-bit signal strength measurement (RSRP2) associated with receiving a reference signal (e.g., a CSI-RS) from the second TRP 1503 via the second UE beam 1530b. The UE 1504 may receive the reference signal via a transmit beam associated with the second CMR set 1520.

In the example of FIG. 15, the measurement value of the strongest measured signal strength is indicated via an absolute measurement value (e.g., an absolute value for the largest RSRP). The measurement value of the other measured signal strength is indicated via a differential measurement value (e.g., a differential value). Aspects of absolute values and differential values are described in connection with the example of FIG. 5A and FIG. 5B.

FIG. 16 is a diagram illustrating another example of a group-based report 1650 facilitating support of a wireless communication system 1600, as presented herein. Aspects of the examples of FIG. 16 may be similar to the examples of FIG. 9A and FIG. 9B. In the example of FIG. 16, one of two CMR sets is configured with repetition ON and a UE 1604 is configured to report multiple signal strength measurements for the CMR set configured with repetition ON. For example, in the example of FIG. 16, a first CMR set 1610 associated with a first TRP 1602 is configured with repetition ON and a second CMR set 1620 associated with a second TRP 1603 is configured with repetition OFF. As shown in FIG. 16, the UE 1604 may be configured with three receive beams (UE beams) (e.g., a first UE beam 1630a, a second UE beam 1630b, and a third UE beam 1630c) to receive communications from the first TRP 1602 and the second TRP 1603.

In the illustrated example of FIG. 16, the strongest measured RSRP value is from the first CMR set 1610 associated with the first TRP 1602. For example, an indicator 1652 of the group-based report 1650 may be set to a value to indicate that the first CMR set 1610 is associated with the largest RSRP value. In the example of FIG. 16, the UE 1604 may sweep across the first UE beam 1630a, the second UE beam 1630b, and the third UE beam 1630c to receive communications associated with the first CMR set 1610 from the first TRP 1602. The UE 1604 may perform measurements on the received communications and associate the first UE beam 1630a with a first signal strength measurement (RSRP1-1) and associate the second UE beam 1630b with a second signal strength measurement (RSRP2-1).

Similar to the example of FIG. 15, the UE 1604 of FIG. 16 may store the Rx configuration (e.g., an indicator of the first UE beam 1630a or the second UE beam 1630b) associated with the reported rows/reported CRIs of the second TRP 1603.

As shown in the illustrated example of FIG. 16, a first row of the group-based report 1650 corresponds to a first report group 1660 and a second row corresponds to a second report group 1662. In the illustrated example of FIG. 16, the first row includes information for resources from the first CMR set 1610 and the second CMR set 1620. For example, a first column 1670 of the group-based report 1650 includes information for resources from the first CMR set 1610. In the example of FIG. 16, the information includes a 7-bit signal strength measurement (RSRP1-1) associated with receiving a reference signal (e.g., a CSI-RS) from the first TRP 1602 via the first UE beam 1630a. The UE 1604 may receive the reference signal via a transmit beam 1612a associated with the first CMR set 1610. A second column 1672 of the group-based report 1650 includes, and with respect to the first report group 1660, information for resources from the second CMR set 1620 using the first UE beam 1630a. For example, the second column 1672 includes a CRI corresponding to a resource of the second CMR set 1620 and a 4-bit signal strength measurement (RSRP1-2) associated with receiving a reference signal (e.g., a CSI-RS) from the second TRP 1603 via the first UE beam 1630a. The CRI corresponding to the resource of the second CMR set 1620 may be associated with one of the transmit beams of the second CMR set 1620 (e.g., a first transmit beam 1622a, a second transmit beam 1622b, or a third transmit beam 1622c).

In a similar manner, the second row of the group-based report 1650 provides information corresponding to the second report group 1662. For example, and with respect to the second report group 1662, the first column 1670 includes information for resources from the second CMR set 1620. In the example of FIG. 16, the information includes a 4-bit signal strength measurement (RSRP2-1) associated with receiving a reference signal (e.g., a CSI-RS) from the second TRP 1603 via the second UE beam 1630b. The UE 1604 may receive the reference signal via a transmit beam associated with the second CMR set 1620. The second column 1672 of the group-based report 1650 includes, and with respect to the second report group 1662, information for resources from the second CMR set 1620. For example, the second column 1672 includes a CRI corresponding to a resource of the second CMR set 1620 and a 4-bit signal strength measurement (RSRP2-2) associated with receiving a reference signal (e.g., a CSI-RS) from the second TRP 1603 via the second UE beam 1630b. The CRI corresponding to the resource of the second CMR set 1620 may be associated with one of the transmit beams of the second CMR set 1620 (e.g., a first transmit beam 1622a, a second transmit beam 1622b, or a third transmit beam 1622c).

In some examples, it may be up to the UE 1604 to determine to report RSRP values corresponding to different UE beams (e.g., either the first UE beam 1630a or the second UE beam 1630b) to receive the first CMR set 1610.

In some examples, the UE 1604 may use the same UE Rx beam to measure the signal strength of the first CMR set 1610. In some such examples, the RSRP values associated with the first CMR set 1610 in the group-based report 1650 may correspond to the same signal strength measurement and, thus, a differential RSRP of zero may be reported in the place of RSRP2-1 in the group-based report 1650.

In the example of FIG. 16, the measurement value of the strongest measured signal strength is indicated via an absolute measurement value (e.g., an absolute value for the largest RSRP). The measurement value of the other measured signal strength is indicated via a differential measurement value (e.g., a differential value). Aspects of absolute values and differential values are described in connection with the example of FIG. 5A and FIG. 5B.

FIG. 17 is a diagram illustrating another example of a group-based report 1750 facilitating support of a wireless communication system 1700, as presented herein. Aspects of the examples of FIG. 17 may be similar to the examples of FIG. 10A and FIG. 10B. In the example of FIG. 17, one of two CMR sets is configured with repetition ON and a UE 1704 is configured to report a single signal strength measurement for the CMR set configured with repetition ON. For example, in the example of FIG. 17, a first CMR set 1710 associated with a first TRP 1702 is configured with repetition ON and a second CMR set 1720 associated with a second TRP 1703 is configured with repetition OFF. In the example of FIG. 17, the first CMR set 1710 includes a transmit beam 1712a and the second CMR set 1720 includes a first transmit beam 1722a, a second transmit beam 1722b, and a third transmit beam 1722c. As shown in FIG. 17, the UE 1704 may be configured with three receive beams (UE beams) (e.g., a first UE beam 1730a, a second UE beam 1730b, and a third UE beam 1730c) to receive communications from the first TRP 1702 and the second TRP 1703.

In the illustrated example of FIG. 17, the strongest measured RSRP value is from the second CMR set 1720 associated with the second TRP 1703. For example, an indicator 1752 of the group-based report 1750 may be set to a value to indicate that the second CMR set 1720 is associated with the largest RSRP value. In the illustrated example of FIG. 17, a first column 1770 of the group-based report 1750 corresponds to the second CMR set 1720 and a second column 1772 corresponds to the first CMR set 1710.

In the example of FIG. 17, the UE 1704 may sweep across the first UE beam 1730a, the second UE beam 1730b, and the third UE beam 1730c to receive communications associated with the first CMR set 1710 from the first TRP 1702. The UE 1704 may perform measurements on the received communications and associate the first UE beam 1730a with a first signal strength measurement (RSRP1-1), associate the second UE beam 1730b with a second signal strength measurement (RSRP2-1), and associated the third UE beam 1730c with a third signal strength measurement (RSRP3-1).

In the example of FIG. 17, the UE 1704 is configured to report one RSRP value for the CRM set configured with repetition ON (e.g., the first CMR set 1710). For example, the RSRP value in the second column 1772 corresponding to the first CMR set 1710 may be the first signal strength measurement (RSRP1-1), the second signal strength measurement (RSRP2-1), or the third signal strength measurement (RSRP3-1). The RSRP value may correspond to the strongest signal strength measurement associated with the first CMR set 1710.

Additionally, the signal strength measurements reported for the second CMR set 1720 may be associated with the same UE Rx beam used to measure the reported single RSRP value of the first CMR set 1710. For example, the RSRP value of the second column 1772 associated with the first CMR set 1710 may correspond to the first UE beam 1730a (e.g., the RSPR1-1). In such examples, the RSRP values indicated in the first column 1770 may also correspond to signal strength measurements for the second CMR set 1720 and the first UE beam 1730a.

For example, with respect to the second CMR set 1720, a first report group 1760 includes a first CRI (“CRI1”) corresponding to a first resource of the second CMR set 1720 and a 7-bit signal strength measurement associated with receiving a reference signal (e.g., a CSI-RS) from the second TRP 1703 via the first UE beam 1730a. A second report group 1762 includes a second CRI (“CRI2”) corresponding to a second resource of the second CMR set 1720 and a 4-bit signal strength measurement associated with receiving a reference signal from the second TRP 1703 via the first UE beam 1730a. A third report group of beams 1764 includes a third CRI (“CRI3”) corresponding to a third resource of the second CMR set 1720 and a 4-bit signal strength measurement associated with receiving a reference signal from the second TRP 1703 via the first UE beam 1730a. The CRIs corresponding to the resources of the second CMR set 1720 may be associated with different transmit beams of the second CMR set 1720 (e.g., a first transmit beam 1722a, a second transmit beam 1722b, or a third transmit beam 1722c).

In some examples, the UE 1704 may not report SINR (e.g., an L1-SINR measurement) in the group-based report 1750. In some such examples, the UE 1704 may be configured to choose the best UE receive beam for RSRP (e.g., L1-RSRP) measurements from the first CMR set 1710.

In the example of FIG. 17 the measurement value of the strongest measured signal strength is indicated via an absolute measurement value (e.g., an absolute value for the largest RSRP). The measurement value of the other measured signal strength is indicated via a differential measurement value (e.g., a differential value). Aspects of absolute values and differential values are described in connection with the example of FIG. 5A and FIG. 5B.

FIG. 18 is a diagram illustrating another example of a group-based report 1850 facilitating support of a wireless communication system 1800, as presented herein. Aspects of the examples of FIG. 18 may be similar to the example of FIG. 12A and FIG. 12B. In the examples of FIG. 18, both CMR sets are configured with repetition ON and a UE 1804 is configured to report one signal strength measurement for each CMR set. For example, in the examples of FIG. 18, a first CMR set 1810 associated with a first TRP 1802 is configured with repetition ON and a second CMR set 1820 associated with a second TRP 1803 is configured with repetition ON. As shown in FIG. 18, the first CMR set 1810 includes a first transmit beam 1812a and the second CMR set 1820 includes a second transmit beam 1822a. In the example of FIG. 18, the UE 1804 is configured with four receive beams (UE beams) (e.g., a first UE beam 1830a, a second UE beam 1830b, a third UE beam 1830c, and a fourth UE beam 1830d) to receive communications from the first TRP 1802 and the second TRP 1803.

In the illustrated example of FIG. 18, the strongest measured RSRP value is from the second CMR set 1820 associated with the second TRP 1803. For example, an indicator 1852 of the group-based report 1850 may be set to a value to indicate that the second CMR set 1820 is associated with the largest RSRP value.

As shown in FIG. 18, the group-based report 1850 includes a single report group 1860. The single report group 1860 includes a first RSRP value 1870 and a second RSRP value 1872. The first RSRP value 1870 corresponds to the second CMR set 1820 and the second RSRP value 1872 corresponds to the first CMR set 1810. Thus, in the example of FIG. 18, the UE 1804 is configured to report two RSRP values, one RSRP value for each CMR set.

In some examples in which the CMR sets associated with a group-based report are configured with repetition ON, then the UE may be configured with the quantity of groups N set to one (e.g., N=1). In some examples, the UE may be configured with the quantity of groups N set to one via signaling, such as RRC signaling, a MAC-CE, and/or DCI. For example, and referring to the example of FIG. 7, the groups indicator 734 may be set to a value indicating that the quantity of groups N is one (e.g., N=1).

In some examples in which the CMR sets associated with a group-based report are configured with repetition ON, it may be appreciated that even if the group-based report includes multiple rows associated with multiple Rx beam pair choices, the network may lack the capability to indicate which Rx beam pair is preferred. Thus, including multiple report groups in the group-based report may increase overhead.

In the example of FIG. 18, the measurement value of the strongest measured signal strength is indicated via an absolute measurement value (e.g., an absolute value for the largest RSRP). The measurement value of the other measured signal strength is indicated via a differential measurement value (e.g., a differential value). Aspects of absolute values and differential values are described in connection with the example of FIG. 5A and FIG. 5B.

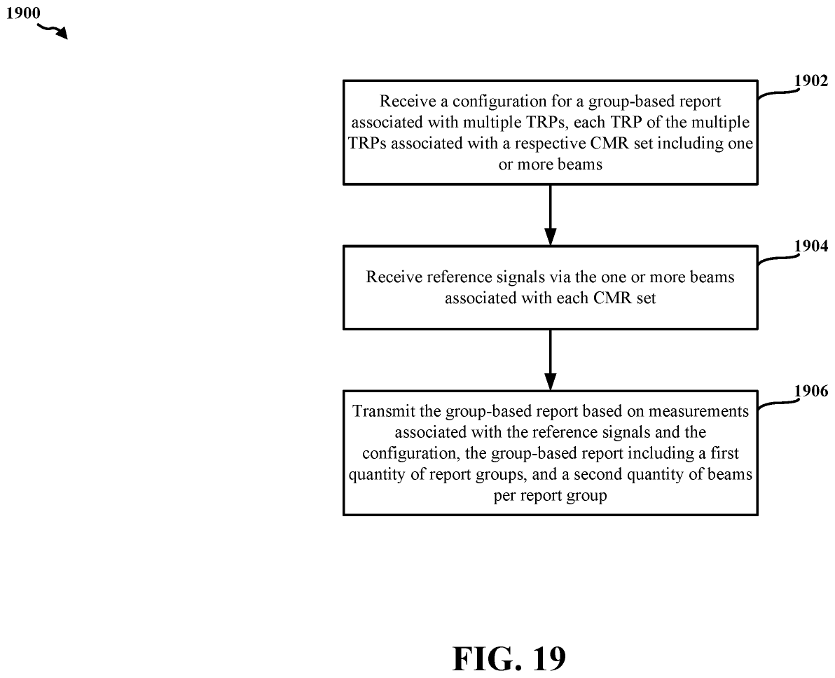

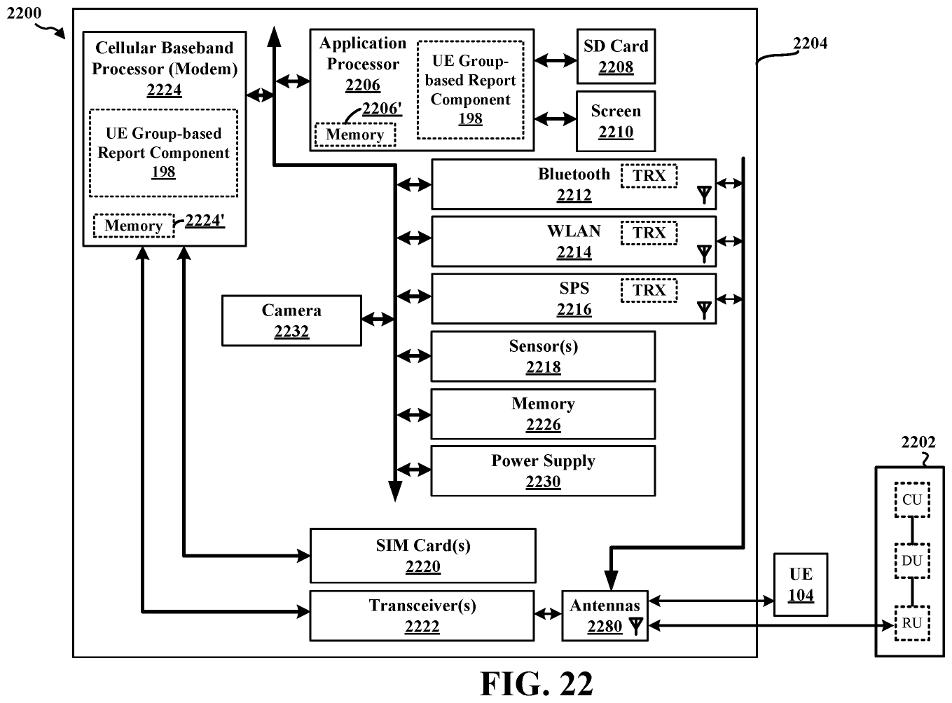

FIG. 19 is a flowchart 1900 of a method of wireless communication. The method may be performed by a UE (e.g., the UE 104, and/or an apparatus 2204 of FIG. 22). The method may facilitate providing group-based reports when at least one CMR set associated with the group-based report is configured with repetition ON.

At 1902, the UE receives a configuration for a group-based report associated with multiple TRPs, each TRP of the multiple TRPs associated with a respective CMR set including one or more beams, as described in connection with the report configuration 730 of FIG. 7. The receiving of the configuration, at 1902, may be performed by a cellular RF transceiver 2222 and/or the UE group-based report component 198 of the apparatus 2204 of FIG. 22.

At 1904, the UE receives reference signals via the one or more beams associated with each CMR set, as described in connection with the CSI-RS 740 and the CSI-RS 744 of FIG. 7. The receiving of the reference signals, at 1904, may be performed by the cellular RF transceiver 2222 and/or the UE group-based report component 198 of the apparatus 2204 of FIG. 22.

At 1906, the UE transmits the group-based report based on measurements associated with the reference signals and the configuration, the group-based report including a first quantity of report groups, and a second quantity of beams-per-report group, as described in connection with at least the group-based report 760 of FIG. 7. The transmitting of the group-based report, at 1906, may be performed by the cellular RF transceiver 2222 and/or the UE group-based report component 198 of the apparatus 2204 of FIG. 22.

In some examples, the measurements may include RSRP (e.g., L1-RSRP) and/or SINR (e.g., L1-SINR), as described in connection with at least the measurement procedure 750 of FIG. 7.

In some examples, the first quantity of report groups may be configured via RRC signaling, as described in connection with at least the groups indicator 734 of FIG. 7.

In some examples, the transmitting of the group-based report, at 1906, may be at least one of aperiodic, semi-periodic, and periodic, as described in connection with at least the group-based report 760 of FIG. 7.

In some examples, each CMR set associated with the group-based report may be configured with repetition OFF, as described in connection with at least the examples of FIG. 5A and FIG. 5B.

In some examples, the first quantity of report groups may be greater than one (e.g., N>1) and at least one CMR set may be configured with repetition OFF.

In some examples, a first CMR set may be configured with repetition ON, a second CMR set may be configured with repetition OFF, and the group-based report may include, for the first CMR set, a single measurement value and exclude beam identifiers, as described in connection with at least the example wireless communication system 800 of FIG. 8A and the group-based report 850 of FIG. 8B. In some examples, the group-based report may include, for the second CMR set, a beam identifier and a corresponding measurement value associated with each respective report group, as described in connection with at least the second column 872 of FIG. 8B.

In some examples, the group-based report may include a first indicator indicating that the first CMR set is associated with a strongest measurement, the single measurement value may indicate an absolute measurement value, and measurement values associated with the second CMR set may indicate differential measurement values, as described in connection with at least the group-based report 850 of FIG. 8B.

In some examples, a first CMR set may be configured with repetition ON, a second CMR set may be configured with repetition OFF, and the group-based report may include a first measurement value and a second measurement value for the first CMR set, and a third measurement value and a fourth measurement value for the second CMR set, and measurement values for the first CMR set may exclude corresponding beam identifiers, as described in connection with at least the example wireless communication system 900 of FIG. 9A and the group-based report 950 of FIG. 9B. In some examples, the group-based report may include respective beam identifiers associated with the third measurement value and the fourth measurement value, as described in connection with the second column 972 of FIG. 9B.

In some examples, the group-based report may include a first indicator indicating that the first CMR set is associated with a strongest measurement, the first measurement value may indicate an absolute measurement value, and the second measurement value, the third measurement value, and the fourth measurement value may each indicate differential measurement values, as described in connection with at least the indicator 952 and the entries of the first report group of beams and the second report group of beams of FIG. 9B. In some examples, the first measurement value and the second measurement value may be associated with a same beam identifier, as described in connection with at least the example when the measurement values of the first column 970 correspond to the first receive beam 930a of FIG. 9B. In some examples, the first measurement value and the second measurement value may be associated with different beam identifiers, as described in connection with at least the example when the first measurement value of the first column 970 corresponds to the first receive beam 930a and the second measurement value of the first column 970 corresponds to the second receive beam 930b of FIG. 9B.

In some examples, the group-based report may include a first indicator indicating that the second CMR set is associated with a strongest measurement, the single measurement value may indicate a differential measurement value, and measurement values associated with the second CMR set may indicate an absolute measurement value for a first report group and one or more different measurement values for remaining report groups of the group-based report, as described in connection with at least the group-based report 1050 of FIG. 10B.

In some examples, the group-based report may include a first indicator indicating that the second CMR set is associated with a strongest measurement, the third measurement value may indicate an absolute measurement value, and the first measurement value, the second measurement value, and the fourth measurement value may each indicate differential measurement values, as described in connection with at least the indicator 1152 and the entries of the first report group of beams and the second report group of beams of FIG. 11B.

In some examples, the third measurement value and the fourth measurement value may be associated with a same beam identifier, as described in connection with at least the example when the measurement values of the second column 1172 correspond to the first receive beam 1130a of FIG. 11B. In some examples, the third measurement value and the fourth measurement value may be associated with different beam identifiers, as described in connection with at least the example when the third measurement value of the second column 1172 corresponds to the first receive beam 1130a and the fourth measurement value of the second column 1172 corresponds to the second receive beam 1130b of FIG. 11B.

In some examples, a first CMR set and a second CMR set may each be configured with repetition ON, and the group-based report may include one report group including a first measurement value associated with the first CMR set and a second measurement value associated with the second CMR set, as described in connection with at least the example wireless communication system 1200 of FIG. 12A and the group-based report 1250 of FIG. 12B. In some examples, the group-based report may exclude beam identifiers associated with the first CMR set and the second CMR set, as described in connection with at least the group-based report 1250 of FIG. 12B.

In some examples, the group-based report may include a first indicator indicating that the first CMR set is associated with a strongest measurement, the first measurement value may indicate an absolute measurement value, and the second measurement value may indicate a differential measurement value, as described in connection with at least the group-based report 1250 of FIG. 12B. In other examples, the first indicator may indicate that the second CMR set is associated with a strongest measurement, the first measurement value may indicate a differential measurement value, and the second measurement value may indicate an absolute measurement value.

In some examples, a first CMR set and a second CMR set may each be configured with repetition ON, and the group-based report may include a first measurement value and a second measurement value for the first CMR set, and a third measurement value and a fourth measurement value for the second CMR set, and measurement values for the first CMR set and the second CMR set may exclude corresponding beam identifiers, as described in connection with at least the examples of FIG. 13A and FIG. 13B.

In some examples, the group-based report may include a first indicator indicating that the first CMR set is associated with a strongest measurement, the first measurement value may indicate an absolute measurement value, and the second measurement value, the third measurement value, and the fourth measurement value may each indicate differential measurement values, as described in connection with at least the group-based report 1350 of FIG. 13B. In other examples, the first indicator may indicate that the second CMR set is associated with a strongest measurement, the third measurement value may indicate an absolute measurement value, and the first measurement value, the second measurement value, and the fourth measurement value each indicate differential measurement values.

In some examples, a first CMR set may be configured with repetition ON, a second CMR set may be configured with repetition OFF, and the group-based report may exclude information associated with the first CMR set and may include, for the second CMR set, a beam identifier and a corresponding measurement value associated with each respective report group, as described in connection with at least the example wireless communication system 1400 of FIG. 14A and the group-based report 1450 of FIG. 14B.

In some examples, the UE may be configured to store a first receive beam configuration associated a first beam identifier corresponding to the third measurement value. The UE may also store a second receiver beam configuration associated with a second beam identifier corresponding to the fourth measurement value. Aspects of storing the receive beam configuration are described in connection with at least the storing procedure 770 of FIG. 7.

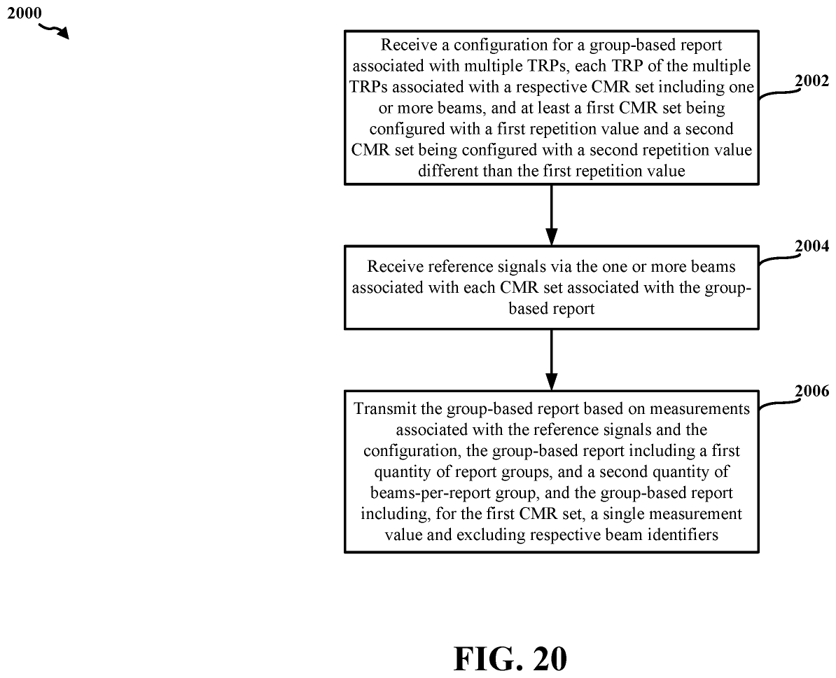

FIG. 20 is a flowchart 2000 of a method of wireless communication. The method may be performed by a UE (e.g., the UE 104, and/or an apparatus 2204 of FIG. 22). The method may facilitate providing group-based reports when at least one CMR set associated with the group-based report is configured with repetition ON.

At 2002, the UE receives a configuration for a group-based report associated with multiple TRPs, each TRP of the multiple TRPs associated with a respective CMR set including one or more beams, and at least a first CMR set being configured with a first repetition value and a second CMR set being configured with a second repetition value different than the first repetition value, as described in connection with at least the report configuration 730 of FIG. 7. The receiving of the configuration, at 2002, may be performed by a cellular RF transceiver 2222 and/or the UE group-based report component 198 of the apparatus 2204 of FIG. 22.

At 2004, the UE receives reference signals via the one or more beams associated with each CMR set associated with the group-based report, as described in connection with the CSI-RS 740 and the CSI-RS 744 of FIG. 7. The receiving of the reference signals, at 2004, may be performed by the cellular RF transceiver 2222 and/or the UE group-based report component 198 of the apparatus 2204 of FIG. 22.

At 2006, the UE transmits the group-based report based on measurements associated with the reference signals and the configuration, the group-based report including a first quantity of report groups, and a second quantity of beams-per-report group, and the group-based report including, for the first CMR set, a single measurement value and excluding respective beam identifiers, as described in connection with at least the group-based report 760 of FIG. 7. The transmitting of the group-based report, at 2006, may be performed by the cellular RF transceiver 2222 and/or the UE group-based report component 198 of the apparatus 2204 of FIG. 22.

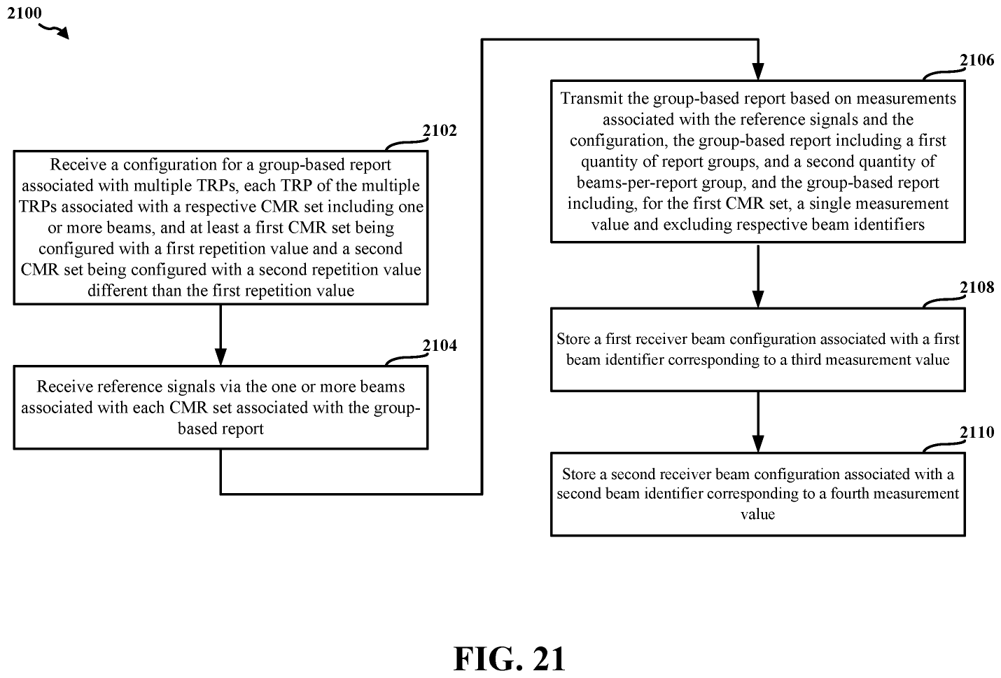

FIG. 21 is a flowchart 2100 of a method of wireless communication. The method may be performed by a UE (e.g., the UE 104, and/or an apparatus 2204 of FIG. 22). The method may facilitate providing group-based reports when at least one CMR set associated with the group-based report is configured with repetition ON.

At 2102, the UE receives a configuration for a group-based report associated with multiple TRPs, each TRP of the multiple TRPs associated with a respective CMR set including one or more beams, and at least a first CMR set being configured with a first repetition value and a second CMR set being configured with a second repetition value different than the first repetition value, as described in connection with at least the report configuration 730 of FIG. 7, the wireless communication system 800 of FIG. 8A, and the group-based report 850 of FIG. 8B. The first repetition value may correspond to repetition ON and the second repetition value may correspond to repetition OFF. The receiving of the configuration, at 2102, may be performed by a cellular RF transceiver 2222 and/or the UE group-based report component 198 of the apparatus 2204 of FIG. 22.

At 2104, the UE receives reference signals via the one or more beams associated with each CMR set associated with the group-based report, as described in connection with the CSI-RS 740 and the CSI-RS 744 of FIG. 7. The receiving of the reference signals, at 2104, may be performed by the cellular RF transceiver 2222 and/or the UE group-based report component 198 of the apparatus 2204 of FIG. 22.

At 2106, the UE transmits the group-based report based on measurements associated with the reference signals and the configuration, the group-based report including a first quantity of report groups, and a second quantity of beams-per-report group, and the group-based report including, for the first CMR set, a single measurement value and excluding respective beam identifiers, as described in connection with at least the group-based report 760 of FIG. 7, and the group-based report 850 of FIG. 8B. The transmitting of the group-based report, at 2106, may be performed by the cellular RF transceiver 2222 and/or the UE group-based report component 198 of the apparatus 2204 of FIG. 22.

At 2108, the UE may store a first receiver beam configuration associated with a first beam identifier corresponding to a third measurement value. At 2110, the UE may store a second receiver beam configuration associated with a second beam identifier corresponding to a fourth measurement value. Aspects of 2108 and 2110 are described in connection with at least the storing procedure 770 of FIG. 7. The storing of the receive beam configurations, at 2108 and 2110, may be performed by the UE group-based report component 198 of the apparatus 2204 of FIG. 22.

In some examples, the measurements may include RSRP (e.g., L1-RSRP) and/or SINR (e.g., L1-SINR), as described in connection with at least the measurement procedure 750 of FIG. 7.

In some examples, the first quantity of report groups may be configured via signaling, such as RRC signaling, a MAC-CE, and/or DCI, as described in connection with at least the groups indicator 734 of FIG. 7.

In some examples, the transmitting of the group-based report, at 2106, may be at least one of aperiodic, semi-periodic, and periodic, as described in connection with at least the group-based report 760 of FIG. 7.

In some examples, the first quantity of report groups may be greater than one (e.g., N>1) and at least the second CMR set may be configured with the second repetition value.

In some examples, the group-based report may include, for the second CMR set, a beam identifier and a corresponding measurement value associated with each respective report group, as described in connection with at least the second column 872 of FIG. 8B. In some examples, the group-based report may include an indicator indicating that the first CMR set is associated with a strongest measurement, the single measurement value may indicate an absolute measurement value, and measurement values associated with the second CMR set may indicate differential measurement values, as described in connection with at least the group-based report 850 of FIG. 8B.

In some examples, the group-based report may include a first measurement value and a second measurement value for the first CMR set, and a third measurement value and a fourth measurement value for the second CMR set, and measurement values for the first CMR set may exclude corresponding beam identifiers, as described in connection with at least the example wireless communication system 900 of FIG. 9A and the group-based report 950 of FIG. 9B. In some examples, the group-based report may include respective beam identifiers associated with the third measurement value and the fourth measurement value, as described in connection with the second column 972 of FIG. 9B.

In some examples, the group-based report may include an indicator indicating that the first CMR set is associated with a strongest measurement, the first measurement value may indicate an absolute measurement value, and the second measurement value, the third measurement value, and the fourth measurement value may each indicate differential measurement values, as described in connection with at least the indicator 952 and the entries of the first report group of beams and the second report group of beams of FIG. 9B. In some examples, the first measurement value and the second measurement value may be associated with a same beam identifier, as described in connection with at least the example when the measurement values of the first column 970 correspond to the first receive beam 930a of FIG. 9B. In some examples, the first measurement value and the second measurement value may be associated with different beam identifiers, as described in connection with at least the example when the first measurement value of the first column 970 corresponds to the first receive beam 930a and the second measurement value of the first column 970 corresponds to the second receive beam 930b of FIG. 9B.

In some examples, the group-based report may include an indicator indicating that the second CMR set is associated with a strongest measurement, the single measurement value may indicate a differential measurement value, and measurement values associated with the second CMR set may indicate an absolute measurement value for a first report group and one or more differential measurement values for remaining report groups of the group-based report, as described in connection with at least the group-based report 1050 of FIG. 10B.

In some examples, the group-based report may include an indicator indicating that the second CMR set is associated with a strongest measurement, the third measurement value may indicate an absolute measurement value, and the first measurement value, the second measurement value, and the fourth measurement value may each indicate differential measurement values, as described in connection with at least the indicator 1152 and the entries of the first report group of beams and the second report group of beams of FIG. 11B.

In some examples, the third measurement value and the fourth measurement value may be associated with a same beam identifier, as described in connection with at least the example when the measurement values of the second column 1172 correspond to the first receive beam 1130a of FIG. 11B. In some examples, the third measurement value and the fourth measurement value may be associated with different beam identifiers, as described in connection with at least the example when the third measurement value of the second column 1172 corresponds to the first receive beam 1130a and the fourth measurement value of the second column 1172 corresponds to the second receive beam 1130b of FIG. 11B.

In some examples, the first CMR set and a third CMR set may each be configured with repetition ON, and the group-based report may include one report group including a first measurement value associated with the first CMR set and a second measurement value associated with the third CMR set, as described in connection with at least the example wireless communication system 1200 of FIG. 12A and the group-based report 1250 of FIG. 12B. In some examples, the group-based report may exclude, for the first CMR set and the third CMR set, corresponding beam identifiers, as described in connection with at least the group-based report 1250 of FIG. 12B.

In some examples, the group-based report may include a first indicator indicating that the first CMR set is associated with a strongest measurement, the first measurement value may indicate an absolute measurement value, and the second measurement value may indicate a differential measurement value, as described in connection with at least the group-based report 1250 of FIG. 12B. In other examples, a second indicator may indicate that the third CMR set is associated with a strongest measurement, the first measurement value may indicate a differential measurement value, and the second measurement value may indicate an absolute measurement value.

In some examples, the first CMR set and a third CMR set may each be configured with repetition ON, and the group-based report may include a first measurement value and a second measurement value for the first CMR set, and a third measurement value and a fourth measurement value for the third CMR set, and measurement values for the first CMR set and the third CMR set may respectively exclude corresponding beam identifiers, as described in connection with at least the examples of FIG. 13A and FIG. 13B.

In some examples, the group-based report may include an indicator indicating that the first CMR set is associated with a strongest measurement, the first measurement value may indicate an absolute measurement value, and the second measurement value, the third measurement value, and the fourth measurement value may each indicate differential measurement values, as described in connection with at least the group-based report 1350 of FIG. 13B. In other examples, the first indicator may indicate that the third CMR set is associated with a strongest measurement, the third measurement value may indicate an absolute measurement value, and the first measurement value, the second measurement value, and the fourth measurement value each indicate differential measurement values.

In some examples, the first CMR set may be configured with the first repetition value, the second CMR set may be configured with the second repetition value, and the group-based report may exclude information associated with the first CMR set and may include, for the second CMR set, a beam identifier and a corresponding measurement value associated with each respective report group, as described in connection with at least the example wireless communication system 1400 of FIG. 14A and the group-based report 1450 of FIG. 14B.

FIG. 22 is a diagram 2200 illustrating an example of a hardware implementation for an apparatus 2204. The apparatus 2204 may be a UE, a component of a UE, or may implement UE functionality. In some aspects, the apparatus 2204 may include a cellular baseband processor 2224 (also referred to as a modem) coupled to one or more transceivers (e.g., a cellular RF transceiver 2222). The cellular baseband processor 2224 may include on-chip memory 2224′. In some aspects, the apparatus 2204 may further include one or more subscriber identity modules (SIM) cards 2220 and an application processor 2206 coupled to a secure digital (SD) card 2208 and a screen 2210. The application processor 2206 may include on-chip memory 2206′. In some aspects, the apparatus 2204 may further include a Bluetooth module 2212, a WLAN module 2214, an SPS module 2216 (e.g., GNSS module), one or more sensor modules 2218 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 2226, a power supply 2230, and/or a camera 2232. The Bluetooth module 2212, the WLAN module 2214, and the SPS module 2216 may include an on-chip transceiver (TRX) (or in some cases, just a receiver (RX)). The Bluetooth module 2212, the WLAN module 2214, and the SPS module 2216 may include their own dedicated antennas and/or utilize one or more antennas 2280 for communication. The cellular baseband processor 2224 communicates through transceiver(s) (e.g., the cellular RF transceiver 2222) via one or more antennas 2280 with the UE 104 and/or with an RU associated with a network entity 2202. The cellular baseband processor 2224 and the application processor 2206 may each include a computer-readable medium/memory, such as the on-chip memory 2224′, and the on-chip memory 2206′, respectively. The additional memory modules 2226 may also be considered a computer-readable medium/memory. Each computer-readable medium/memory (e.g., the on-chip memory 2224′, the on-chip memory 2206′, and/or the additional memory modules 2226) may be non-transitory. The cellular baseband processor 2224 and the application processor 2206 are each responsible for general processing, including the execution of software stored on the computer-readable medium/memory. The software, when executed by the cellular baseband processor 2224/application processor 2206, causes the cellular baseband processor 2224/application processor 2206 to perform the various functions described supra. The computer-readable medium/memory may also be used for storing data that is manipulated by the cellular baseband processor 2224/application processor 2206 when executing software. The cellular baseband processor 2224/application processor 2206 may be a component of the UE 350 and may include the at least one memory 360 and/or at least one of the TX processor 368, the RX processor 356, and the controller/processor 359. In one configuration, the apparatus 2204 may be a processor chip (modem and/or application) and include just the cellular baseband processor 2224 and/or the application processor 2206, and in another configuration, the apparatus 2204 may be the entire UE (e.g., see the UE 350 of FIG. 3) and include the additional modules of the apparatus 2204.

As discussed supra, the UE group-based report component 198 may be configured to: receive a configuration for a group-based report associated with multiple TRPs, each TRP of the multiple TRPs associated with a respective CMR set including one or more beams, and at least a first CMR set being configured with a first repetition value and a second CMR set being configured with a second repetition value different than the first repetition value; receive reference signals via the one or more beams associated with each CMR set associated with the group-based report; and transmit the group-based report based on measurements associated with the reference signals and the configuration, the group-based report including a first quantity of report groups, and a second quantity of beams-per-report group, and the group-based report including, for the first CMR set, a single measurement value and excluding respective beam identifiers. The UE group-based report component 198 may also be configured to: receive a configuration for a group-based report associated with multiple TRPs, each TRP of the multiple TRPs associated with a respective CMR set including one or more beams; receive reference signals via the one or more beams associated with each CMR set; and transmit the group-based report based on measurements associated with the reference signals and the configuration, the group-based report including a first quantity of report groups, and a second quantity of beams per report group.

The UE group-based report component 198 may be within the cellular baseband processor 2224, the application processor 2206, or both the cellular baseband processor 2224 and the application processor 2206. The UE group-based report component 198 may be one or more hardware components specifically configured to carry out the stated processes/algorithm, implemented by one or more processors configured to perform the stated processes/algorithm, stored within a computer-readable medium for implementation by one or more processors, or some combination thereof.

As shown, the apparatus 2204 may include a variety of components configured for various functions. For example, the UE group-based report component 198 may include one or more hardware components that perform each of the blocks of the algorithm in the flowcharts of FIG. 19, FIG. 20, and/or FIG. 21.

In one configuration, the apparatus 2204, and in particular the cellular baseband processor 2224 and/or the application processor 2206, may include means for receiving a configuration for a group-based report associated with multiple TRPs, each TRP of the multiple TRPs associated with a respective CMR set including one or more beams, and at least a first CMR set being configured with a first repetition value and a second CMR set being configured with a second repetition value different than the first repetition value. The example apparatus 2204 also includes means for receiving reference signals via the one or more beams associated with each CMR set associated with the group-based report. The example apparatus 2204 also includes means for transmitting the group-based report based on measurements associated with the reference signals and the configuration, the group-based report including a first quantity of report groups, and a second quantity of beams-per-report group, and the group-based report including, for the first CMR set, a single measurement value and excluding respective beam identifiers.

In another configuration, the example apparatus 2204 also includes means for storing a first receiver beam configuration associated with a first beam identifier corresponding to the third measurement value.

In another configuration, the example apparatus 2204 also includes means for storing a second receiver beam configuration associated with a second beam identifier corresponding to the fourth measurement value.

In another configuration, the example apparatus 2204 also includes means for receiving a configuration for a group-based report associated with multiple TRPs, each TRP of the multiple TRPs associated with a respective CMR set including one or more beams. The example apparatus 2204 also includes means for receiving reference signals via the one or more beams associated with each CMR set. The example apparatus 2204 also includes means for transmitting the group-based report based on measurements associated with the reference signals and the configuration, the group-based report including a first quantity of report groups, and a second quantity of beams per report group.

In another configuration, the example apparatus 2204 also includes means for storing a first receiver beam configuration associated with a first beam identifier corresponding to the third measurement value. The example apparatus 2204 also includes means for storing a second receiver beam configuration associated with a second beam identifier corresponding to the fourth measurement value.

The means may be the UE group-based report component 198 of the apparatus 2204 configured to perform the functions recited by the means. As described supra, the apparatus 2204 may include the TX processor 368, the RX processor 356, and the controller/processor 359. As such, in one configuration, the means may be the TX processor 368, the RX processor 356, and/or the controller/processor 359 configured to perform the functions recited by the means.

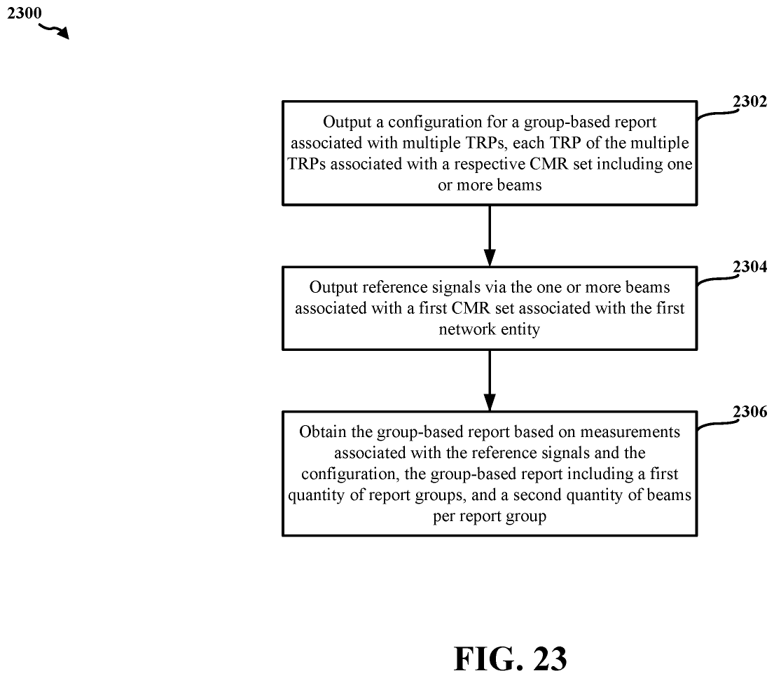

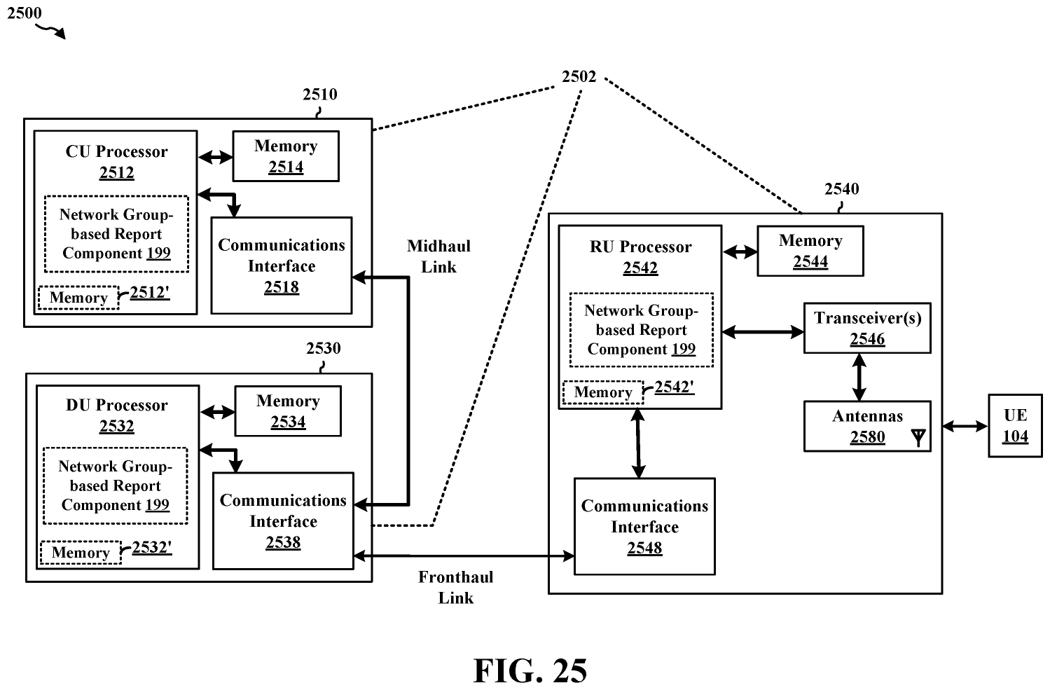

FIG. 23 is a flowchart 2300 of a method of wireless communication. The method may be performed by a first network entity (e.g., the base station 102, and/or a network entity 2502 of FIG. 25). The method may facilitate providing group-based reports when at least one CMR set associated with the group-based report is configured with repetition ON.

At 2302, the first network entity outputs a configuration for a group-based report associated with multiple TRPs, each TRP of the multiple TRPs associated with a respective CMR set including one or more beams, as described in connection with the report configuration 730 of FIG. 7. The outputting of the configuration, at 2302, may be performed by the network group-based report component 199 of the network entity 2502 of FIG. 25.

At 2304, the first network entity may output reference signals via the one or more beams associated with a first CMR set associated with the first network entity, as described in connection with the CSI-RS 740 of FIG. 7. The outputting of the reference signals, at 2304, may be performed by the network group-based report component 199 of the network entity 2502 of FIG. 25.

At 2306, the first network entity obtains the group-based report based on measurements associated with the reference signals and the configuration, the group-based report including a first quantity of report groups, and a second quantity of beams per report group, as described in connection with at least the group-based report 760 of FIG. 7. The obtaining of the group-based report, at 2306, may be performed by the network group-based report component 199 of the network entity 2502 of FIG. 25.

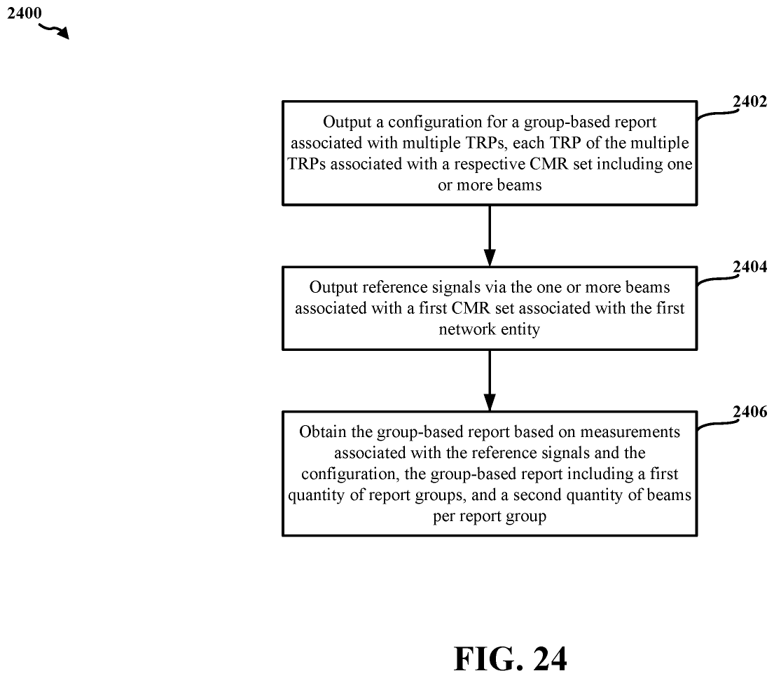

FIG. 24 is a flowchart 2400 of a method of wireless communication. The method may be performed by a first network entity (e.g., the base station 102, and/or a network entity 2502 of FIG. 25). The method may facilitate providing group-based reports when at least one CMR set associated with the group-based report is configured with repetition ON.

At 2402, the first network entity provides a configuration for a group-based report associated with multiple TRPs, each TRP of the multiple TRPs associated with a respective CMR set including one or more beams, and at least a first CMR set being configured with a first repetition value, as described in connection with the report configuration 730 of FIG. 7. The providing of the configuration, at 2402, may be performed by the network group-based report component 199 of the network entity 2502 of FIG. 25.

At 2404, the first network entity provides reference signals via the one or more beams associated with the first CMR set associated with the first network entity, as described in connection with the CSI-RS 740 of FIG. 7. The providing of the reference signals, at 2404, may be performed by the network group-based report component 199 of the network entity 2502 of FIG. 25.

At 2406, the first network entity obtains the group-based report based on measurements associated with the reference signals and the configuration, the group-based report including a first quantity of report groups, and a second quantity of beams-per-report group, and the group-based report including, for the first CMR set, a single measurement value and excluding respective beam identifiers, as described in connection with at least the group-based report 760 of FIG. 7. The obtaining of the group-based report, at 2406, may be performed by the network group-based report component 199 of the network entity 2502 of FIG. 25.

In some examples, the measurements may include RSRP (e.g., L1-RSRP) and/or SINR (e.g., L1-SINR), as described in connection with at least the measurement procedure 750 of FIG. 7.

In some examples, the first quantity of report groups may be configured via signaling, such as RRC signaling, a MAC-CE, and/or DCI, as described in connection with at least the groups indicator 734 of FIG. 7.

In some examples, the obtaining of the group-based report, at 2406, may be at least one of aperiodic, semi-periodic, and periodic, as described in connection with at least the group-based report 760 of FIG. 7.

In some examples, each CMR set associated with the group-based report may be configured with a second repetition value different than the first repetition value, as described in connection with at least the examples of FIG. 5A and FIG. 5B.

In some examples, the first quantity of report groups may be greater than one (e.g., N>1) and at least one CMR set may be configured with a second repetition value different than the first repetition value.

In some examples, the first CMR set may be configured with the repetition value, a second CMR set associated with a second network entity may be configured with a second repetition value different than the first repetition value, and the group-based report may include, for the first CMR set, a single measurement value and exclude beam identifiers, as described in connection with at least the example wireless communication system 800 of FIG. 8A and the group-based report 850 of FIG. 8B. In some examples, the group-based report may include, for the second CMR set, a beam identifier and a corresponding measurement value associated with each respective report group, as described in connection with at least the second column 872 of FIG. 8B.

In some examples, the group-based report may include a first indicator indicating that the first CMR set is associated with a strongest measurement, the single measurement value may indicate an absolute measurement value, and measurement values associated with the second CMR set may indicate differential measurement values, as described in connection with at least the group-based report 850 of FIG. 8B.

In some examples, the first CMR set may be configured with the first repetition value, a second CMR set associated with a second network entity may be configured with a second repetition value different than the first repetition value, and the group-based report may include a first measurement value and a second measurement value for the first CMR set, and a third measurement value and a fourth measurement value for the second CMR set, and measurement values for the first CMR set may exclude corresponding beam identifiers, as described in connection with at least the example wireless communication system 900 of FIG. 9A and the group-based report 950 of FIG. 9B. In some examples, the group-based report may include respective beam identifiers associated with the third measurement value and the fourth measurement value, as described in connection with the second column 972 of FIG. 9B.

In some examples, the group-based report may include a first indicator indicating that the first CMR set is associated with a strongest measurement, the first measurement value may indicate an absolute measurement value, and the second measurement value, the third measurement value, and the fourth measurement value may each indicate differential measurement values, as described in connection with at least the indicator 952 and the entries of the first report group of beams and the second report group of beams of FIG. 9B. In some examples, the first measurement value and the second measurement value may be associated with a same beam identifier, as described in connection with at least the example when the measurement values of the first column 970 correspond to the first receive beam 930a of FIG. 9B. In some examples, the first measurement value and the second measurement value may be associated with different beam identifiers, as described in connection with at least the example when the first measurement value of the first column 970 corresponds to the first receive beam 930a and the second measurement value of the first column 970 corresponds to the second receive beam 930b of FIG. 9B.

In some examples, the group-based report may include a first indicator indicating that the second CMR set is associated with a strongest measurement, the single measurement value may indicate a differential measurement value, and measurement values associated with the second CMR set may indicate an absolute measurement value for a first report group and one or more different measurement values for remaining report groups of the group-based report, as described in connection with at least the group-based report 1050 of FIG. 10B.

In some examples, the group-based report may include a first indicator indicating that the second CMR set is associated with a strongest measurement, the third measurement value may indicate an absolute measurement value, and the first measurement value, the second measurement value, and the fourth measurement value may each indicate differential measurement values, as described in connection with at least the indicator 1152 and the entries of the first report group of beams and the second report group of beams of FIG. 11B.

In some examples, the third measurement value and the fourth measurement value may be associated with a same beam identifier, as described in connection with at least the example when the measurement values of the second column 1172 correspond to the first receive beam 1130a of FIG. 11B. In some examples, the third measurement value and the fourth measurement value may be associated with different beam identifiers, as described in connection with at least the example when the third measurement value of the second column 1172 corresponds to the first receive beam 1130a and the fourth measurement value of the second column 1172 corresponds to the second receive beam 1130b of FIG. 11B.

In some examples, the first CMR set and a second CMR set associated with a second network entity may each be configured with the first repetition value, and the group-based report may include one report group including a first measurement value associated with the first CMR set and a second measurement value associated with the second CMR set, as described in connection with at least the example wireless communication system 1200 of FIG. 12A and the group-based report 1250 of FIG. 12B. In some examples, the group-based report may exclude beam identifiers associated with the first CMR set and the second CMR set, as described in connection with at least the group-based report 1250 of FIG. 12B.

In some examples, the group-based report may include a first indicator indicating that the first CMR set is associated with a strongest measurement, the first measurement value may indicate an absolute measurement value, and the second measurement value may indicate a differential measurement value, as described in connection with at least the group-based report 1250 of FIG. 12B. In other examples, the first indicator may indicate that the second CMR set is associated with a strongest measurement, the first measurement value may indicate a differential measurement value, and the second measurement value may indicate an absolute measurement value.

In some examples, the first CMR set and a second CMR set associated with a second network entity may each be configured with the first repetition value, and the group-based report may include a first measurement value and a second measurement value for the first CMR set, and a third measurement value and a fourth measurement value for the second CMR set, and measurement values for the first CMR set and the second CMR set may exclude corresponding beam identifiers, as described in connection with at least the examples of FIG. 13A and FIG. 13B.

In some examples, the group-based report may include a first indicator indicating that the first CMR set is associated with a strongest measurement, the first measurement value may indicate an absolute measurement value, and the second measurement value, the third measurement value, and the fourth measurement value may each indicate differential measurement values, as described in connection with at least the group-based report 1350 of FIG. 13B. In other examples, the first indicator may indicate that the second CMR set is associated with a strongest measurement, the third measurement value may indicate an absolute measurement value, and the first measurement value, the second measurement value, and the fourth measurement value each indicate differential measurement values.

In some examples, the first CMR set may be configured with the first repetition value, a second CMR set associated with a second network entity may be configured with a second repetition value different than the first repetition value, and the group-based report may exclude information associated with the first CMR set and may include, for the second CMR set, a beam identifier and a corresponding measurement value associated with each respective report group, as described in connection with at least the example wireless communication system 1400 of FIG. 14A and the group-based report 1450 of FIG. 14B.

FIG. 25 is a diagram 2500 illustrating an example of a hardware implementation for a network entity 2502. The network entity 2502 may be a BS, a component of a BS, or may implement BS functionality. The network entity 2502 may include at least one of a CU 2510, a DU 2530, or an RU 2540. For example, depending on the layer functionality handled by the network group-based report component 199, the network entity 2502 may include the CU 2510; both the CU 2510 and the DU 2530; each of the CU 2510, the DU 2530, and the RU 2540; the DU 2530; both the DU 2530 and the RU 2540; or the RU 2540. The CU 2510 may include a CU processor 2512. The CU processor 2512 may include on-chip memory 2512′. In some aspects, may further include additional memory modules 2514 and a communications interface 2518. The CU 2510 communicates with the DU 2530 through a midhaul link, such as an F1 interface. The DU 2530 may include a DU processor 2532. The DU processor 2532 may include on-chip memory 2532′. In some aspects, the DU 2530 may further include additional memory modules 2534 and a communications interface 2538. The DU 2530 communicates with the RU 2540 through a fronthaul link. The RU 2540 may include an RU processor 2542. The RU processor 2542 may include on-chip memory 2542′. In some aspects, the RU 2540 may further include additional memory modules 2544, one or more transceivers 2546, antennas 2580, and a communications interface 2548. The RU 2540 communicates with the UE 104. The on-chip memories (e.g., the on-chip memory 2512′, the on-chip memory 2532′, and/or the on-chip memory 2542′) and/or the additional memory modules (e.g., the additional memory modules 2514, the additional memory modules 2534, and/or the additional memory modules 2544) may each be considered a computer-readable medium/memory. Each computer-readable medium/memory may be non-transitory. Each of the CU processor 2512, the DU processor 2532, the RU processor 2542 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the network group-based report component 199 may be configured to: provide a configuration for a group-based report associated with multiple TRPs, each TRP of the multiple TRPs associated with a respective CMR set including one or more beams, and at least a first CMR set being configured with a first repetition value; provide reference signals via the one or more beams associated with the first CMR set associated with the first network entity; and obtain the group-based report based on measurements associated with the reference signals and the configuration, the group-based report including a first quantity of report groups, and a second quantity of beams-per-report group, and the group-based report including, for the first CMR set, a single measurement value and excluding respective beam identifiers. The network group-based report component 199 may also be configured to: output a configuration for a group-based report associated with multiple TRPs, each TRP of the multiple TRPs associated with a respective CMR set including one or more beams; output reference signals via the one or more beams associated with a first CMR set associated with the first network entity; and obtain the group-based report based on measurements associated with the reference signals and the configuration, the group-based report including a first quantity of report groups, and a second quantity of beams per report group

The network group-based report component 199 may be within one or more processors of one or more of the CU 2510, DU 2530, and the RU 2540. The network group-based report component 199 may be one or more hardware components specifically configured to carry out the stated processes/algorithm, implemented by one or more processors configured to perform the stated processes/algorithm, stored within a computer-readable medium for implementation by one or more processors, or some combination thereof.

The network entity 2502 may include a variety of components configured for various functions. For example, the network group-based report component 199 may include one or more hardware components that perform each of the blocks of the algorithm in the flowcharts of FIG. 23 and/or FIG. 24.

In one configuration, the network entity 2502 may include means for providing a configuration for a group-based report associated with multiple TRPs, each TRP of the multiple TRPs associated with a respective CMR set including one or more beams, and at least a first CMR set being configured with a first repetition value. The example network entity 2502 also includes means for providing reference signals via the one or more beams associated with the first CMR set associated with the first network entity. The example network entity 2502 also includes means for obtaining the group-based report based on measurements associated with the reference signals and the configuration, the group-based report including a first quantity of report groups, and a second quantity of beams-per-report group, and the group-based report including, for the first CMR set, a single measurement value and excluding respective beam identifiers.

In another configuration, the example network entity 2502 also includes means for outputting a configuration for a group-based report associated with multiple TRPs, each TRP of the multiple TRPs associated with a respective CMR set including one or more beams. The example network entity 2502 also includes means for outputting reference signals via the one or more beams associated with a first CMR set associated with the first network entity. The example network entity 2502 also includes means for obtaining the group-based report based on measurements associated with the reference signals and the configuration, the group-based report including a first quantity of report groups, and a second quantity of beams-per-report group.

The means may be the network group-based report component 199 of the network entity 2502 configured to perform the functions recited by the means. As described supra, the network entity 2502 may include the TX processor 316, the RX processor 370, and the controller/processor 375. As such, in one configuration, the means may be the TX processor 316, the RX processor 370, and/or the controller/processor 375 configured to perform the functions recited by the means.

Aspects disclosed herein provide techniques for addressing scenarios in which group-based reporting is enabled and at least one of the CMR sets is configured with repetition ON. In some examples, beam identifiers for beams of the CMR set configured with repetition ON may be excluded from the group-based report, while beams identifiers for beams of the CMR set configured with repetition OFF may be included in the group-based report. In some examples, the group-based report may include a single signal strength measurement for the CMR set configured with repetition ON. In other examples, the group-based report may exclude signal strength measurements for the CMR set configured with repetition ON. In still other examples, the group-based report may include multiple signal strength measurements for the CMR set configured with repetition ON.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a UE, including: receiving a configuration for a group-based report associated with multiple transmission-reception points (TRPs), each TRP of the multiple TRPs associated with a respective channel measurement resource (CMR) set including one or more beams; receiving reference signals via the one or more beams associated with each CMR set; and transmitting the group-based report based on measurements associated with the reference signals and the configuration, the group-based report including a first quantity of report groups, and a second quantity of beams per report group.

Aspect 2 is the method of aspect 1, further including that each CMR set associated with the group-based report is configured with repetition OFF.

Aspect 3 is the method of aspect 1, further including that the first quantity is greater than one and at least one CMR set is configured with repetition OFF.

Aspect 4 is the method of any of aspects 1 and 3, further including that a first CMR set is configured with repetition ON, a second CMR set is configured with repetition OFF, and the group-based report includes, for the first CMR set, a single measurement value and excludes beam identifiers.

Aspect 5 is the method of any of aspects 1 and 3 to 4, further including that the group-based report includes, for the second CMR set, a beam identifier and a corresponding measurement value associated with each respective report group.

Aspect 6 is the method of any of aspects 1 and 3 to 5, further including that the group-based report includes a first indicator indicating that the first CMR set is associated with a strongest measurement, the single measurement value indicates an absolute measurement value, and measurement values associated with the second CMR set indicate differential measurement values.

Aspect 7 is the method of any of aspects 1 and 3 to 5, further including that the group-based report includes a first indicator indicating that the second CMR set is associated with a strongest measurement, the single measurement value indicates a differential measurement value, and measurement values associated with the second CMR set indicates an absolute measurement value for a first report group and one or more different measurement values for remaining report groups of the group-based report.

Aspect 8 is the method of aspect 1, further including that a first CMR set and a second CMR set are each configured with repetition ON, and the group-based report includes one report group including a first measurement value associated with the first CMR set and a second measurement value associated with the second CMR set.

Aspect 9 is the method of any of aspects 1 and 8, further including that the group-based report excludes beam identifiers associated with the first CMR set and the second CMR set.

Aspect 10 is the method of any of aspects 1 and 8 to 9, further including that the group-based report includes a first indicator indicating that the first CMR set is associated with a strongest measurement, the first measurement value indicates an absolute measurement value, and the second measurement value indicates a differential measurement value.

Aspect 11 is the method of any of aspects 1 and 8 to 9, further including that the group-based report includes a first indicator indicating that the second CMR set is associated with a strongest measurement, the first measurement value indicates a differential measurement value, and the second measurement value indicates an absolute measurement value.

Aspect 12 is the method of any of aspects 1 and 3, further including that a first CMR set is configured with repetition ON, a second CMR set is configured with repetition OFF, and the group-based report excludes information associated with the first CMR set and includes, for the second CMR set, a beam identifier and a corresponding measurement value associated with each respective report group.

Aspect 13 is the method of any of aspects 1 and 3, further including that a first CMR set is configured with repetition ON, a second CMR set is configured with repetition OFF, and the group-based report includes a first measurement value and a second measurement value for the first CMR set, and a third measurement value and a fourth measurement value for the second CMR set, and measurement values for the first CMR set excluding corresponding beam identifiers.

Aspect 14 is the method of any of aspects 1, 3 and 13, further including that the group-based report includes respective beam identifiers associated with the third measurement value and the fourth measurement value.

Aspect 15 is the method of any of aspects 1, 3, and 13 to 14, further including that the group-based report includes a first indicator indicating that the first CMR set is associated with a strongest measurement, the first measurement value indicates an absolute measurement value, and the second measurement value, the third measurement value, and the fourth measurement value each indicate differential measurement values.

Aspect 16 is the method of any of aspects 1, 3, and 13 to 15, further including that the first measurement value and the second measurement value are associated with a same beam identifier.

Aspect 17 is the method of any of aspects 1, 3, and 13 to 15, further including that the first measurement value and the second measurement value are associated with different beam identifiers.

Aspect 18 is the method of any of aspects 1, 3, and 13 to 14, further including that the group-based report includes a first indicator indicating that the second CMR set is associated with a strongest measurement, the third measurement value indicates an absolute measurement value, and the first measurement value, the second measurement value, and the fourth measurement value each indicate differential measurement values.

Aspect 19 is the method of any of aspects 1, 3, 13, 14, and 18, further including that the third measurement value and the fourth measurement value are associated with a same beam identifier.

Aspect 20 is the method of any of aspects 1, 3, 13, 14, and 18, further including that the third measurement value and the fourth measurement value are associated with different beam identifiers.

Aspect 21 is the method of any of aspects 1, 3, and 13 to 20, further including: storing a first receiver beam configuration associated with a first beam identifier corresponding to the third measurement value; and storing a second receiver beam configuration associated with a second beam identifier corresponding to the fourth measurement value.

Aspect 22 is the method of aspect 1, further including that a first CMR set and a second CMR set are each configured with repetition ON, and the group-based report includes a first measurement value and a second measurement value for the first CMR set, and a third measurement value and a fourth measurement value for the second CMR set, and measurement values for the first CMR set and the second CMR set excluding corresponding beam identifiers.

Aspect 23 is the method of any of aspects 1 and 22, further including that the group-based report includes a first indicator indicating that the first CMR set is associated with a strongest measurement, the first measurement value indicates an absolute measurement value, and the second measurement value, the third measurement value, and the fourth measurement value each indicate differential measurement values.

Aspect 24 is the method of any of aspects 1 and 22, further including that the group-based report includes a first indicator indicating that the second CMR set is associated with a strongest measurement, the third measurement value indicates an absolute measurement value, and the first measurement value, the second measurement value, and the fourth measurement value each indicate differential measurement values.

Aspect 25 is an apparatus for wireless communication at a UE including at least one processor coupled to a memory and configured to implement any of aspects 1 to 24.

In aspect 26, the apparatus of aspect 25 further includes at least one antenna coupled to the at least one processor.

In aspect 27, the apparatus of aspect 25 or 26 further includes a transceiver coupled to the at least one processor.

Aspect 28 is an apparatus for wireless communication including means for implementing any of aspects 1 to 24.

In aspect 29, the apparatus of aspect 28 further includes at least one antenna coupled to the means to perform the method of any of aspects 1 to 24.

In aspect 30, the apparatus of aspect 28 or 29 further includes a transceiver coupled to the means to perform the method of any of aspects 1 to 24.

Aspect 31 is a non-transitory computer-readable storage medium storing computer executable code, where the code, when executed, causes a processor to implement any of aspects 1 to 24.

Aspect 32 is a method of wireless communication at a first network entity, including: outputting a configuration for a group-based report associated with multiple transmission-reception points (TRPs), each TRP of the multiple TRPs associated with a respective channel measurement resource (CMR) set including one or more beams; outputting reference signals via the one or more beams associated with a first CMR set associated with the first network entity; and obtaining the group-based report based on measurements associated with the reference signals and the configuration, the group-based report including a first quantity of report groups, and a second quantity of beams per report group.

Aspect 33 is the method of aspect 32, further including that each CMR set associated with the group-based report is configured with repetition OFF.

Aspect 34 is the method of aspect 32, further including that the first quantity is greater than one and at least one CMR set is configured with repetition OFF.

Aspect 35 is the method of any of aspects 32 and 34, further including that the first CMR set is configured with repetition ON, a second CMR set associated with a second network entity is configured with repetition OFF, and the group-based report includes, for the first CMR set, a single measurement value and excludes beam identifiers.

Aspect 36 is the method of any of aspects 32 and 34 to 35, further including that the group-based report includes, for the second CMR set, a beam identifier and a corresponding measurement value associated with each respective report group.

Aspect 37 is the method of any of aspects 32 and 34 to 36, further including that the group-based report includes a first indicator indicating that the first CMR set is associated with a strongest measurement, the single measurement value indicates an absolute measurement value, and measurement values associated with the second CMR set indicate differential measurement values.

Aspect 38 is the method of any of aspects 32 and 34 to 36, further including that the group-based report includes a first indicator indicating that the second CMR set is associated with a strongest measurement, the single measurement value indicates a differential measurement value, and measurement values associated with the second CMR set indicates an absolute measurement value for a first report group and one or more different measurement values for remaining report groups of the group-based report.

Aspect 39 is the method of aspect 32, further including that the first CMR set and a second CMR set associated with a second network entity are each configured with repetition ON, and the group-based report includes one report group including a first measurement value associated with the first CMR set and a second measurement value associated with the second CMR set.

Aspect 40 is the method of any of aspects 32 and 39, further including that the group-based report excludes beam identifiers associated with the first CMR set and the second CMR set.

Aspect 41 is the method of any of aspects 32 and 39 to 40, further including that the group-based report includes a first indicator indicating that the first CMR set is associated with a strongest measurement, the first measurement value indicates an absolute measurement value, and the second measurement value indicates a differential measurement value.

Aspect 42 is the method of any of aspects 32 and 39 to 40, further including that the group-based report includes a first indicator indicating that the second CMR set is associated with a strongest measurement, the first measurement value indicates a differential measurement value, and the second measurement value indicates an absolute measurement value.

Aspect 43 is the method of any of aspects 32 and 34, further including that the first CMR set is configured with repetition ON, a second CMR set associated with a second network entity is configured with repetition OFF, and the group-based report excludes information associated with the first CMR set and includes, for the second CMR set, a beam identifier and a corresponding measurement value associated with each respective report group.

Aspect 44 is the method of any of aspects 32 and 34, further including that the first CMR set is configured with repetition ON, a second CMR set associated with a second network entity is configured with repetition OFF, and the group-based report includes a first measurement value and a second measurement value for the first CMR set, and a third measurement value and a fourth measurement value for the second CMR set, and measurement values for the first CMR set excluding corresponding beam identifiers.

Aspect 45 is the method of any of aspects 32, 34, and 44, further including that the group-based report includes respective beam identifiers associated with the third measurement value and the fourth measurement value.

Aspect 46 is the method of any of aspects 32, 34, and 44 to 45, further including that the group-based report includes a first indicator indicating that the first CMR set is associated with a strongest measurement, the first measurement value indicates an absolute measurement value, and the second measurement value, the third measurement value, and the fourth measurement value each indicate differential measurement values.

Aspect 47 is the method of any of aspects 32, 34, and 44 to 46, further including that the first measurement value and the second measurement value are associated with a same beam identifier.

Aspect 48 is the method of any of aspects 32, 34, and 44 to 46, further including that the first measurement value and the second measurement value are associated with different beam identifiers.

Aspect 49 is the method of any of aspects 32, 34, 44, and 45, further including that the group-based report includes a first indicator indicating that the second CMR set is associated with a strongest measurement, the third measurement value indicates an absolute measurement value, and the first measurement value, the second measurement value, and the fourth measurement value each indicate differential measurement values.

Aspect 50 is the method of any of aspects 32, 34, 44, 45, and 49, further including that the third measurement value and the fourth measurement value are associated with a same beam identifier.

Aspect 51 is the method of any of aspects 32, 34, 44, 45, and 49, further including that the third measurement value and the fourth measurement value are associated with different beam identifiers.

Aspect 52 is the method of aspect 32, further including that the first CMR set and a second CMR set associated with a second network entity are each configured with repetition ON, and the group-based report includes a first measurement value and a second measurement value for the first CMR set, and a third measurement value and a fourth measurement value for the second CMR set, and measurement values for the first CMR set and the second CMR set excluding corresponding beam identifiers.

Aspect 53 is the method of any of aspects 32 and 52, further including that the group-based report includes a first indicator indicating that the first CMR set is associated with a strongest measurement, the first measurement value indicates an absolute measurement value, and the second measurement value, the third measurement value, and the fourth measurement value each indicate differential measurement values.

Aspect 54 is the method of any of aspects 32 and 52, further including that the group-based report includes a first indicator indicating that the second CMR set is associated with a strongest measurement, the third measurement value indicates an absolute measurement value, and the first measurement value, the second measurement value, and the fourth measurement value each indicate differential measurement values.

Aspect 55 is an apparatus for wireless communication at a first network entity including at least one processor coupled to a memory and configured to implement any of aspects 32 to 54.

In aspect 56, the apparatus of aspect 55 further includes at least one antenna coupled to the at least one processor.

In aspect 57, the apparatus of aspect 55 or 56 further includes a transceiver coupled to the at least one processor.

Aspect 58 is an apparatus for wireless communication including means for implementing any of aspects 32 to 54.

In aspect 59, the apparatus of aspect 58 further includes at least one antenna coupled to the means to perform the method of any of aspects 32 to 54.

In aspect 60, the apparatus of aspect 58 or 59 further includes a transceiver coupled to the means to perform the method of any of aspects 32 to 54.

Aspect 61 is a non-transitory computer-readable storage medium storing computer executable code, where the code, when executed, causes a processor to implement any of aspects 32 to 54.

Aspect 62 is a method of wireless communication at a UE, including: receiving a configuration for a group-based report associated with multiple transmission-reception points (TRPs), each TRP of the multiple TRPs associated with a respective channel measurement resource (CMR) set including one or more beams, and at least a first CMR set being configured with a first repetition value and a second CMR set being configured with a second repetition value different than the first repetition value; receiving reference signals via the one or more beams associated with each CMR set associated with the group-based report; and transmitting the group-based report based on measurements associated with the reference signals and the configuration, the group-based report including a first quantity of report groups, and a second quantity of beams-per-report group, and the group-based report including, for the first CMR set, a single measurement value and excluding respective beam identifiers.

Aspect 63 is the method of aspect 62, further including that the first quantity is greater than one and at least the second CMR set is configured with the second repetition value.

Aspect 64 is the method of any of aspects 62 and 63, further including that the group-based report includes, for the second CMR set, a beam identifier and a corresponding measurement value associated with each respective report group.

Aspect 65 is the method of any of aspects 62 to 64, further including that the group-based report includes an indicator indicating that the first CMR set is associated with a strongest measurement, the single measurement value indicates an absolute measurement value, and measurement values associated with the second CMR set indicate differential measurement values.

Aspect 66 is the method of any of aspects 62 to 64, further including that the group-based report includes an indicator indicating that the second CMR set is associated with a strongest measurement, the single measurement value indicates a differential measurement value, and measurement values associated with the second CMR set indicate an absolute measurement value for a first report group and one or more differential measurement values for remaining report groups of the group-based report.

Aspect 67 is the method of aspect 62, further including that the first CMR set and a third CMR set are each configured with repetition ON, and the group-based report includes one report group including a first measurement value associated with the first CMR set and a second measurement value associated with the third CMR set.

Aspect 68 is the method of any of aspects 62 and 67, further including that the group-based report excludes, for the first CMR set and the third CMR set, corresponding beam identifiers.

Aspect 69 is the method of any of aspects 62 and 67 to 68, further including that the group-based report includes a first indicator indicating that the first CMR set is associated with a strongest measurement, the first measurement value indicates an absolute measurement value, and the second measurement value indicates a differential measurement value, or the group-based report includes a second indicator indicating that the third CMR set is associated with the strongest measurement, the first measurement value indicates the differential measurement value, and the second measurement value indicates the absolute measurement value.

Aspect 70 is the method of any of aspects 62 and 63, further including that the first CMR set and a third CMR set are each configured with repetition ON, and the group-based report includes a first measurement value and a second measurement value for the first CMR set, and a third measurement value and a fourth measurement value for the third CMR set, and measurement values for the first CMR set and the third CMR set respectively exclude corresponding beam identifiers.

Aspect 71 is the method of aspect 62, further including that the group-based report includes an indicator indicating that the first CMR set is associated with a strongest measurement, the first measurement value indicates an absolute measurement value, and the second measurement value, the third measurement value, and the fourth measurement value each indicate differential measurement values.

Aspect 72 is the method of aspect 62, further including that the group-based report includes an indicator indicating that the third CMR set is associated with a strongest measurement, the third measurement value indicates an absolute measurement value, and the first measurement value, the second measurement value, and the fourth measurement value each indicate differential measurement values.

Aspect 73 is an apparatus for wireless communication at a UE including at least one processor coupled to a memory and configured to implement any of aspects 62 to 72.

In aspect 74, the apparatus of aspect 73 further includes at least one antenna coupled to the at least one processor.

In aspect 75, the apparatus of aspect 73 or 74 further includes a transceiver coupled to the at least one processor.

Aspect 76 is an apparatus for wireless communication including means for implementing any of aspects 62 to 72.

In aspect 77, the apparatus of aspect 76 further includes at least one antenna coupled to the means to perform the method of any of aspects 62 to 72.

In aspect 78, the apparatus of aspect 76 or 77 further includes a transceiver coupled to the means to perform the method of any of aspects 62 to 72.

Aspect 79 is a non-transitory computer-readable storage medium storing computer executable code, where the code, when executed, causes a processor to implement any of aspects 62 to 72.

Aspect 80 is a method of wireless communication at a first network entity, including: providing a configuration for a group-based report associated with multiple transmission-reception points (TRPs), each TRP of the multiple TRPs associated with a respective channel measurement resource (CMR) set including one or more beams, and at least a first CMR set being configured with a first repetition value; providing reference signals via the one or more beams associated with the first CMR set associated with the first network entity; and obtaining the group-based report based on measurements associated with the reference signals and the configuration, the group-based report including a first quantity of report groups, and a second quantity of beams-per-report group, and the group-based report including, for the first CMR set, a single measurement value and excluding respective beam identifiers.

Aspect 81 is the method of aspect 80, further including that the first CMR set and a second CMR set associated with a second network entity are each configured with the first repetition value, and the group-based report includes one report group including a first measurement value associated with the first CMR set and a second measurement value associated with the second CMR set.

Aspect 82 is the method of aspect 80, further including that the group-based report excludes beam identifiers associated with the first CMR set and the second CMR set.

Aspect 83 is the method of any of aspects 80 and 82, further including that a second CMR set associated with a second network entity is configured with a second repetition value different than the first repetition value, and the group-based report includes a first measurement value and a second measurement value for the first CMR set, and a third measurement value and a fourth measurement value for the second CMR set, and measurement values for the first CMR set exclude corresponding beam identifiers.

Aspect 84 is the method of any of aspects 80 and 82 further including that the first CMR set and a second CMR set associated with a second network entity are each configured with the first repetition value, and the group-based report includes a first measurement value and a second measurement value for the first CMR set, and a third measurement value and a fourth measurement value for the second CMR set, and measurement values for the first CMR set and the second CMR set exclude corresponding beam identifiers.

Aspect 85 is an apparatus for wireless communication at a first network entity including at least one processor coupled to a memory and configured to implement any of aspects 80 to 84.

In aspect 86, the apparatus of aspect 85 further includes at least one antenna coupled to the at least one processor.

In aspect 87, the apparatus of aspect 85 or 86 further includes a transceiver coupled to the at least one processor.

Aspect 88 is an apparatus for wireless communication including means for implementing any of aspects 80 to 84.

In aspect 89, the apparatus of aspect 88 further includes at least one antenna coupled to the means to perform the method of any of aspects 80 to 84.

In aspect 90, the apparatus of aspect 88 or 89 further includes a transceiver coupled to the means to perform the method of any of aspects 80 to 84.

Aspect 91 is a non-transitory computer-readable storage medium storing computer executable code, where the code, when executed, causes a processor to implement any of aspects 80 to 84.

What is claimed is:

1. An apparatus for wireless communication at a user equipment (UE), comprising:
at least one memory; and
at least one processor coupled to the at least one memory and, based at least in part on information stored in the at least one memory, the at least one processor is configured to:
receive a configuration for a group-based report associated with multiple transmission-reception points (TRPs), each TRP of the multiple TRPs associated with a respective channel measurement resource (CMR) set including one or more beams, and at least a first CMR set being configured with a first repetition value and a second CMR set being configured with a second repetition value different than the first repetition value;
receive reference signals via the one or more beams associated with each CMR set associated with the group-based report; and
transmit the group-based report based on measurements associated with the reference signals and the configuration, the group-based report including a first quantity of report groups, and a second quantity of beams-per-report group, and the group-based report including, for the first CMR set, a single measurement value and excluding respective beam identifiers.

2. The apparatus of claim 1, wherein the first quantity is greater than one and at least the second CMR set is configured with the second repetition value.

3. The apparatus of claim 1, wherein the group-based report includes, for the second CMR set, a beam identifier and a corresponding measurement value associated with each respective report group.

4. The apparatus of claim 3, wherein the group-based report includes an indicator indicating that the first CMR set is associated with a strongest measurement, the single measurement value indicates an absolute measurement value, and measurement values associated with the second CMR set indicate differential measurement values.

5. The apparatus of claim 3, wherein the group-based report includes an indicator indicating that the second CMR set is associated with a strongest measurement, the single measurement value indicates a differential measurement value, and measurement values associated with the second CMR set indicate an absolute measurement value for a first report group and one or more differential measurement values for remaining report groups of the group-based report.

6. The apparatus of claim 1, wherein the first CMR set and a third CMR set are each configured with repetition ON, and the group-based report includes one report group including a first measurement value associated with the first CMR set and a second measurement value associated with the third CMR set.

7. The apparatus of claim 6, wherein the group-based report excludes, for the first CMR set and the third CMR set, corresponding beam identifiers.

8. The apparatus of claim 7, wherein:
the group-based report includes a first indicator indicating that the first CMR set is associated with a strongest measurement, the first measurement value indicates an absolute measurement value, and the second measurement value indicates a differential measurement value, or
the group-based report includes a second indicator indicating that the third CMR set is associated with the strongest measurement, the first measurement value indicates the differential measurement value, and the second measurement value indicates the absolute measurement value.

9. The apparatus of claim 1, wherein the first CMR set and a third CMR set are each configured with repetition ON, and the group-based report includes a first measurement value and a second measurement value for the first CMR set, and a third measurement value and a fourth measurement value for the third CMR set, and measurement values for the first CMR set and the third CMR set respectively exclude corresponding beam identifiers.

10. The apparatus of claim 9, wherein the group-based report includes an indicator indicating that the first CMR set is associated with a strongest measurement, the first measurement value indicates an absolute measurement value, and the second measurement value, the third measurement value, and the fourth measurement value each indicate differential measurement values.

11. The apparatus of claim 9, wherein the group-based report includes an indicator indicating that the third CMR set is associated with a strongest measurement, the third measurement value indicates an absolute measurement value, and the first measurement value, the second measurement value, and the fourth measurement value each indicate differential measurement values.

12. The apparatus of claim 1, wherein the group-based report includes a first measurement value and a second measurement value for the first CMR set, and a third measurement value and a fourth measurement value for the second CMR set, and measurement values for the first CMR set exclude corresponding beam identifiers.

13. The apparatus of claim 12, wherein the group-based report includes an indicator indicating that the first CMR set is associated with a strongest measurement, the first measurement value indicates an absolute measurement value, and the second measurement value, the third measurement value, and the fourth measurement value each indicate differential measurement values.

14. The apparatus of claim 12, wherein the group-based report includes an indicator indicating that the second CMR set is associated with a strongest measurement, the third measurement value indicates an absolute measurement value, and the first measurement value, the second measurement value, and the fourth measurement value each indicate differential measurement values.

15. The apparatus of claim 12, further comprising:
at least one antenna coupled to the at least one processor, wherein the at least one processor is further configured to:
store a first receiver beam configuration associated with a first beam identifier corresponding to the third measurement value; and
store a second receiver beam configuration associated with a second beam identifier corresponding to the fourth measurement value.

16. A method of wireless communication at a user equipment (UE), comprising:
receiving a configuration for a group-based report associated with multiple transmission-reception points (TRPs), each TRP of the multiple TRPs associated with a respective channel measurement resource (CMR) set including one or more beams, and at least a first CMR set being configured with a first repetition value and a second CMR set being configured with a second repetition value different than the first repetition value;
receiving reference signals via the one or more beams associated with each CMR set associated with the group-based report; and
transmitting the group-based report based on measurements associated with the reference signals and the configuration, the group-based report including a first quantity of report groups, and a second quantity of beams-per-report group, and the group-based report including, for the first CMR set, a single measurement value and excluding respective beam identifiers.

17. The method of claim 16, wherein the group-based report includes, for the second CMR set, a beam identifier and a corresponding measurement value associated with each respective report group.

18. The method of claim 17, wherein the group-based report includes an indicator indicating that the first CMR set is associated with a strongest measurement, the single measurement value indicates an absolute measurement value, and measurement values associated with the second CMR set indicate differential measurement values.

19. The method of claim 17, wherein the group-based report includes an indicator indicating that the second CMR set is associated with a strongest measurement, the single measurement value indicates a differential measurement value, and measurement values associated with the second CMR set indicate an absolute measurement value for a first report group and one or more differential measurement values for remaining report groups of the group-based report.

20. The method of claim 16, wherein the first CMR set and a third CMR set are each configured with repetition ON, and the group-based report includes a first measurement value and a second measurement value for the first CMR set, and a third measurement value and a fourth measurement value for the third CMR set, and measurement values for the first CMR set and the third CMR set respectively exclude corresponding beam identifiers.

21. An apparatus for wireless communication at a first network entity, comprising:
at least one memory; and
at least one processor coupled to the at least one memory and, based at least in part on information stored in the at least one memory, the at least one processor is configured to:
provide a configuration for a group-based report associated with multiple transmission-reception points (TRPs), each TRP of the multiple TRPs associated with a respective channel measurement resource (CMR) set including one or more beams, and at least a first CMR set being configured with a first repetition value;
provide reference signals via the one or more beams associated with the first CMR set associated with the first network entity; and
obtain the group-based report based on measurements associated with the reference signals and the configuration, the group-based report including a first quantity of report groups, and a second quantity of beams-per-report group, and the group-based report including, for the first CMR set, a single measurement value and excluding respective beam identifiers.

22. The apparatus of claim 21, wherein the first CMR set and a second CMR set associated with a second network entity are each configured with the first repetition value, and the group-based report includes one report group including a first measurement value associated with the first CMR set and a second measurement value associated with the second CMR set.

23. The apparatus of claim 22, wherein the group-based report excludes beam identifiers associated with the first CMR set and the second CMR set.

24. The apparatus of claim 21, wherein, a second CMR set associated with a second network entity is configured with a second repetition value different than the first repetition value, and the group-based report includes a first measurement value and a second measurement value for the first CMR set, and a third measurement value and a fourth measurement value for the second CMR set, and measurement values for the first CMR set exclude corresponding beam identifiers.

25. The apparatus of claim 21, wherein the first CMR set and a second CMR set associated with a second network entity are each configured with the first repetition value, and the group-based report includes a first measurement value and a second measurement value for the first CMR set, and a third measurement value and a fourth measurement value for the second CMR set, and measurement values for the first CMR set and the second CMR set exclude corresponding beam identifiers.

26. A method of wireless communication at a first network entity, comprising:
providing a configuration for a group-based report associated with multiple transmission-reception points (TRPs), each TRP of the multiple TRPs associated with a respective channel measurement resource (CMR) set including one or more beams, and at least a first CMR set being configured with a first repetition value;
providing reference signals via the one or more beams associated with the first CMR set associated with the first network entity; and
obtaining the group-based report based on measurements associated with the reference signals and the configuration, the group-based report including a first quantity of report groups, and a second quantity of beams-per-report group, and the group-based report including, for the first CMR set, a single measurement value and excluding respective beam identifiers.

27. The method of claim 26, wherein the first CMR set and a second CMR set associated with a second network entity are each configured with the first repetition value, and the group-based report includes one report group including a first measurement value associated with the first CMR set and a second measurement value associated with the second CMR set.

28. The method of claim 27, wherein the group-based report excludes beam identifiers associated with the first CMR set and the second CMR set.

29. The method of claim 26, wherein a second CMR set associated with a second network entity is configured with a second repetition value different than the first repetition value, and the group-based report includes a first measurement value and a second measurement value for the first CMR set, and a third measurement value and a fourth measurement value for the second CMR set, and measurement values for the first CMR set exclude corresponding beam identifiers.

30. The method of claim 26, wherein the first CMR set and a second CMR set associated with a second network entity are each configured with the first repetition value, and the group-based report includes a first measurement value and a second measurement value for the first CMR set, and a third measurement value and a fourth measurement value for the second CMR set, and measurement values for the first CMR set and the second CMR set exclude corresponding beam identifiers.
